(19) United States
(12) Patent Application Publication
(10) Pub. No.: US 2009/0124512 A1
(43) Pub. Date: May 14, 2009

(54) DNA ARRAY ANALYSIS AS A DIAGNOSTIC FOR CURRENT AND EMERGING STRAINS OF INFLUENZA

(75) Inventors: Kathy L. Rowlen, Boulder, CO (US); Robert Kuchta, Boulder, CO (US); Michael Townsend, Atlanta, GA (US); James Smagala, Arvada, CO (US); Chad L. Moore, San Diego, CA (US); Erica Dawson, Broomfield, CO (US); Martin Mehlmann, Birsfelden (CH); Nancy Cox, Atlanta, GA (US); Catherine B. Smith, Stone Mountain, GA (US); Daniela Mehlmann, Birsfelden (CH)

Correspondence Address: FAEGRE & BENSON LLP, 1900 FIFETEENTH STREET, BOULDER, CO, 80302-5414, US

(73) Assignee: REGENTS OF THE UNIVERSITY OF COLORADO, Denver, CO (US)

(21) Appl. No.: 12/160,784

(22) PCT Filed: Jan. 18, 2007
(86) PCT No.: PCT/US07/60706

§ 371 Date: Dec. 2, 2008

Related U.S. Application Data
(60) Provisional application No. 60/759,670, filed on Jan. 18, 2006.
(60) Provisional application No. 60/784,751, filed on Mar. 21, 2006.

(51) Int. Cl. C40B 40/06; C40B 50/00; C40B 30/04

(52) U.S. Cl. 506/9; 506/16; 506/23

(57) ABSTRACT

Embodiments herein provide for methods, compositions and apparati for detection and/or diagnosis of virus types, subtypes and/or strains. In particular embodiments, the virus is an influenza virus. The apparatus may include a microarray with attached capture probes, designed to bind to oligonucleotides capable of binding at least a portion of a nucleic acid sequence of one or more target genes in a broad array of influenza types, subtypes or strains. The compositions may include isolated nucleic acids as capture probes, target sequences and/or tagged label probes, of use for diagnosis and/or detection of influenza virus.

This application claims the benefit under 35 U.S.C. § 119(e) of U.S. provisional patent application Ser. No. 60/759,670 filed on Jan. 18, 2006 and U.S. provisional patent application Ser. No. 60/784,751 filed on Mar. 21, 2006, both incorporated herein by reference in their entirety.

### FIELD

Embodiments herein relate to compositions, methods and apparatus for detection and differential diagnosis of influenza. In some embodiments, influenza types, such as A, B and C may be distinguished from each other. In certain embodiments, subtypes of influenza A may be distinguished from each other. In one particular embodiment, the various strains of influenza A virus may be distinguished from each other

### BACKGROUND

Influenza is an orthomyxovirus with three genera, types A, B, and C. The types are distinguished by the nucleoprotein antigenicity. Types A and B are the most clinically significant, causing mild to severe respiratory illness. Influenza B is a human virus and does not appear to be present in an animal reservoir. Type A viruses exist in both human and animal populations, with significant avian and swine reservoirs. Influenza A and B each contain 8 segments of negative sense ssRNA. Type A viruses can also be divided into antigenic subtypes on the basis of two viral surface glycoproteins, hemagglutinin (HA) and neuraminidase (NA). There are currently 15 identified HA subtypes (designated H1 through H15) and 9 NA subtypes (N1 through N9) all of which can be found in wild aquatic birds. Of the 135 possible combinations of HA and NA, only four (H1N1, H1N2, H2N2, and H3N2) have widely circulated in the human population since the virus was first isolated in 1933. The two most common subtypes of influenza A currently circulating in the human population are H3N2 and H1N1.

New type influenza A strains emerge due to genetic drift that results in slight changes in the antigenic sites on the surface of the virus. Thus, the human population can experience epidemics of influenza infection every year. More drastic genetic changes can result in an antigenic shift (a change in the subtype of HA and/or NA) resulting in a new subtype capable of rapidly spreading in a susceptible population. The influenza A virus of 1918 was of the H1N1 subtype and it replaced the previous virus (probably H3N8 as deduced by seroarcheology) that had been the dominant type A virus in the human population. Antigenic shift most likely arises from genetic reassortment when two different subtypes infect the same cell. Because viral genetic information is stored in eight separate segments, packaging of new virions within a cell that is replicating two different viruses (e.g. an avian type A and a human type A) can result in a virus with a mixture of genes from each of the parent viruses. This is presumed to be the mechanism by which avian-like surface glycoproteins (and some internal, nonglycoprotein genes) appeared in the viruses responsible for the 1957 (H2N2) and 1968 (H3N2) pandemics. This reassortment of surface antigens is an ongoing possibility as shown by the recent appearance of H1N2 reassortants worldwide.

Subtypes are sufficiently different as to make them non-crossreactive with respect to antigenic behavior; prior infection with one subtype (e.g. H1N1) can lead to no immunity to another (e.g. H3N2). It is this lack of crossreactivity that allows a novel subtype to become pandemic as it spreads through an immunologically naïve population. In the case of populations in close contact, spread is especially rapid. Consequently, the appearance of a new subtype or previously identified circulating strains can have significant consequences for public health in general and defense preparedness in particular.

Although relatively uncommon, it is possible for nonhuman influenza A strains to transfer from their “natural” reservoir to humans. In one example, the highly lethal Hong Kong avian influenza outbreak in humans in 1997 was due to an influenza A H5N1 virus that was an epidemic in the local poultry population at that time. This virus killed six of the 18 patients shown to have been infected.

Annual influenza A virus infections have a significant impact in terms of human lives, between 500,000 and 1,000,000 die worldwide each year, and economic impact resulting from direct and indirect loss of productivity during infection. Of even greater concern is the ability of influenza A viruses to undergo natural and engineered genetic change that could result in the appearance of a virus capable of rapid and lethal spread within the population.

One of the most dramatic events in influenza history was the so-called “Spanish Flu” pandemic of 1918-1919. In less than a year, between 20 and 40 million people died from influenza, with an estimated one fifth of the world's population infected. The virus that caused the Spanish flu was unique for several reasons, not the least of which was its ability to kill previously healthy young adults. In fact, the US military was devastated by the virus near the end of World War I, with 80% of US army deaths between 1918 and 1919 due to influenza infection. Because it is a readily transmitted, primarily airborne pathogen, and because the potential exists for the virus to be genetically engineered into novel forms, influenza A represents a serious biodefense concern.

Current public and scientific concern over the possible emergence of a pandemic strain of influenza or other pathogenic or non-pathogenic viruses requires a method for the rapid detection and identification of these viruses, for example, the type and subtypes of the viruses. A need exists for improved genetic diagnosis for influenza virus to control and monitor the virus' impact on human, avian and animal health within the U.S. and worldwide.

### SUMMARY

Embodiments herein provide for methods, compositions and apparati for detecting and/or diagnosing the presence of a virus. In certain embodiments, methods, compositions and apparatus provide for detecting and/or diagnosing the presence of influenza virus. In other embodiments, the detection and/or diagnosis may extend to identifying the type, subtype and/or strain of influenza virus present in a sample.

Samples contemplated in some embodiments may include any sample from a subject suspected of having influenza virus, including but not limited to, nasopharangeal washes, expectorate, respiratory tract swabs, throat swabs, tracheal aspirates, bronchoalveolar lavage, mucus, saliva or a combination thereof. Other samples contemplated herein may include but are not limited to, air samples, air-filter samples, surface-associated samples and a combination thereof. Subjects contemplated herein can include, but are not limited to, humans, birds, horses, dogs, cats, rodents and swine.

One embodiment concerns an array that includes a plurality of capture probes bound to the surface of a solid substrate (e.g. FluChip or MChip) or suspended in a solution. In accordance with these embodiments, the capture probes are capable of binding to oligonucleotides comprising at least a portion of a nucleic acid sequence or complimentary nucleic acid sequence of a target gene of one or more influenza virus. In one exemplary method, an array can include a plurality of capture probes bound to the surface of a solid substrate or suspended in a solution where the capture probes are capable of binding to oligonucleotides comprising at least a portion of a nucleic acid sequence or complimentary nucleic acid sequence of a single target gene segment of one or more influenza virus. At least a portion of the nucleic acid sequences can include conserved regions of the single target gene or multiple target genes. In certain examples, a capture probe is capable of binding to and immobilizing RNA molecules of an influenza virus type, subtype or strain. In addition, an array can further include positive and/or negative controls bound to the surface of a solid substrate. These controls can be used to confirm the conditions of an array for binding a particular virus. The array may be a microarray or a multi-channel microarray.

Other embodiments may concern apparatus of use for influenza virus detection and/or diagnosis, (e.g. such as a “FluChip™” apparatus). A FluChip™ apparatus may comprise a microarray with one or more attached capture probes capable of binding to oligonucleotides comprising at least a portion of a nucleic acid sequence or complimentary nucleic acid sequence of more than one target gene. In a preferred embodiment, the FluChip™ apparatus may comprise 55 or more of such sequences. The capture probes attached to the FluChip™ apparatus may be designed to hybridize with nucleic acid sequences from 1 or more types, subtypes and/or strains of influenza virus

In certain embodiments, influenza virus is selected from the group consisting of influenza A H3N2, influenza A H1N1, and avian influenza A H5N1.

Some embodiments may include oligonucleotides that can include, but are not limited to, at least a portion of a nucleic acid sequence or complimentary nucleic acid sequence of a target gene of one or more influenza B strains. In accordance with these embodiments the influenza type, subtype or strain can be distinguished from one another. In addition, any array contemplated herein can include capture probes selected from sequences listed in Table 3, Table 4, Table 5 or a combination thereof. In addition, the capture and label probes indicated herein are interchangeable, thus sequences listed as capture, label or combination thereof can be used to create an array. In certain embodiments the array contains 100 or less capture probes (and/or label sequences) bound to the surface of the solid substrate.

In some embodiments, an array can be bound to a solid substrate. In accordance with these embodiments, a solid surface can include, but is not limited to, glass, plastic, silicon-coated substrate, macromolecule-coated substrate, particles, beads, microparticles, microbeads, dipstick, magnetic beads, paramagnetic beads and a combination thereof. In one particular embodiment, the capture probes linked to a solid substrate each can be individually about 5 to about 200 nucleotides (nt) in length, about 10 to about 150 nt in length, about 25 to about 100 nt in length or about 10 to about 75 nt in length.

One embodiment concerns a method for attaching a plurality of capture probes to a solid substrate surface to form an array, wherein the capture probes are capable of binding to oligonucleotides comprising at least a portion of a nucleic acid sequence or complimentary nucleic acid sequence of a target gene of one or more strains of influenza type, subtype or strain. The oligonucleotides contemplated herein can include at least a portion of a nucleic acid sequence or complimentary nucleic acid sequence of a target gene selected from the group consisting of hemagglutinin (HA gene segment), neuraminidase (NA gene segment), matrix protein (M gene segment) and a combination thereof. In one particular embodiment, the oligonucleotides contemplated herein can include at least a portion of a nucleic acid sequence of the HA gene. In another particular embodiment, the oligonucleotide contemplated herein can include at least a portion of a nucleic acid sequence of the M gene.

In addition, embodiments herein concerns methods for detecting influenza in a sample, the method includes: a) contacting the sample with an array of a plurality of capture probes to produce a test array, wherein the test array comprises a capture probe-sample complex when the sample contains an oligonucleotide comprising at least a portion of a nucleic acid sequence or complimentary nucleic acid sequence of a target gene of one or more influenza virus; and b) contacting the test array with one or more detection probes to produce a labeled array, wherein the labeled array comprises a target-probe complex when the test array comprises the capture-probe complex, and wherein the presence of the target-probe complex is indicative of the presence of influenza virus in the sample. In accordance with these methods, the array can include a plurality of capture probes comprising at least a portion of a nucleic acid sequence or complimentary nucleic acid sequence of a target gene of one or more influenza virus. In certain embodiments, the presence of influenza virus in the sample is determined by detecting a signal generated by the probe of a target-probe complex. In other embodiments, the signal generated by the target-probe complex produces different patterns depending on the influenza type, subtype or strain present in the sample. In certain examples, the capture probes are capable of binding to one or more influenza type and/or one or more influenza A subtype or strain. In certain examples, the target gene can include, but is not limited to hemagglutinin (HA gene segment), neuraminidase (NA gene segment), matrix protein (M gene segment) and a combination thereof.

In certain embodiments, methods concern detection of influenza virus in a sample in 48 hours or less, 36 hours or less, 24 hours or less or more particularly in 12 hours or less.

Another embodiment concerns label probes that can include an oligonucleotide of at least a portion of a nucleic acid sequence of a target gene of one or more types or strains of influenza. In certain examples, the label probe is capable of binding to at least a portion of a nucleic acid sequence of a target gene of one or more influenza types, subtype or strain.

One exemplary method herein concerns diagnosing influenza in a subject using apparati disclosed herein. In accordance with this method, diagnosis of severity of influenza infection in the subject is also contemplated herein. In one example, a sample is obtained from a subject and the sample is exposed to an apparatus disclosed herein and the presense or level of influenza can be assessed. In certain embodiments, it is contemplated that the strain of influenza virus can be assessed and treatment of the subject can be based on this assessment. It is also contemplated that any of the apparati disclosed herein can be used for assessing infection in a small or large population in order to decide the best approach in the event of an outbreak of influenza in the population, such as quarantine or isolation of the infected population.

Further embodiments can include kits for practicing the embodiments disclosed herein. One exemplary kit can include, but is not limited to: a) an array of a plurality of capture probes bound to the surface of a solid substrate, wherein the capture probes are capable of binding to oligonucleotides including at least a portion of a nucleic acid sequence of a target gene of one or more influenza type or strain and (b) one or more tagged label probes wherein the tagged label probes are capable of producing a signal and wherein the label probes are capable of binding to the oligonucleotides comprising at least a portion of a nucleic acid sequence or complimentary nucleic acid sequence of a target gene of one or more influenza virus. In one particular kit, an array may include positive and/or negative controls where the controls are capable of indicating binding conditions of the array.

The skilled artisan will realize that although the methods and apparatus are described in terms of the particular embodiments for application of identifying particular influenza virus types, subtypes and/or strains, they are also of use with other types of viral detection and/or diagnosis.

### BRIEF DESCRIPTION OF THE DRAWINGS

The following drawings form part of the present specification and are included to further demonstrate certain embodiments. The embodiments may be better understood by reference to one or more of these drawings in combination with the detailed description of specific embodiments presented herein.

FIG. 1 represents an exemplary scheme for influenza virus assay-design, including the direct hybridization used for the positive control (left hand side) and the dual capture/label hybridization process for detection of viral RNA (right hand side).

FIG. 2 represents a flowchart outlining the overall process for finding conserved regions of the influenza viral genome.

FIG. 3 represents a flowchart for the process of choosing appropriate capture-label pairs from a single conserved region.

FIG. 4 represents a neighbor-joining phylogenetic tree for 499 influenza A NA (N1) gene segment sequences. The brackets at right show the initial division of the tree together with the initial number of conserved regions found for each particular subset.

FIG. 5 represents a FluChip-55™ apparatus layout. Capture sequences were spotted in triplicate next to ‘positive control’ (PC) rows. Samples were grouped by subtype (HA and NA) or by type (A or B) based on the matrix gene (M).

FIG. 6 represents a typical microarray results demonstrating correct typing and subtyping of a) A/H1N1, b) A/H3N2, and c) A/H5N1. The dark spots represent strong fluorescence signal. The top and left edge spots are positive controls. The boxed areas highlight hits on specific subtypes, with the designations included for ease of viewing. Typical relative variation in the signal for triplicate spots was 10%. The limit of detection on the microarray was ˜0.7 ng RNA.

FIGS. 7A-7D represent bar graph summaries of results for analysis of 72 unknown samples using the assay (influenza A primers only) in conjunction with FluChip-55™ apparatus. The performance is summarized for both the original blind study (A) and a duplicate study (B). The microarray performance, which has been corrected for missing subtypes and lack of RNA amplification, is shown in (C) and (D) for the blind and duplicate studies, respectively.

FIG. 8 represents an ethidium bromide stained 1% agarose gel showing PCR products for several influenza samples. The amplified gene is noted on the right while the fragment size is marked on the left.

FIG. 9 represents an image showing correct typing and subtyping of patient sample derived influenza A H3N2 virus.

FIGS. 10A-10D represent an exemplary layout of a general microarray (A) of 7 M segment sequences showing positive control sequences (closed symbols) and capture sequences spotted in triplicate (open circles). Fluorescence images showing typical patterns for (B) H3N2 (26 samples), (C) H1N1 (18 samples), and (D) H5N1 (8 samples) viruses.

FIGS. 11A-11D represent an exemplary layout of a microarray for 15 M gene capture sequences with positive control sequences (closed symbols) and capture sequences spotted in triplicate (open symbols) shown in (A). Fluorescence images showing typical patterns for viral subtypes H3N2 (B), H1N1 (C), and H5N1 (D).

FIGS. 12A-12C represent an exemplary method of fluorescence images highlighting microarray patterns for viruses that exhibit patterns other than shown in FIG. 2. (A) is a laboratory reassortant virus containing HA and NA from an H3N2 virus and the internal genes from an H1N1 virus, (B) is a swine H3N2 virus that infected a human, and (C) is from an avian H9N2 virus.

FIGS. 13A and 13B represent an exemplary method of hierarchical clustering analysis (see Methods for details) of 58 microarray results (1 experiment for each viral isolate) using 15 M segment probe sequences (A). A similar clustering analysis is shown in (B) along with results from 24 unknown patient samples, subsequently revealed to be H3N2 and H1N1 viruses (all influenza A).

### DESCRIPTION OF ILLUSTRATIVE EMBODIMENTS

### Definitions

Terms that are not otherwise defined herein are used in accordance with their plain and ordinary meaning.

As used herein, “a” or “an” may mean one or more than one of an item.

A “sequence variant” is any alteration in a nucleic acid sequence, such as an alteration observed in a given gene sequence between different strains, types or subtypes of influenza virus. Sequence variants may include, but are not limited to, insertions, deletions, substitutions, mutations and single nucleotide polymorphisms.

A “capture” probe or sequence is a nucleic acid sequence that is capable of forming a complex with oligonucleotides including at least a portion of a nucleic acid sequence or complimentary nucleic acid sequence of a target gene. Forming a complex can include hybridizing to, binding to or associating with oligonucleotides including at least a portion of a nucleic acid sequence or complimentary nucleic acid sequence of a target gene. In certain examples, a nucleic acid sequence can be any nucleic acid molecule for example, RNA, DNA or combination thereof. Note: capture and label probe or sequences in certain embodiments can be interchangeable.

A “label” probe or sequence is a nucleic acid sequence that is capable of forming a complex with oligonucleotides including at least a portion of a nucleic acid sequence or complimentary nucleic acid sequence of a target gene. Forming a complex can include hybridizing to, binding to or associating with oligonucleotides including at least a portion of a nucleic acid sequence or complimentary nucleic acid sequence of a target gene. In addition, a “label” probe is capable of producing a signal. In certain embodiments, a “label” probe or sequence may be detectably labeled, for example by attachment of a fluorescent, phosphorescent, enzymatic, radioactive or other tag moiety. Alternatively, a label probe or sequence may contain one or more functional groups designed to bind to a detectable tag moiety. Note: capture and label sequences in certain embodiments can be interchangeable.

### Influenza Diagnostics

Current methods for characterizing type A influenza viruses rely on phenotypic (e.g., antigenic) information, although the actual genetic basis of pathogenicity and transmissibility may have little, if anything, to do with the serologic reactivity of HA and NA. While there is evidence that the high pathogenicity of the H5N1 viruses responsible for the 1997 Hong Kong outbreak in poultry was largely due to enhanced cleavability of the H5 HA, this alone cannot explain their ability to infect humans because previous outbreaks of viruses with similar cleavability H5 HAs did not cause human disease. The reason these 1997H5N1 viruses were able to infect humans is still the subject of investigation. Previous studies in mice, using human H5N1 isolates from the 1997 outbreak have revealed five different amino acids in four genes that might contribute to the host range and/or pathogenicity of these viruses. Thus, phenotypic assays do not provide sufficient information for gauging the potential pathogenicity of a new strain.

Traditional characterization of influenza virus involves hemagglutinin-inhibition serology tests, with viral cultures often necessary for more detailed characterization. These approaches are laborious and time-consuming. In addition, all of the current rapid influenza tests are relatively insensitive, resulting in at least some false negative reports.

### Functional Genomics and Microchip-Platforms

With the advent of rapid genome sequencing and large genome databases, it is now possible to utilize genetic information in a myriad of ways. One of the most promising technologies is oligonucleotide arrays. The general structure of an oligonucleotide array, more commonly referred to as a DNA microarray or a DNA chip, is a well defined array of spots on an optically flat surface, each of which contains a layer of relatively short strands of DNA (e.g., Schena, ed., “DNA Microarrays A Practical Approach,” Oxoford University Press; Marshall et al. (1998) Nat. Biotechnol. 16:27-31; each incorporated herein by reference). Of the two most commonly used technologies for generating arrays, one is based on photolithography (e.g. Affymetrix) and the other is based on robot-controlled ink jet (spotbot) technology (e.g., Arrayit.com). Other methods for generating microarrays are known and any such known method may be used herein. Generally, an oligonucleotide (capture probe) placed within a given spot in the array is selected to bind at least a portion of a nucleic acid or complimentary nucleic acid of a target gene. An aqueous sample is placed in contact with the array under the appropriate hybridization conditions. The array is then washed thoroughly to remove all non-specific adsorbed species. In order to determine whether or not the target sequence was captured, the array is “developed” by adding, for example, a fluorescently labeled oligonucleotide sequence that is complimentary to an unoccupied portion of the target sequence. The microarray is then “read” using a microarray reader or scanner, which outputs an image of the array. Spots that exhibit strong fluorescence are positive for that particular target sequence.

DNA chip technology has found widespread use in gene expression analysis and there are now several demonstrations of DNA chips in the field of diagnostics.

### DNA Microarray for Differential Detection of Influenza a Strains

In one example, the “FluChip™” apparatus can provide information as to whether or not an individual is infected with a virus such as influenza as well as provide both type and subtype characterization of the virus. Analysis for the presence of influenza using the FluChip™ apparatus requires about 11 hours, as compared to about 4 days using current state of the art methodology. This apparatus requires about 55 sequences that are directed towards several genes. One particular embodiment of the The FluChip™ assay utilizes the amplification of more than one gene, namely the M segment, the HA segment and the NA segments. This application was filed Jan. 18, 2006 entitled, “DNA Microarray Analysis as a Diagnostic for Current and Emerging Strains of Influenza A,” and is incorporated herein by reference in its entirety for all purposes.

Certain embodiments have several advantages over the viral assays to date namely assays for identifying types, subtypes and strains of influenza. In one embodiment, the chip assay disclosed herein can target many genes or a single gene target of a virus. Multiplex PCR as used in the FluChip™ apparatus targets multiple genes. In other embodiments, an array disclosed herein can target a single gene segment such as the MChip™ apparatus. Arrays disclosed herein have rapid turn around times for analysis. For example, the turnaround time for analysis for the presence or absence of a viral target in a sample can be 11 hours or less. In a particular embodiment, analysis for the presence or absence of a viral target in a sample can be 7 hours or less. In a more particular embodiment, analysis for the presence or absence of a viral target in a sample can be 5 hours or less. In addition, the chip assay for detection of a pathogenic or non-pathogenic virus disclosed herein can be 100 sequences or less, preferably 15-60 sequences, more preferably 15-30 sequences and even more preferably less than 15 sequences to identify the presence or absence of a target gene of a particular type, subtype or strain of a virus (e.g. M segment of influenza A H1N1). In accordance with these embodiments, identification of the presence or absence of a particular type, subtype or strain of a virus in a sample may require about 100 nucleotides or less for detection of a target gene indicative of the virus. In one particular embodiment, the identification of the presence or absence of a particular type, subtype or strain of a virus in a sample may require about 50 nucleotides or less for detection of a target gene indicative of the virus. For example, 5-15 sequences of about 10-30 nucleotides in length may be used to generate a chip for identification of the presence or absence of a gene segment of a virus in a sample. In accordance with these embodiments, a skilled artisan understands that many of the sequences generated for detection of the single gene indicative of the viral organism may have overlap.

An important consideration for using a DNA microarray to analyze flu strains is identifying what gene of the viral genome (e.g. the influenza genome) to target. For example, each type of influenza (A, B, and C) is characterized by multiple subtypes. The subtypes refer to the proteins that are expressed due to sequences present in the HA (hemagglutinin) and NA (neuraminidase) genes. Each virus is identified via a type and subtype (e.g. A/H1N1). In addition, the virus can be identified as a particular strain. Sequences placed on the microarray must preferably distinguish between the various types, subtypes or strain of influenza. Additionally, influenza virus mutates extremely rapidly. Thus, sequences placed on the microarray must preferably take into account the rapid mutational rate of influenza.

Herein, a set of procedures was developed that permit taking a large number of influenza sequences for an individual gene (>1000) and identify regions within each gene that will permit identification in both the influenza type and subtype. The sequences used consisted of both published data (ex., the Influenza Sequence Database (ISD) at the Los Alamos National Laboratory www.flu.lanl.gov), and unpublished, proprietary sequence databases (CDC influenza sequence database). This process involved using both preexisting programs as well as programs developed specifically for this task, most notably the program ‘ConFind’ (Smagala et al., “ConFind: a robust tool for conserved sequence identification,” Bioinformatics Advance Access published Oct. 20, 2005, incorporated herein by reference). Using these programs in a specific workflow resulted in rapid and efficient identification of regions of the H and N genes that could be used for subtyping influenza A. As previously found, regions of the M (matrix) gene were identified that provide unambiguous typing of influenza (type A or B).

In one embodiment, a single target gene indicative of a virus may be used to design an array apparatus. In accordance with the embodiment the array apparatus can be produced by generating specific oligonucleotides that are capable of binding at least a portion of a nucleic acid sequence or complimentary nucleic acid of this target gene. One example detailed herein found that a single gene (e.g. M segment of influenza A) may be used to identify the presence of influenza A in a sample. Unexpectedly, a highly conserved internal gene, the M gene, may be used to distinguish between types, subtypes or strains of a virus. For example, a single target gene segment such as the M segment gene of influenza virus A may be used to identify the presence or absence of a specific subtype of the virus. One exemplary method described herein found that an array including M segment gene-derived oligonucleotides distinguished subtypes H1N1, H3N2, and H5N1 of influenza A within samples.

In one embodiment, the M segment can be used to provide antigenic subtype information by examining the role of the matrix genes and the matrix protein's interaction with surface glycoproteins. The M segment of influenza A codes for both the M1 and M2 proteins. M1 is the most abundant protein in the virion and forms the inside of the viral envelope. M1 serves as a bridge between HA, NA, and M2 and the viral core. M1 is involved in a number of steps in the life cycle of the virus, including the transport of the ribonucleoproteins, viral assembly, and budding. M2 is a minor component of the viral envelope that acts as a proton-selective ion channel. Inside the acidic endosome after viral and endosomal membrane fusion, the M2 ion channel opens and facilitates the low-pH environment needed to uncoat the ribonucleoprotein.

In one aspect, a target gene is selected and particular sequences of the target gene are chosen for oligonucleotide generation and placement on the DNA microarray. For example an array was designed for analysis of the M gene of influenza A. In this example, 15 different M segment sequences were positioned on a microarray. Appropriate probe sequences (capture and label) were then designed from the conserved regions (see Methods). Oligonucleotides were designed from sequences selected to yield either broad reactivity with all viral subtypes or highly specific reactivity for a given viral subtype or host species. Anticipated reactivity was determined computationally by evaluating the number of mismatches between possible probe sequences and all sequences in the databases used to design them. These oligonucleotides were designed to specifically identify influenza A M gene and distinguish subtypes of influenza A. Although the M segment is not under selective pressure to evade the immune system, functional interactions between the surface glycoproteins and the M segment are well documented, and recent evidence clearly highlights their co-evolution.

In one exemplary method, the following procedure was used to identify the type and subtype of influenza.
(1) Amplify the viral RNA using reverse transcriptase-PCR
(2) Convert the cDNA into large amounts of RNA using T7 RNA polymerase.
(3) Fragment the RNA using base catalyzed hydrolysis.
(4) Add a mixture of specific label-oligonucleotides to the fragmented RNA. Only one label oligonucleotide will bind to each region that the microarray is designed to capture.
(5) Place the mixture of fragmented influenza RNA and label-oligos onto the microarray, and allow hybridization to occur.
(6) Wash off any unbound RNA/DNA.
(7) Analyze using a scanning laser fluorimeter.

The detailed procedures are described in the Examples section below. In one exemplary study viral isolates of known subtype were tested. Methods disclosed herein were used to identify the subtype of each of the samples. In the examples, an apparatus disclosed herein accurately provided types and subtypes of influenza viruses in much less time than current procedures (for example, see Tables 7 and 8).

In other embodiments, it is contemplated that other viruses have an internal non-immunogenic protein similar to the M segment of influenza A that may be targeted and capture and label sequences may be produced. From these capture and label sequences, a microarray chip may be created for identifying types, subtypes or strains of the virus in a sample. In accordance with these embodiments, other viruses may include negative sense, single-strand, segmented RNA viruses. In one particular embodiment, a negative sense, single-strand, segmented RNA virus may include viruses of the class Orthomyxovyridae. Orthomyxovyridae viruses include but are not limited Influenzavirus A, Influenzavirus B, Influenzavirus C, Thogotovirus and Isavirus.

In another embodiment, the unique patterns observed in the M segment sequences on a microarray could be used as a diagnostic test for the identification of unknown influenza A viruses. In accordance with this embodiment, microarray results from unknown viruses could be evaluated against a “verification” set or control set using either a simple hierarchical clustering analysis or more advanced methods, such as neural networks (see for example: Filmore, D. Gene expression learned. Mod. Drug. Disc. 7, 47-49 (2004); Hanai, T. & Honda, H. Application of knowledge information processing methods to biochemical engineering, biomedical and bioinformatics fields. Adv. Biochem. Eng. Biotech. 91, 51-73 (2004) incorporated herein by reference).

### Artificial Neural Network

An artificial neural network (ANN) or more commonly just neural network (NN) is an interconnected group of artificial neurons that uses a mathematical model or computational model for information processing based on a connectionist approach to computation. In most cases an ANN is an adaptive system that changes its structure based on external or internal information that flows through the network. In certain embodiments, an ANN can be used for selecting target genes and sequences within a target gene for generating arrays disclosed herein. For a detailed example of a use of ANN, see the Example Section. In one exemplary embodiment, an ANN was used to analyze and derive sequences of use in the making of a chip array, namely an MChip™ array. In other embodiments, ANN can be used instead of or incombination with using a hierarchical clustering analysis method (described previously and in the Example section).

In some other embodiments, the apparatus used for detecting a viral-associated sequence indicative of a certain strain, type or subtype of a virus may include but is not limited to a microarray system, a biosensor system, a gel system, a dipping-apparatus system, a rapid test strip system, a handheld scanner system, or a microbead-based system. In accordance with these embodiments, capture probe and/or label probe oligonucleotides capable of binding a portion of nucleic acid or complimentary nucleic acid sequences of a region of a target protein (e.g. multiple target gene segments, the M segment sequences disclosed herein) may be identified and synthesized. Subsequently, these oligonucleotides can be used to generate an array system adaptable for assaying for the presence of the target sequences in a sample. In accordance with these embodiments, a dipstick, a solid surface, a gel or bead system, for example, having capture probe sequences associated with the dipstick, solid surface, gel or bead system may be used to assay for the presence of specific viral protein sequences indicative of the strain, type or subtype of a suspected virus within a sample.

It is contemplated that arrays disclosed in any of the embodiments herein can include an array bound to a solid surface or suspended in solution. Briefly, in one example, an array can be attached to a bead such as a microbead by means known in the art. Microbead arrays can, for example, be prepared by loading capture probe-coupled microspheres (e.g. diameter, 3 μm) onto the distal ends of chemically etched imaging fiber bundles. In certain embodiments, a sample of interest can be exposed to the fiber-optic array and then a second probe such as a label probe may be used to detect binding to the fiber-optic array (see for example, www.illumina.com). In addition, a single gene target of influenza may be used to generate these arrays or multiple gene targets for a multiplexed microarray can be used to target multiple gene targets of influenza. Another example array may include a capillary bead array known in the art (see for example: Kohara et al Nucleic Acids Research, 2002, Vol. 30, No. 16 e870). Other examples include may include a molecular beacon. Molecular beacons are dual-labelled probes often used in real-time PCR assays. In one example, a fluid array system is contemplated using microsphere-conjugated molecular beacons and the flow cytometer for the specific, multiplexed detection of unlabelled nucleic acids in solution. In this exemplary system, molecular beacons can be conjugated with microspheres using a linkage (e.g. biotin-streptavidin linkage). In certain examples, beads of different sizes and molecular beacons in one or more fluorophore colors, synthetic control sequences can be used to detect the presence of influenza in a sample using oligonucleotides derived from at least a portion of a nucleic acid or complimentary nucleic acid of one or more target genes disclosed herein (see for example: Horejsh et al, Nucleic Acids Res. 2005; 33(2): e13).

### Kits

In still further embodiments, kits for the methods described above are contemplated. In one embodiment, the kits have a point-of care application for example, the kits may have portability for use at a site of suspected viral outbreak. In another embodiment, a viral (such as a pathogenic or non-pathogenic virus) detection kit is contemplated. In another embodiment, a kit for analysis of a sample from a subject having or suspected of developing a virally-induced infection is contemplated. In a more particular embodiment, a kit for analysis of a sample from a subject having or suspected of developing an influenza-induced infection is contemplated. In accordance with this embodiment, the kit may be used to assess the type, subtype or strain of the virus.

The kits may include an array system such as a chip array system within a suitable vessel for a portable assay. In addition, the kit may include a stick or specialized paper such as a dipping stick or dipping paper capable of rapidly analyzing a sample for example, within a healthcare facility by a healthcare provider. In another embodiment, the kit may be a portable kit for use at a specified location outside of a healthcare facility.

The container means of any of the kits will generally include at least one vial, test tube, flask, bottle, syringe or other container means, into which the testing agent, may be preferably and/or suitably aliquoted. Kits herein may also include a means for comparing the results such as a suitable control sample such as a positive and/or negative control. A suitable positive control may include a sample of a known viral type, subtype or strain.

### Nucleic Acids

In various embodiments, isolated nucleic acids may be used for analysis to detect and/or diagnosis types, subtypes or even strains of influenza virus in a subject. The isolated nucleic acid may be derived from genomic RNA or complementary DNA (cDNA). In other embodiments, isolated nucleic acids, such as chemically or enzymatically synthesized DNA, may be of use for capture probes, primers and/or labeled detection oligonucleotides.

A “nucleic acid” includes single-stranded and double-stranded molecules, as well as DNA, RNA, chemically modified nucleic acids and nucleic acid analogs. It is contemplated that a nucleic acid may be of 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, about 110, about 120, about 130, about 140, about 150, about 160, about 170, about 180, about 190, about 200, about 210, about 220, about 230, about 240, about 250, about 275, about 300, about 325, about 350, about 375, about 400, about 425, about 450, about 475, about 500, about 525, about 550, about 575, about 600, about 625, about 650, about 675, about 700, about 725, about 750, about 775, about 800, about 825, about 850, about 875, about 900, about 925, about 950, about 975, about 1000, about 1100, about 1200, about 1300, about 1400, about 1500, about 1750, about 2000 or greater nucleotide residues in length, up to a full length protein encoding or regulatory genetic element.

### Construction of Nucleic Acids

Isolated nucleic acids may be made by any method known in the art, for example using standard recombinant methods, synthetic techniques, or combinations thereof. In some embodiments, the nucleic acids may be cloned, amplified, or otherwise constructed.

The nucleic acids may conveniently comprise sequences in addition to a type, subtype or strain associated viral sequence. For example, a multi-cloning site comprising one or more endonuclease restriction sites may be added. A nucleic acid may be attached to a vector, adapter, or linker for cloning of a nucleic acid. Additional sequences may be added to such cloning and sequences to optimize their function, to aid in isolation of the nucleic acid, or to improve the introduction of the nucleic acid into a cell. Use of cloning vectors, expression vectors, adapters, and linkers is well known in the art.

### Recombinant Methods for Constructing Nucleic Acids

Isolated nucleic acids may be obtained from bacterial, viral or other sources using any number of cloning methodologies known in the art. In some embodiments, oligonucleotide probes which selectively hybridize, under stringent conditions, to the nucleic acids are used to identify a viral sequence. Methods for construction of nucleic acid libraries are known and any such known methods may be used. [See, e.g., Current Protocols in Molecular Biology, Ausubel, et al., Eds., Greene Publishing and Wiley-Interscience, New York (1995); Sambrook, et al., Molecular Cloning: A Laboratory Manual, 2nd Ed., Cold Spring Harbor Laboratory Vols. 1-3 (1989); Methods in Enzymology, Vol. 152, Guide to Molecular Cloning Techniques, Berger and Kimmel, Eds., San Diego: Academic Press, Inc. (1987).]

### Nucleic Acid Screening and Isolation

Viral RNA or cDNA may be screened for the presence of an identified genetic element of interest using a probe based upon one or more sequences, such as those disclosed in Table 1. Various degrees of stringency of hybridization may be employed in the assay. As the conditions for hybridization become more stringent, there must be a greater degree of complementarity between the probe and the target for duplex formation to occur. The degree of stringency may be controlled by temperature, ionic strength, pH and/or the presence of a partially denaturing solvent such as formamide. For example, the stringency of hybridization is conveniently varied by changing the concentration of formamide within the range up to and about 50%. The degree of complementarity (sequence identity) required for detectable binding can vary according to the stringency of the hybridization medium and/or wash medium. In certain embodiments, the degree of complementarity can optimally be about 100 percent; but in other embodiments, sequence variations in the influenza RNA may result in <100% complementarity, <90% complimentarity probes, <80% complimentarity probes, <70% complimentarily probes or lower depending upon the conditions. In certain examples, primers may be compensated for by reducing the stringency of the hybridization and/or wash medium.

High stringency conditions for nucleic acid hybridization are well known in the art. For example, conditions may comprise low salt and/or high temperature conditions, such as provided by about 0.02 M to about 0.15 M NaCl at temperatures of about 50° C. to about 70° C. Other exemplary conditions are disclosed in the following Examples. It is understood that the temperature and ionic strength of a desired stringency are determined in part by the length of the particular nucleic acid(s), the length and nucleotide content of the target sequence(s), the charge composition of the nucleic acid(s), and by the presence or concentration of formamide, tetramethylammonium chloride or other solvent(s) in a hybridization mixture. Nucleic acids may be completely complementary to a target sequence or may exhibit one or more mismatches.

### Nucleic Acid Amplification

Nucleic acids of interest may also be amplified using a variety of known amplification techniques. For instance, polymerase chain reaction (PCR) technology may be used to amplify target sequences directly from viral RNA or cDNA. PCR and other in vitro amplification methods may also be useful, for example, to clone nucleic acid sequences, to make nucleic acids to use as probes for detecting the presence of a target nucleic acid in samples, for nucleic acid sequencing, or for other purposes. Examples of techniques of use for nucleic acid amplification are found in Berger, Sambrook, and Ausubel, as well as Mullis et al., U.S. Pat. No. 4,683,202 (1987); and, PCR Protocols A Guide to Methods and Applications, Innis et. al., Eds., Academic Press Inc., San Diego, Calif. (1990). PCR-based screening methods have been disclosed. [See, e.g., Wilfinger et al. BioTechniques, 22(3): 481-486 (1997).]

### Synthetic Methods for Constructing Nucleic Acids

Isolated nucleic acids may be prepared by direct chemical synthesis by methods such as the phosphotriester method of Narang et al., Meth. Enzymol. 68:90-99 (1979); the phosphodiester method of Brown et al., Meth. Enzymol. 68:109-151 (1979); the diethylphosphoramidite method of Beaucage et al., Tetra. Lett. 22:859-1862 (1981); the solid phase phosphoramidite triester method of Beaucage and Caruthers, Tetra. Letts. 22(20):1859-1862 (1981), using an automated synthesizer as in Needham-VanDevanter et al., Nucleic Acids Res., 12:6159-6168 (1984); or by the solid support method of U.S. Pat. No. 4,458,066. Chemical synthesis generally produces a single stranded oligonucleotide. This may be converted into double stranded DNA by hybridization with a complementary sequence or by polymerization with a DNA polymerase using the single strand as a template. While chemical synthesis of DNA is best employed for sequences of about 100 bases or less, longer sequences may be obtained by the ligation of shorter sequences.

### Covalent Modification of Nucleic Acids

A variety of cross-linking agents, alkylating agents and radical generating species may be used to bind, label, detect, and/or cleave nucleic acids. In addition, covalent crosslinking to a target nucleotide using an alkylating agent complementary to the single-stranded target nucleotide sequence can be used. A photoactivated crosslinking to single-stranded oligonucleotides mediated by psoralen can be used. Use of N4,N4-ethanocytosine as an alkylating agent to crosslink to single-stranded oligonucleotides has also been disclosed. Various compounds to bind, detect, label, and/or cleave nucleic acids are known in the art.

### Nucleic Acid Labeling

In various embodiments, tag nucleic acids may be labeled with one or more detectable labels to facilitate identification of a target nucleic acid sequence bound to a capture probe on the surface of a microchip. A number of different labels may be used, such as fluorophores, chromophores, radio-isotopes, enzymatic tags, antibodies, chemiluminescent, electroluminescent, affinity labels, etc. One of skill in the art will recognize that these and other label moieties not mentioned herein can be used. Examples of enzymatic tags include urease, alkaline phosphatase or peroxidase. Colorimetric indicator substrates can be employed with such enzymes to provide a detection means visible to the human eye or spectrophotometrically. A well-known example of a chemiluminescent label is the luciferin/luciferase combination.

In preferred embodiments, the label may be a fluorescent, phosphorescent or chemiluminescent label. Exemplary photodetectable labels may be selected from the group consisting of Alexa 350, Alexa 430, AMCA, aminoacridine, BODIPY 630/650, BODIPY 650/665, BODIPY-FL, BODIPY-R6G, BODIPY-TMR, BODIPY-TRX, 5-carboxy-4′,5′-dichloro-2′,7′-dimethoxy fluorescein, 5-carboxy-2′,4′,5′,7′-tetrachlorofluorescein, 5-carboxyfluorescein, 5-carboxyrhodamine, 6-carboxyrhodamine, 6-carboxytetramethyl amino, Cascade Blue, Cy2, Cy3, Cy5,6-FAM, dansyl chloride, Fluorescein, HEX, 6-JOE, NBD (7-nitrobenz-2-oxa-1,3-diazole), Oregon Green 488, Oregon Green 500, Oregon Green 514, Pacific Blue, phthalic acid, terephthalic acid, isophthalic acid, cresyl fast violet, cresyl blue violet, brilliant cresyl blue, para-aminobenzoic acid, erythrosine, phthalocyanines, azomethines, cyanines, xanthines, succinylfluoresceins, rare earth metal cryptates, europium trisbipyridine diamine, a europium cryptate or chelate, diamine, dicyanins, La Jolla blue dye, allopycocyanin, allococyanin B, phycocyanin C, phycocyanin R, thiamine, phycoerythrocyanin, phycoerythrin R, REG, Rhodamine Green, rhodamine isothiocyanate, Rhodamine Red, ROX, TAMRA, TET, TRIT (tetramethyl rhodamine isothiol), Tetramethylrhodamine, and Texas Red. These and other labels are available from commercial sources, such as Molecular Probes (Eugene, Oreg.).

### EXAMPLES

The following examples are included to illustrate various embodiments. It should be appreciated by those of skill in the art that the techniques disclosed in the examples which follow represent techniques discovered to function well in the practice of the claimed methods, compositions and apparatus. However, those of skill in the art should, in light of the present disclosure, appreciate that many changes may be made in the specific embodiments which are disclosed and still obtain a like or similar result without departing from the spirit and scope of the invention.

### Materials and Methods

Implementation/Programs. In certain embodiments, the BioEdit software package (v.7.0.4.1) was used to visualize sequences [Hall, 1999]. Wherever possible, other programs were run as accessory applications within the BioEdit interface. Multiple sequence alignment was performed using Clustal W (v. 1.4) [Thompson et al., 1994]. DNADIST (v. 3.5c in PHYLIP v. 3.6) was used to create phylogenetic trees. TreeView (Win32, v.1.6.6) [Page, 1996] and MEGA3 (v. 3.0) [Kumar et al., 20004] were used to display and manipulate phylogenetic trees. In addition to these existing programs, a number of Python scripts were written and implemented as shown below. The software is available under the GNU General Public License at www.colorado.edu/chemistry/RGHP/software/.
label-tree. labels each node in a .dnd file (phylogenetic tree) with a unique integer to facilitate the visualization and subdivision of phylogenetic trees.
dnd2fa. converts the information in a .dnd (or Newick .nwk) file back to a FASTA file containing sequence information.
fa2fa. allows the contents of one FASTA file to be subtracted from another, outputting a file containing the remaining sequences.
ConFind. identifies conserved regions in a specified dataset [Smagala et al., 2005]
Find oligos. chooses all appropriate capture and label sequences by iteratively walking along the conserved region until minimum GC content, melting temperature, and Shannon entropy requirements are met.
pick oligos. ranks the potential capture and label probe output from ‘find_oligos’ based on length, Shannon entropy, and melting temperature; chooses the oligo pairs with the lowest penalty without allowing the nucleotide positions of the oligos to overlap with other capture-label pairs.

Databases. Sequence information for a large number of influenza viruses can be found for example from publicly available databases at the Los Alamos National Laboratories (www.flu.lanl.gov/) [Macken et al., 2001] and the database held by the Centers for Diseases Control and Prevention in Atlanta, Ga. One database used to BLAST (Basic Local Alignment Search Tool) the identified sequences was created containing human genome sequence information obtained from the EST (Expressed Sequence Tags) database and sequence information for several organisms that cause influenza like illnesses. Example organisms include but are not limited to, Influenza B and C, Paramyxovirus, Rhinovirus, Respiratory syncytial virus, Bacillus anthracis, Coronaviruses, Adenoviruses, Legionella spp., Chlamydia pneumoniae, Mycoplasma pneumoniae and Streptococcus pneumoniae from the NCBI nonredundant database (ftp.ncbi.nlm.nih.gov/blast/db/). The top strand only of each capture and label probe was BLASTed against this database. By default, BLAST uses the top and bottom strand, i.e., the sequence and its reverse complement to search for sequence similarities in the database. Individual sequences with an E value lower than 10000 were considered to be a “hit”, e.g. capable of binding or to hybridize to a non influenza sequence.

### One Experimental Approach

One exemplary method concerns an experimental approach for generating capture and label probes of amplified RNA on a microarray used in Example 1. Briefly, a capture probe is immobilized on a solid substrate and binds target RNA during hybridization. In this example, the captured target is bound to the capture probe and the target is detected using an additional fluorophore-conjugated oligonucleotide (e.g. the label probe). After hybridization and rigorous washing, the microarray is scanned in a laser-based (532 nm excitation) fluorescence scanner at 5 μm resolution.

Sequence Selection and FluChip-55™ Microarray Design. Influenza specific capture and label sequences were selected using the methodology described in Example 1. A total of 103 capture/label pairs were selected for analysis on the FluChip™ apparatus. The possibility of false positive signals resulting from direct hybridization of label sequences to capture sequences was examined by incubation of labels, in the absence of any other nucleic acids, at room temperature for 2 h in standard hybridization buffer. Capture probes found to exhibit cross-reactivity with label probes were removed from the array layout, along with the corresponding label probes, and the array reprinted. This process was repeated until the microarray exhibited no false positives in the absence of viral RNA.

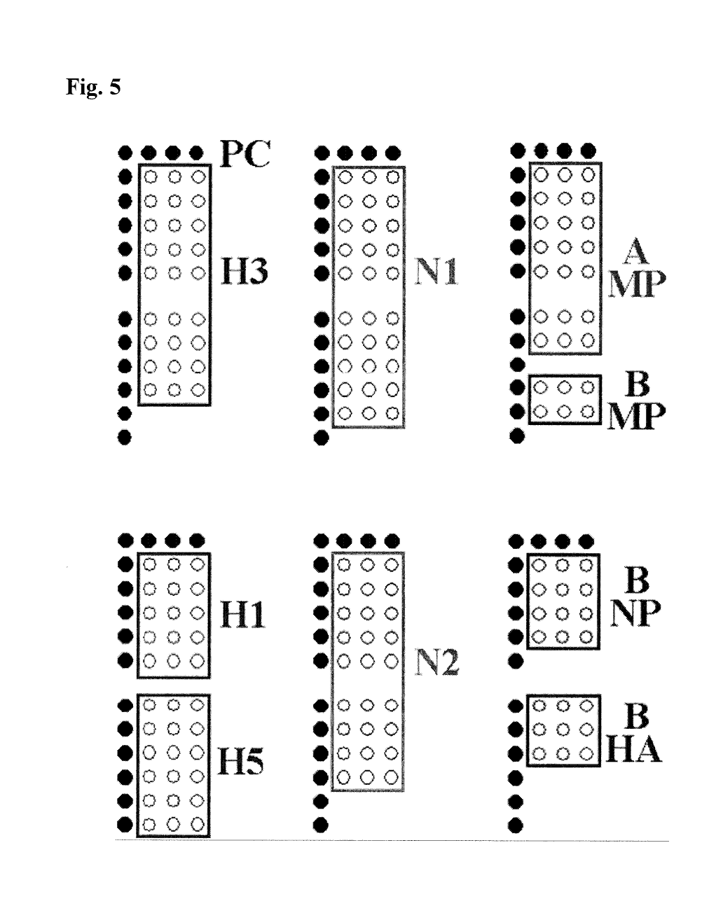

The resulting array contained 55 capture probes, and corresponding label probes (see Table 3). The final version contained 20 capture/label probe pairs for influenza A/HA gene, 19 for A/NA, 7 for A/MP, 2 for influenza B/MP gene, 4 for B/NP, and 3 for B/HA. The array layout used for the blind study of viral RNA from isolates provided by the CDC is shown in FIG. 5. Each capture probe was spotted in triplicate. A single capture probe with a complementary fluor-labeled sequence in solution was used as a positive control on each array. The positive control served as a direct indication of whether or not the hybridization conditions were adequate but also as a spatial marker for ease of viewing.

Microarray Slide Preparation. In this example, the substrate used for all of the studies reported herein was an aldehyde-modified glass microscope slide (Cel Accociates Inc., Pearland, Tex.). Additional details relating to the oligo spotting technique have been reported. In another example, the 5′-amino-C6-modified capture sequences (Operon Biotechnologies, Inc., Huntsville, Ala.) were spotted onto the slides at 10 μM concentration in a spotting buffer containing 3×SSC (1×SSC: 150 mM NaCl, 15 mM sodium citrate, pH 7.0), 50 mM sodium phosphate and 0.005% sarcosyl. A Genetix OmniGrid (Genetix, Boston, Mass.) microarray spotter was used with solid core pins and a 550 μm pitch between spots. Additional slides were printed under identical conditions on a MicroGrid II Compact arrayer (Genomic Solutions Inc., Ann Arbor, Mich.) for pre-testing studies. After spotting, slides were stored under 100% relative humidity overnight and stored in a sealed container at −20° C. until further use.

Samples. The CDC provided 72 samples for a blind study of FluChip-55 microarray. The sample set was later revealed to contain three negative controls: two water samples and one that contained bovine serum albumin. An independent negative (water) was added to the sample set for control purposes. The provided viral isolates represented samples from human, avian, equine, canine, and swine species. The original samples were acquired by a range of techniques, including throat swabs, nasopharyngeal swabs, tracheal aspirates or bronchoalveolar lavage. The viruses were propagated in either embryonated eggs or MDCK cells.

In one example, genomic RNA was extracted directly from allantoic fluid or cell culture supernatant with the RNeasy kit (Qiagen, Valencia, Calif.). Virus type and subtype were pre-determined at the CDC by sequencing of the hemagglutinin and neuraminidase genes. Samples were provided as unknowns in a 96 well plate and subsequently identified by the well number of that plate (e.g., sample A1 came from row A, Column 1). The first round of studies was conducted blind, the type or subtype of the samples were unknown. After initial analysis of the results, the complete sample set was processed again independently for evaluation of reproducibility.

RNA Amplfication. Viral RNA from each isolate was amplified using reverse transcription (RT), followed by PCR, and subsequent run-off transcription using the PCR product as a template. Reverse-transcription was performed with SuperScript TI Reverse Transcriptase (e.g. Invitrogen Corp., Carlsbad, Calif.) using either SZA+ or SZB+ ‘universal’ influenza primers as previously described. PCR for influenza A was performed using an optimized concentration of previously disclosed primers to amplify the MP, HA and NA genes (see Table 3). The PCR conditions, in this example, were: 94° C. for 2 min, then two cycles of 94° C. for 30 sec, 50° C. for 30 sec and 72° C. for 2 min, followed by 35 cycles of 94° C. for 30 sec, 60° C. for 30 sec and 72° C. for 90 sec with a 5 sec increment per cycle, and 72° C. for 10 min. PCR products were visualized on a 1% ethidium bromide stained agarose gel to evaluate amplification. Samples that showed little or no visible product in an agarose gel were subsequently amplified with influenza B specific primers.

Two novel primers were used to amplify the HA gene of influenza B (Table 3). The PCR conditions used for B amplification were: 94° C. for 2 min, 30 cycles of 94° C. for 1 min, 50° C. for 2 min, and 72° C. for 3 min and finally 72° C. for 10 min. The 5′ PCR primer used during RT-PCR included a promoter site that allowed run-off transcription with T7 RNA polymerase (Invitrogen Corp., Carlsbad, Calif.). Crude transcribed RNA was stored at −20° C. until needed.

RNA Quantification. Solutions of RNA with known concentration were used to determine the amount of sample loss during cleanup with the Qiagen RNeasy mini kit (Qiagen, Valencia, Calif.). Transcribed viral RNA was purified using the RNeasy kit and quantified by measurement of optical absorbance at 260 nm (A260). The concentration of RNA in the crude transcription product was back calculated. Transcription reactions produced an average of 300 μg/ml of RNA.

RNA Fragmentation and Hybridization. Transcribed RNA was fragmented prior to hybridization on the microarray as described. (Mehlmann, M. et al. “Optimization of fragmentation conditions for microarray analysis of viral RNA,” Anal Biochem. 2005 Dec. 15; 347(2):316-23. Epub 2005 Oct. 17, incorporated herein by reference in its entirety). Briefly, 1 μl of 5× fragmentation buffer (200 mM Tris-acetate, 500 mM potassium acetate, 150 mM magnesium acetate, pH 8.4) and 4 μl of transcribed RNA were incubated at 75° C. for 25 min. The samples were then placed on ice and 15 μl of quenching/hybridization buffer were added to a final concentration of 4×SSPE (1×SSPE: 150 mM NaCl, 10 mM NaH₂PO₄, 1 mM EDTA, pH 7.0), 30 mM EDTA, 2.5×Denhardt's solution, 30% deionized formamide, and 200 nM each of the appropriate 5′ modified Quasar® 570 ‘label’ sequences (Biosearch Technologies, Novato, Calif.).

Slides used for hybridization were sequentially pre-washed for 5 min in each of 0.1% SDS/4×SSC, 4×SSC, ddH₂O, and finally in near boiling water and then spun dry until use. Hybridizations were carried out for 2 h at room temperature. After hybridization, the slides were washed for 5 min in each of 0.1% SDS/2×SSC, 0.1% SDS/0.2×SSC, 0.2×SSC and briefly rinsed in ddH₂O prior to spin-drying.

Microarray Imaging and Analysis. Hybridized samples were scanned using a Bio-Rad VersArray scanner (Bio-Rad Laboratories, Hercules, Calif.) with 532 nm detection, laser power and PMT sensitivity of 60% and 700 V, respectively, and 5 μm resolution. Image contrast was optimized using Photoshop (Adobe, San Jose, Calif.). Although quantitative evaluation was performed on a sub-set of images, given the clarity of the images, analysis was performed by visual inspection. Control conditions: each of 5 volunteers was provided with the microarray layout (as in FIG. 5) and asked to assign a type and subtype to each image. The analysis step was conducted as a blind study for both the initial round of experiments as well as the duplicate round. As described in greater detail in the results section, the volunteers' results were combined to produce a statistical evaluation for the overall assay and the FluChip™ apparatus for virus identification.

Microarray Limit of Detection (LOD). The LOD, as defined by a ratio of fluorescence signal (minus background) to noise in the background of greater than 3, was determined for quantitative evaluation of images after hybridization of MP RNA. Briefly, sample D2 was amplified with MP specific primers by RT-PCR and T7-transcribed using the conditions described above. A dilution series of the MP RNA was created, fragmented and hybridized. Images were scanned as described above and processed with VersArray Analyzer Software (BioRad Laboratories, Hercules, Calif./Media Cybernetics, Silver Spring, Md.).

### Example 1

### Selection of Influenza Virus Target Sequences for Detection and Identification of Types, Subtypes and/or Strains

One exemplary method discloses an efficient method for analyzing large databases in order to identify regions of conservation in the influenza viral genome. From these regions of conservation, capture and label sequences capable of discriminating between different viral types and subtypes were selected. Features of the method include the use of phylogenetic trees for data reduction and the selection of a relatively small number of capture and label probes to represent a broad spectrum of influenza viruses. A detailed experimental evaluation of the selected sequences is described in below.

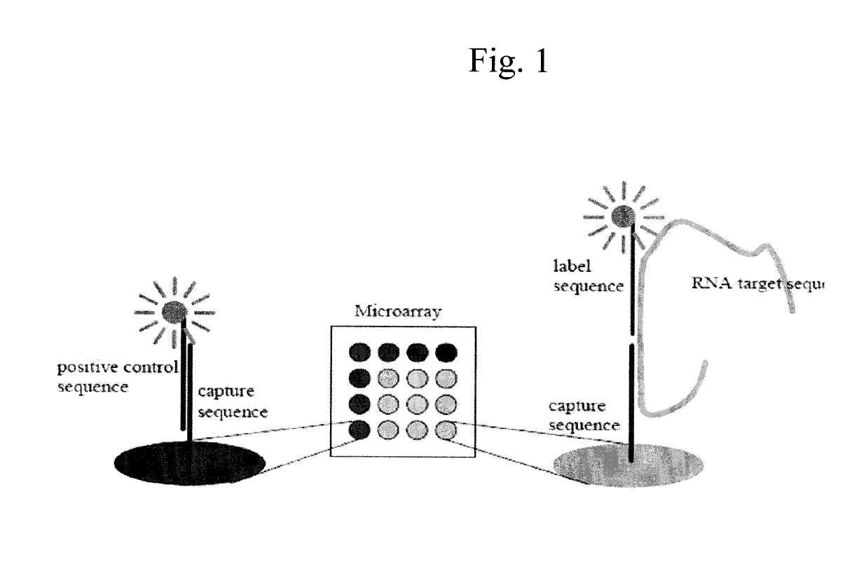

FIG. 1 represents one method used to direct capture and detection of viral RNA using a two-step hybridization process. In one aspect, several hurdles exist for obtaining the much needed sequence information for designing arrays contemplated herein. It is desirable to use limited numbers of capture probes capable of binding many viral targets belonging to a specific subtype. This is a different situation than that encountered for gene expression studies in which the capture probes are derived from single, specified gene with known sequence.

Next, influenza is an RNA virus with a high mutation rate. Regions of conservation determined at one point in time will likely change as the virus mutates. The high mutation rate requires a rapid, reliable method to reduce the currently-available dataset of interest to a set of oligonucleotides capable of binding to at least a portion of nucleic acid sequences that include a simple, functional array.

Then, many publicly-available databases with sequence information exist. In fact, the National Institutes of Health is currently funding the National Institute for Allergic and Infectious Disease Influenza Genome Sequencing Project, aimed at the rapid availability of the complete sequences of thousands of influenza viruses (see for example: www.niaid.nih.gov/dmid/genomes/mscs/default.htm#influenza). As such databases are continually growing, a systematic method of extracting desired information from them is required

Probe design for oligonucleotide microarrays has been the subject of recent reviews, [Russell, 2003; Tomiuk and Hofmann, 2001] and several software tools have been developed to design microarray probes. For example, OligoWiz [Wernersson and Nielsen, 2005; Nielsen et al., 2003] is a program that searches for potential probes by taking into account five different parameters: specificity, melting temperature, position within transcript, complexity and self annealing ability. The user assigns weights to each of these parameters and a sum score is calculated. The program returns oligonucleotides having the best scores. In addition, there are other programs available that are not specifically designed for microarray oligo selection but are used to find and optimize primers, especially for large scale sequencing purposes.

The objective of most currently available sequence selection tools, such as those mentioned above, is to find primers or probes targeting a single gene within a single organism. In general, sequences for an experiment are chosen based on their specificity for the target, similarity in hybridization conditions, inability to cross-hybridize, and ‘coverage’ of the genes of interest by the sequence set.

For typing and subtyping of influenza viruses, the objective is more demanding since the capture and label probes should not only target a single gene of a specific virus strain but should target many viruses of the same subtype. To design such capture and label sequences, sequences from a set of virus strains has to be examined in order to identify regions that are capable of targeting multiple viruses.

Using PROFILES, Rodrigues et al. (1992) calculated ‘homology profiles’ for aligned sequences from foot-and-mouth disease viruses by creating a consensus sequence and recording the number of sequences showing a nucleotide difference from this consensus sequence. These profiles were used to visualize similarities or differences between sequences, and primer pairs were then chosen manually by simply inspecting the ‘homology profiles’.

Primer Premier (PREMIER Biosoft International, Palo Alto, Calif.) is an example of an existing commercial program for designing primer and microarray sequences for a given set of sequences. A limiting requirement in its application to large databases for highly mutable viruses such as influenza, which often contain incomplete and non-overlaping regions, is that all sequences in the set must contain data over a specific nucleotide range. In contrast, the method presented herein is more robust as it allows conserved regions to be identified even when only a fraction of the set includes incomplete regions.

PRIME [Gibbs et al., 1998] is an existing program most similar in regards to examining a set of sequences. Beginning with an aligned set of sequences, GPRIME finds homologous regions of a specific length in a dataset using an ‘ambiguity consensus.’ In an application described by Gibbs et al. (1998), the homologous regions were manually selected by examining redundancy values, melting temperatures (Tm), gaps, and possible secondary structure. Chosen sequences were compared to the EMBL database using a FASTA search to determine their specificity for the target genomes. Also outlined was a tool that identifies sequence regions where PCR primers could distinguish between two subsets of data by noting differences between consensus sequences from the two datasets. The chosen sequences were tested for their ability to prime separate RT-PCR reactions with RNA extracted from orchid leaves showing virus symptoms. Although applied to very limited datasets and not used for microarray applications, these programs introduced the idea of a more systematic approach to the selection of capture oligonucleotides for diagnostic applications.

The method described herein for efficient identification of capture and label pairs begins with a set of aligned sequences. In contrast to the limited data-sets used by GPRIME, however, the individual gene-specific databases in this study contained up to 1000 sequences or more. Conserved regions of a minimum length meeting certain Shannon entropy requirements were found using a ‘majority consensus.’ The method described here can be used for designing array probes as well as primers for PCR experiments.

This study developed an algorithm for mining large databases to find potential capture and label sequences that enabled the typing and subtyping of a wide range of different influenza viruses on a microarray. As discussed in Example 2 below, the microarray assay consisted of immobilization of a short (˜25-mer) “capture” DNA oligonucleotide on a microarray surface, hybridization of influenza RNA to the capture sequence, and detection by the hybridization of a fluorophore-conjugated “label” DNA oligonucleotide (˜25-mer) to a second region on the target RNA. In addition, several positive control spots in which a capture probe annealed directly to a complementary label probe were included in the microarray design for ease of viewing (FIG. 1).

The capture and label sequences were designed to meet a set of defined criteria:

The sequences were specific for a targeted gene segment and showed no cross-reactivity with other capture and label sequences.

The sequences were conserved over a wide range of influenza viruses in order to allow the typing and subtyping of as many different influenza viruses as possible.

Each capture and label probe was between 16 and 25 nt in length (these lengths result in a sufficiently high melting temperature and sufficient specificity). For reasons described by Chandler et al. (2003) the capture and label probewere adjacent to one another, separated by only one nucleotide. A conserved region of at least 45 nt in length allowed for capture and label sequences within these limits.

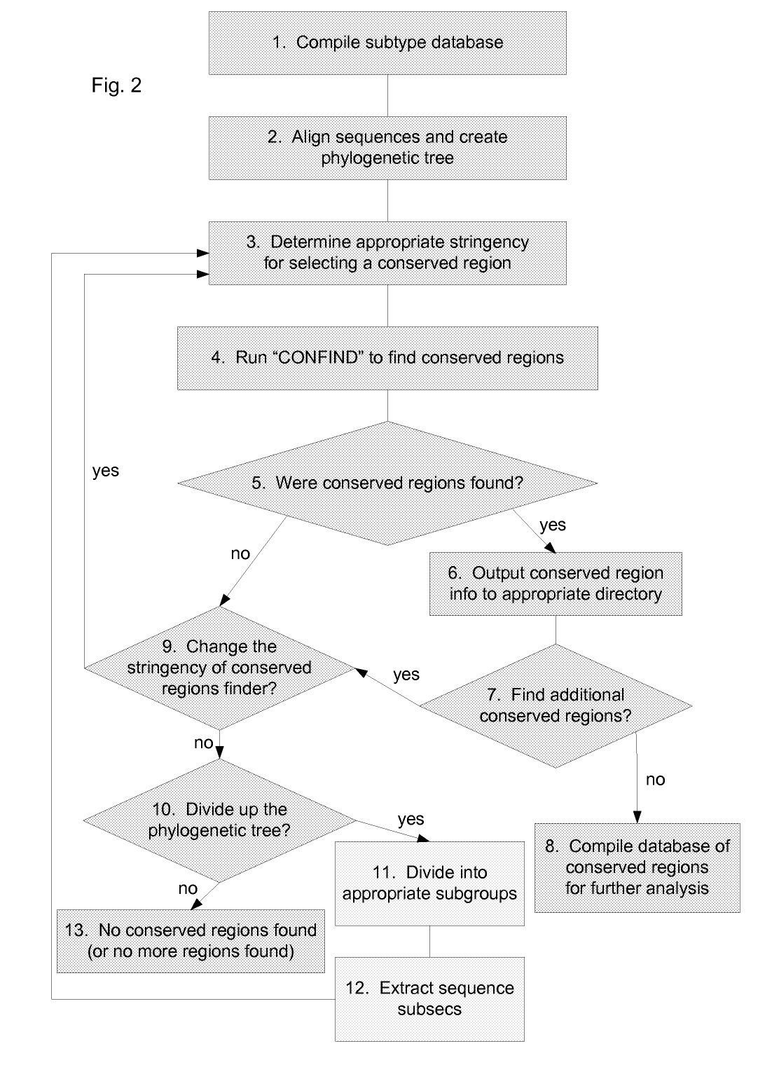

Method Development—Finding Conserved Regions. The flowchart shown in FIG. 2 describes the overall process of finding conserved regions for a specific database of interest. From all available sequences, gene-specific databases containing sequences only of a specific gene and subtype (e.g., influenza A, HA gene, H1 subtype) were created and converted to FASTA (a sequence alignment package) format (FIG. 2, step 1). In certain cases, the gene-specific database created was limited by specification of a starting year, especially for viral subtypes that were highly circulating and, as a result, frequently sequenced. Once the gene-specific database was created, a multiple sequence alignment was performed on the dataset using ClustalW (step 2) v.1.4 [Thompson et al., 1994]. A multiple alignment was performed using the FAST algorithm with bootstraps=1000 and ktuple=4. Additionally, a neighbor-joining phylogenetic tree was created. A more rigorous phylogenetic tree using a maximum likelihood or parsimony method is possible, however, the neighbor-joining algorithm was chosen due to the large size of the databases and the computational time involved in applying a more rigorous method. The nodes of the phylogenetic tree were arbitrarily numbered to assist in later dividing the tree.

The CONserved regions FINDer (called ‘ConFind’, FIG. 2 step 4) was written in-house and modeled after the ‘Find Conserved Regions’ option in BioEdit. A full description of this available software can be found elsewhere [Smagala et al., 2005]. The ‘Find Conserved Regions’ in BioEdit requires that all sequences contain data over a specific nucleotide range. Briefly, ‘ConFind’ was written to allow conserved regions to be found even when only a fraction of the included sequences contain sequence information at certain positions.

This program runs in the BioEdit interface, and values can be set for the minimum length of a conserved region, the maximum allowed bits of Shannon entropy per base, number of allowed exceptions to this Shannon entropy requirement, and the minimum number of sequences required at a position in order for that position to be considered for conservation. The default values were set to a minimum length of 45 nt, 0.2 allowed bits of Shannon entropy per base (with 2 allowed exceptions), and a minimum of 10 sequences. The stringency of these requirements (step 3) was often changed to enable the selection of more or less conserved regions, depending on the particular situation.

‘ConFind’ was applied to a gene-specific database using the default stringency requirements, as noted in step 4 of FIG. 2. If conserved regions were found, information regarding the original sequence information, positions of the conserved region, and positional Shannon entropies were output to file, noted in FIG. 2, step 6. If conserved regions were not found, the stringency was loosened, and the procedure repeated. Often, even when very loose stringency requirements were applied, the genetic variability of influenza viruses prevented the identification of conserved regions over an entire genespecific database (sometimes containing 1000+sequences). The phylogenetic tree was then examined and divided into smaller subtrees, shown as steps 10 and 11, in an effort to find additional regions of conservation. This process was not automated, as a number of different criteria could potentially be established to determine sequence “difference” or “similarity”, such as virus age, geographic region, host organism, etc.

The power of this analysis lies in the fact that the process is very goal-specific, and a different desired end goal may result in a different breakdown of the phylogenetic tree. The subtrees (in Newick tree format containing no sequence information) were extracted from the main tree and converted back to FASTA format (step 12) to be used as subsequent input at step 3. The phylogenetic trees were originally broken down into as few subsets as were necessary, as one of the goals was to capture the largest number of “different” influenza viruses with a limited set of capture and label sequences. Once conserved regions were found that adequately represented the sequences in the examined gene-specific database, capture and label sequences were selected.

Method Development—Selection of Capture and Label Sequences from Conserved Regions. While ‘conservation’ of a sequence within a large number of influenza viruses is an important criterion, several other criteria were established in order to optimize selection of capture-label pairs, including secondary structure melting temperatures, G/C content and length. Initially, 28 capture/label sequences representing influenza A HA subtypes 1, 3, A/NA subtypes 1 and 2 and A/MP were manually selected based on a “score” (described below) that reflected all of the specified criteria. The selection routine was then automated for the selection of a much larger pair set.

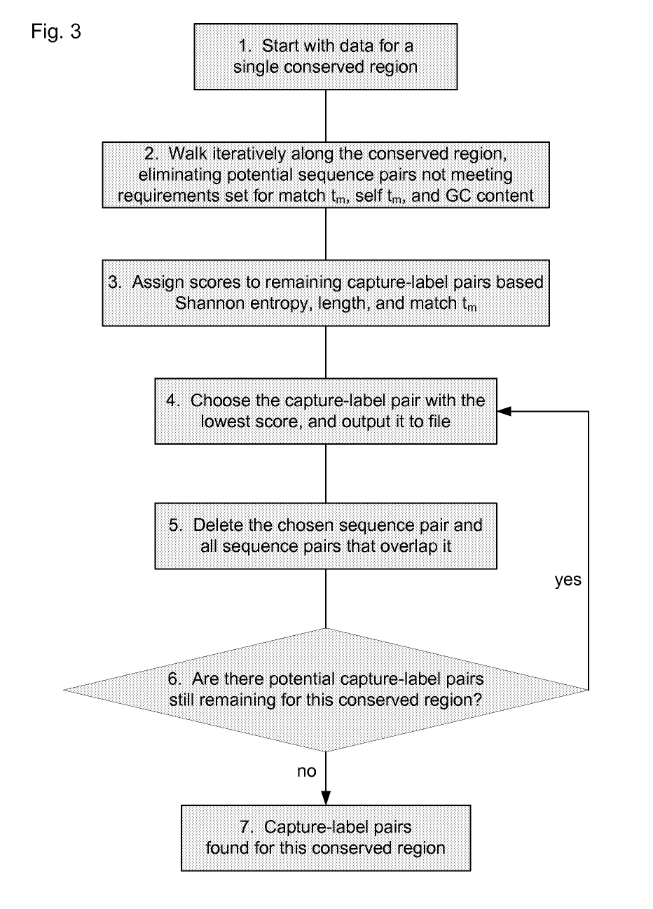

For automated sequence selection, an additional program (‘find_oligos’) was written that allowed the identification of all possible capture-label pairs within a single conserved region. As outlined in FIG. 3, the algorithm walks iteratively, starting at position one, along the conserved region and searches for pairs of sequences separated by one nucleotide. Additional requirements are a length for each sequence between 16-25 nt, a minimum melting temperature for the annealing to the reverse complement (match Tₘ) for both label and capture sequences of 50° C., a maximum melting temperature of 35° C. for the most probably secondary structure as determined by MFOLD [Zuker et al., 1999], and a GC content between 30-70%. Because of the length range of 16-25 nt for each sequence, several pairs with different lengths could be found for each starting position. If several pairs were found, the pair with highest conservation, i.e. the pair with the lowest maximum Shannon entropy score, was chosen. If several potential capture-label pairs still remained for this start position, the longest one was chosen (FIG. 3, step 2). An additional program ‘pick oligos’ was written to rank the identified possible capture-label pairs (FIG. 3, step 3) according to the following rules.

“Good” capture and label pairs should be highly conserved (e.g. low Shannon entropy) and any highly mutable positions present should be located on separate oligos. To improve the stability of the hybridization, longer oligos with a higher melting temperature are preferred. The ranking was performed by defining a set of penalties as outlined in Table 1. The penalty values were chosen empirically so that the ranking results from the ‘pick oligos’ program on a test dataset matched the results of a manual ranking performed by a skilled researcher. The ‘pick oligo’ program chose the capture-label pair with the lowest penalty and removed capture-label pairs that had a sequential overlap with the chosen pair (FIG. 3, step 4+5). This process was iterated until no potential capture-label pairs remained.

TABLE 1
Empirical penalties assigned to potential capture-label pairs
for final sequence selection.

| | Assigned penalty | |
|---|---|---|
| Criterion | value | Explanation, notes |
| total Shannon | 10 g(E1 + E2) | |
| entropy penalty | | |
| E1 > 0.1 | 15 | extra penalty for high |
| E2 > 0.1 | 15 | mismatch probability |
| both E1, E2 on | 10 | E1, E2 on separate oligos |
| the same oligo | | preferred to minimize potential |
| | | mismatches |
| E1, E2 > 0.1 AND | 20 | |
| both E1, E2 on | | |
| the same oligo | | |
| tₘ | 1/tₘ (in ° C.) | higher melting temperature |
| | | preferred |
| length | 1/length (in ml) | longer sequence preferred |

*E1 and E2 are the two highest Shannon entropies within the examined capture-label pair

For stability, it is preferable to have two potential mismatches on two separate sequences rather than to have two potential mismatches on a single sequence.

Method Implementation. A total of 4917 influenza sequences were divided into 15 different smaller gene-specific databases as shown in Table 2, representing different gene specific subtypes (e.g. H1, N1, N3). Databases containing very large numbers of sequences (>1000) were generally reduced by investigating only relatively recent viruses, which is reasonable considering the rapid evolutionary nature of influenza. ‘ConFind’ was used to find conserved regions using the genespecific database, and if none were found, the database was divided into smaller subsets as discussed later. The total numbers of conserved regions for each gene-specific database are shown in Table 2.

A unique aspect of the presented method to find capture and label pairs was the ‘breakdown’ of the original gene-specific database into several smaller subsets. This ‘breakdown’ was a very problem-specific task. Depending on the research objectives, the breakdown can be conducted according to a large number of different criteria, such as phylogenetic lineage, virus age, geographic region of origin, host species, or sample pretreatment.

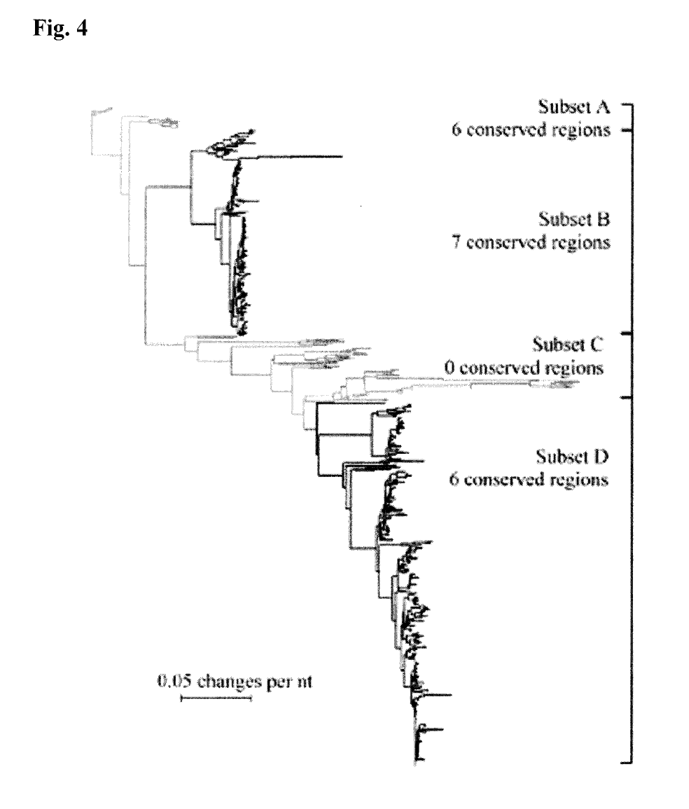

For the influenza microarray, each gene-specific database was subdivided according to phylogenetic information, as there is a connection between phylogenetic information and antigenicity. As an example, the breakdown of the tree for the N1 subtype of the NA gene of influenza A is shown in FIG. 4. In this example, using the parameters described in the Finding Conserved Regions section no conserved regions were found for the complete set of 499 N1 sequences. A visual inspection of the phylogenetic tree suggested a logical breakdown into four smaller subsets, which were analyzed separately. Subset A consisted of 16 sequences, all of which were of the H1N1 subtype and most were strains circulating in humans before 1950.

TABLE 2
Description of original influenza sequence databases and results from applying
described conserved region and sequence selection methods

| Database | | | | | |
|---|---|---|---|---|---|
| | Gene segment | | Total number | Number of | Number of |
| Influenza | and type (if | Years | of sequences | conserved | capture-label |
| type | applicable) | Included¹ | in database | regions found | pairs found |
| A | HA (H1) | 2000+ | 230 | 10 | 7 |
| A | HA (H5) | 2000+ | 248 | 45 | 27 |
| A | HA (H7) | 2000+ | 156 | 15 | 15 |
| A | HA (H9) | all | 326 | 17 | 13 |
| A | NA (N1) | all | 499 | 133 | 106 |
| A | NA (N2) | all | 1012 | 40 | 28 |
| A | NA (N3) | all | 44 | 15 | 25 |
| A | NA (N7) | all | 9 | 9 | 8 |
| A | NP | all | 487 | 53 | 43 |
| A | MP | 2000+ | 540 | 77 | 41 |
| B | HA | all | 343 | 66 | 39 |
| B | MP | all | 31 | 11 | 7 |
| B | NP | all | 32 | 12 | 8 |
| Totals | | | 4917 | 629 | 447 |

¹year indicated is the earliest year included, whereas ‘all’ indicates sequences from all available years were included is the analysis

A total of 6 conserved regions were found for this subset. Subset B (156 sequences) contained, with only few exceptions, sequences from recently circulating viruses (within the last 10 years) of the H1N1 subtype that infected humans. For this subset 7 conserved regions were found. Subset C (51 sequences) contained mostly sequences from influenza viruses of the H1N1 subtype circulating in animals from the late 1970's to 1990's. Subset C can be considered a transition between the animal N1 sequences from subset D and the human N1 sequences from subset B. Due to the large genetic divergence between the animal and human strains, no conserved regions were initially found for subset C. Subset D contained 276 sequences from the last 8 years, which were mostly of the H5N1 subtype. While these H5N1 strains were mostly circulating in avian species, subset D also contained 31 avian strains that had been contracted by humans. A total of 6 conserved regions were found for subset D. As subsets B and D both contained sequence information from viruses that recently infected humans, these subsets were further evaluated in a manner similar to that described for the initial breakdown.

Subset C was also further analyzed, as no conserved regions were found initially. The determination of sufficient conserved regions within a specific dataset was only the first step in the sequence selection process and resulted in conserved regions of variable length (Table 2, column 5). However, the microarray assay required an immobilized capture oligonucleotide and a separate fluorophore-labeled oligonucleotide, both 16-25 nt in length, that would anneal to the target molecule with a one nt gap. Therefore, the next step involved finding all suitable capture and label pairs within a conserved region. Suitable capture and label pairs were found by using the scripts ‘find_oligos’ and ‘pick_oligos’. The ‘find_oligos’ program was used to find all potential capture and label pairs within a conserved region, while the ‘pick oligos’ program ranked the found sequences according to Shannon entropy, melting temperature, and length as discussed above. In addition, the ‘pick_oligo’ program also chose the capture-label pairs with the best (lowest) scores.

Evaluation of Potential Interferences. The final step in selecting capture and label sequences for generating oligonucleotides of a target gene for identifying influenza was to search for potential cross-hybridizations using BLAST. In this example, an additional database was needed that contained sequences from potential interfering species that might be present in the target RNA hybridization mixture and might also hybridize to the identified capture and label pairs resulting in false positive signals. Since it was impractical to BLAST against all available genomes, a smaller database was created to include human mRNA and genomes from other microorganisms that cause influenza like illness, as well as genomes for influenza B and C (as described in the Materials and Methods section). Because of the two-step hybridization, false-positive signals from non-target organisms can only be observed on a microarray if one of the capture sequences together with any of the label sequences hybridizes to the same gene. Thus, if a capture probe was found to “hit” or bind at least a portion of a gene within the database, a second level of comparison was conducted to check whether a label probe also bound. If both capture and label sequences were found to hit the same gene, the sequence was discarded as a possible source of false-positive signals on the microarray.

From the 629 conserved regions identified from all of the accessed influenza databases, a total number of 447 potential capture-label pairs (Table 1) were selected after applying the ‘find_oligos’ and ‘pick oligos’ programs. From these 447 capture-label pairs, 75 pairs with the best scores that represented influenza A HA subtypes 1, 3 and 5, A/NA subtypes 1 and 2, A/MP, B/MP, B/NP and B/HA were chosen for initial experimental evaluation. Together with the 28 manually chosen sequences a total of 103 capture/label pairs was experimentally evaluated. The sequences identified by this method and refined experimentally are listed in Table 3. The bolded target sequences in Table 3 (column headed “conserved region”) represent those target sequences selected for use in certain preferred embodiments.

### Example 2

### Microarray Analysis for Diagnosis of Influenza Type, Subtype and Strain

Global surveillance of influenza is critical for improvements in disease management and is especially important for reducing the impact of an influenza pandemic. Enhanced surveillance requires rapid, robust and inexpensive analytical techniques capable of providing a detailed strain analysis of influenza viruses. Low-density oligonucleotide microarrays, with highly multiplexed “signatures” for influenza, offer many of the desired characteristics. However, the high mutability of the influenza virus represents a design challenge.

In one exemplary method, the design and characterization of an influenza microarray, “FluChip-55™” apparatus, for relatively rapid identification of influenza A H1N1, H3N2, and H5N1 viruses is described here. In this example, a small set of oligonucleotides was selected to exhibit broad coverage of influenza A and B viruses currently circulating in the human population as well as the avian A/H5N1 virus that is persistent in poultry in Southeast Asia. A complete assay, involving extraction and amplification of the viral RNA was developed and tested.

In an exemplary blind study of 72 influenza isolates, RNA from a wide range of influenza A and B viruses was amplified, hybridized, fluor labeled and imaged. The entire analysis time was less than 12 hours. The combined results for two assays provided typing and subtyping for an average of 71% of the isolates, correct type and partial subtype information for 13%, correct type only for 10%, false negatives for 5%, and false positives for 1%. Overall the assay provided the correct type and/or subtype information for 95% of the isolates. In the overwhelming majority of cases where incomplete sub-typing was observed, the failure was due to the RNA amplification step rather than limitations in the microarray. Optimization of primer sequences and conditions for amplification of template RNA are well known in the art and are a matter of routine experimentation for the person of ordinary skill.

Current technologies for strain identification of influenza typically require virus isolation, culture and immunoassay characterization. This method of immunocytological characterization of cultured virus is considered the “gold standard” for virus detection and generates a large quantity of virus for further characterization. Unfortunately, this method requires 3-7 days to culture the virus prior to antigenic testing, and only a few samples can be tested simultaneously. Multiplex polymerase chain reaction (PCR) assays, which utilize multiple primer pairs to amplify the influenza genome, have increased the sensitivity and speed of virus identification. In this approach, influenza RNA is reverse-transcribed (RT) into complementary DNA (cDNA) and subsequently PCR amplified into a double stranded DNA (dsDNA) product with influenza specific primers. However, limitations in the number of compatible primers used for a multiplex reaction limit the number of amplifiable genes in a single assay. Many recently developed influenza assays remain either limited to identifying a modest range of viruses with minimal virus specific information, or screening a smaller panel of viruses in order to gain additional information.

In certain methods, multiplex is capable of DNA microarray technology provides a means to screen for thousands of different nucleic acid sequences simultaneously. A DNA microarray uses solid surface immobilized oligonucleotides (capture probes) to bind target genetic segments. The use of longer capture probes allows detection of a range of genetically diverse sequences since long sequences have a higher mismatch tolerance. Oligonucleotide arrays based on shorter capture sequences have been suggested as a means to achieve greater specificity and discrimination between similar genetic sequences.

Using a previously developed algorithm [Mehlmann, 2005] for sequence selection and described in Example 1, a low-density microarray was designed to use a relatively small set of capture and label sequences (55, “FluChip-55™” apparatus) for subtype analysis of three important influenza A viruses and some influenza B viruses. The results from a thorough blind study of the microarray are described herein. The unique aspects of this work include the microarray design, the use of target RNA rather than DNA, and the broad range of viruses used to test the microarray. A blind study was conducted with 72 unknown samples provided by the CDC. The samples contained RNA from recent influenza viruses isolated from several species, including human, avian, equine, canine, and swine. Additionally, 9 patient samples that had previously been shown to be positive for influenza, but with no provided subtype information, were tested on the microarray.

### Blind Study Results

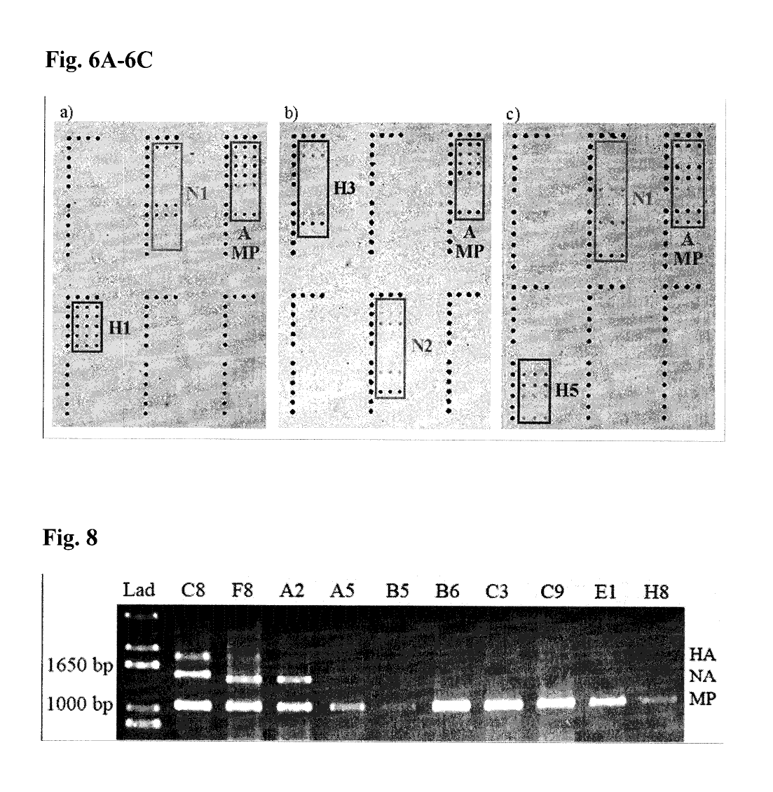

Representative results for A/H1N1, A/H3N2 and the avian AH5N1 subtype are given in FIG. 6. Note that for a given type and subtype not all of the possible sequences bind with equal probability. Binding can be defined as a positive fluorescence signal for all three spots that correspond to a specific capture sequence. By comparison to quantitative values of integrated signal and background, it was determined that signal-to-background ratios greater than 2 were easily distinguished by visual inspection. The advantages of visual inspection are twofold: rapid evaluation of the entire image and easy consideration of the required spatial registry in the decision making process for determination of binding.

As previously detailed, use of a simple, fixed signal-to-background ratio for determination of binding to a given spot is not appropriate because it does not readily account for variations in background, hybridization efficiency nor the pattern (e.g., 3 positives in a given row) that must be present for binding to be counted as indicative of the presence of a virus. Ultimately, pattern recognition software will be utilized for automated assignment.

For those sequences that were visually identified as binding, variations in relative fluorescence signal intensity reflects the degree to which viral RNA was captured and labeled. Differences in the pattern of oligonucleotides that bind for a given subtype were also observed. For example, comparisons of binding on the N1 capture sequences for an H1N1 virus (FIG. 6A) and an H5N1 virus (FIG. 6C) reveals variability in the pattern for a single subtype. Within the N1 boxed areas, sequences 1, 6, and 7 binding for H1N1, while 5, 7 and 9 binding for the H5N1 virus. This was expected, as the microarray sequence selection algorithm was designed to select capture/label probe pairs that matched a given ‘branch’ of a phylogenetic tree. Often, the division of a phylogenetic tree for a given gene-specific subtype, such as N1, resulted in branches specific to host species or virus subtype (e.g. N1 sequences for avian H5N1 grouped together and occurred in a separate branch from the generally human H1N1 viruses). Thus, a positive assignment required only a single hit or binding in a given set of sequences designed for a specific gene (e.g. MP, H or N). Any misassignment (e.g., if a hit or binding was assigned for both N1 and N2) was listed as a false positive even though some degree of correct information may have been obtained.

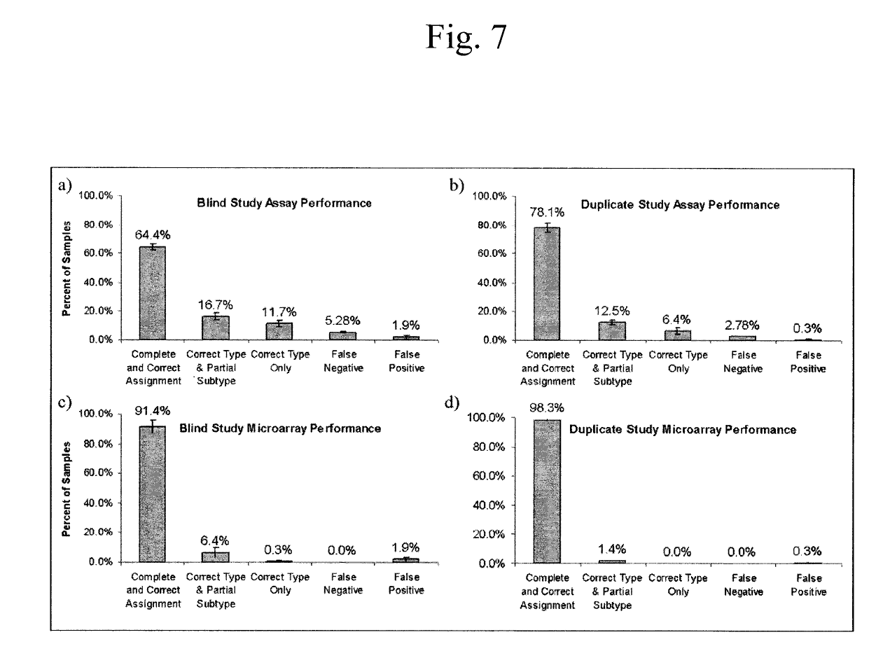

The majority of the samples tested produced images that provided clear and unambiguous influenza type and subtype identification. Microarray images from both rounds of experiments were used for identification through visual inspection by 5 individuals. The summary of assignments for samples processed with influenza A primers is given in FIG. 7. The bars represent the mean value for the percentage of sample assignments in a given category and the errors bars are ±one standard deviation from the 5 assignments. The categories for assignment using only influenza A primers for RNA amplification were: complete and correct (A or negative, and H and N), correct type and partial subtype (i.e., A or negative, either or H or N but not both), correct type only (A or negative, no H nor N), false negative (no information), and false positive (any misassignment). It is important to note that the results summarized in FIG. 7A-7B reflect the complete assay, which involves amplification and fragmentation of the viral RNA followed by hybridization, labeling and washing on the microarray. For the original blind study, which exhibited lower signal-to-background values in general, the assignment was complete and correct for 64±2% of the samples. Correct typing and partial subtype information was obtained for 17±2% of the samples. For 12±2% of the samples only correct typing information was obtained, with no subtype information. False negatives and false positives were observed for 5±1 and 2±1% of the samples, respectively.

For the duplicate study, in which higher signal-to-background images were generally obtained, the results reflect a higher degree of complete assignments. The assignment was complete and correct for 78±4% of the samples. Correct typing and partial subtype information was obtained for 12±2% of the samples. For 6±2% of the samples only correct typing information was obtained, with no subtype information. False negatives and false positives were observed for 3±0% and 0.3±0.5% of the samples, respectively.

Analysis of Incomplete Assignments. By combining the results from the blind study and duplicate study, an average of 71% of the samples resulted in correct and complete identification. However, the remaining 29% of the samples were either incompletely assigned or, more rarely, misassigned. Following both studies, a careful analysis of failures provided insight into the performance of the microarray. Of the 72 unknown samples, several contained RNA from viruses not covered by FluChip-55™ microarray. For example, 12 of the samples contained RNA for the gene specific influenza A subtypes H6, H7, H9, N3, N7 and N8, which accounted for approximately one third of the missed identifications. Future versions of the FluChip™ apparatus will include additional subtypes for more complete coverage.

In order to evaluate an amplification step, the PCR products for each sample were analyzed on an agarose gel. A representative example of a multilane gel is shown in FIG. 8. The first two samples shown, C8 and F8, were positive controls demonstrating successfully amplified MP, NA and HA products, which subsequently allowed completely correct identification of the virus. The remaining samples, A2 to H8, exhibited apparently missing products for one or more genes. It is important to note that “missing” in this case implies a PCR product concentration below the limit of detection for the gel (˜2 ng). Sample A2 was assigned to be “influenza A” with a “N1” subtype, no HA subtype determination could be made. Analysis of PCR product from sample A2 indicated amplification of the MP and NA genes but no observable amplification of the HA gene.

Another example is sample E1, where a correct identification of the HA subtype was made but the NA subtype was ‘missed’. The MP gene was highly amplified, and a faint band corresponding to HA gene is visible, but no discernable product was observed for NA. One exception to this trend was sample C9, an A/H3N8 virus in which a HA product was indicated but no H subtype identification was made from analysis of the microarray images. In this case, the HA was apparently amplified but not successfully hybridized to the microarray. Possible reasons for hybridization failure are discussed below. The microarray performance, independent of the amplification step was evaluated by accounting for both missing capture/label probes (as detailed above) and missing RNA. A summary of the corrected microarray results is given in FIGS. 7C and 7D. In this case, it is clear that the microarray itself provided complete and accurate information for up to 98% of the samples.

Analysis of False Positives. As represented in FIG. 7, based on both the blind study and duplicate study, an average of ˜1% of the samples yielded a false positive assignment. In absolute terms, only eight responses were assigned as a false positive. This is only a fraction of the more than 720 (72 samples*5 volunteers*2 studies) influenza A primer amplified sample images viewed. Specifically, in the blind study sample E8 was assigned as “A/H1” by 4 of the 5 volunteers although it was a negative control. However, in the duplicate study, all 5 volunteers correctly identified sample E8 as a negative. Careful evaluation of the image associated with the original E8 sample indicated potential interference of microarray artifacts (e.g., small and abnormal spot morphology in the H1 region and spatial mixing of the positive control in the MP region of sequences). In a similar fashion, sample E9 was identified as “H1” and “A/H1” by two volunteers in the blind study but correctly identified as a negative by all 5 volunteers in the duplicate study. Additionally, sample G9 was incorrectly identified as “A/N1” once and as “A/H1” once although G9 is an A/H7N3 virus. Abnormal spot morphology and spatial mixing of positive control spots may also account for each of these false positives.

Overall, a false positive rate of 1% is comparable or lower than the performance of many other diagnostic influenza tests known in the art. Of concern in designing an oligonucleotide array is that while shorter oligos provide increased specificity due to decreased mismatch tolerance, the probability of capturing similar oligonucleotides in solution increases. However, an additional level of selectivity is gained through hybridization of influenza RNA to the surface bound capture probe and to the solution label. Thus, the use of a two-step hybridization scheme may have aided in reducing the number of false positive hits in comparison with previous similar oligonucleotide arrays.

Analysis of False Negatives. The complete assay yielded an average false negative signal of 4.0% from both studies of the 72 unknown samples. False negatives can arise due to either poor sequence complementarity between the capture and, or, label probes with the target RNA or non-ideal RNA accessibility. Given the highly structured nature of single stranded RNA, poor hybridization to the microarray capture and label sequences could arise from a lack of accessibility or non-ideal fragmentation. It has been documented that RNA secondary structure can lead to uneven cleavage when utilizing chemical fragmentation reagents It is possible that the employed method of base catalyzed RNA fragmentation preferentially cleaves the viral RNA at positions that would prevent interaction with both the capture and label probes in certain regions of the genome, thus preventing capture and, or, detection on the microarray. Although fragmentation was conducted in order to reduce structural features in the RNA [Small et al., 2001], RNA's with lengths of 38-150 nt may still have significant structure [Mehlmann et al., 2005].

To assess this possibility, in one exemplary a method was used to computationally predict a probable structure of the fragmented RNA (data not shown, MFold see Mathews et al., 1999; Zuker, 2003). Viral RNA regions corresponding to the capture/label hybridization sites, which average 37-50 nt long, were extended sequentially in 10 nucleotide increments, with 5 nt added to each end, up to a maximum length of 100 nucleotides. The Tm of the self-associated fragments was compared to hits and negatives on the microarray. It was anticipated that self-associated fragments that had high intramolecular Tm's, would be less available for hybridization with capture/label probes and would therefore produce less intense hits, while fragments with low intramolecular Tm's would be more available for hybridization and would produce stronger hits. However, no direct correlation was observed, suggesting that sequence mismatch, and not RNA accessibility, is the dominant factor in false negative results. Although the overall rate of false negatives was low (˜4%), improvements in sequence selection and coverage should further enhance correct assignment.

Influenza B Analysis. In preliminary studies, during RNA amplification if no product was visible in an agarose gel when using the influenza A specific primers an attempt was made to amplify that sample with influenza B HA primers. In the blind study, 86%±3% of the influenza B samples were correctly assigned (either influenza B or a negative), 14%±3% were false negatives, and no false positives were assigned. In the duplicate study, 85%±3% were correctly assigned, 13%±0% were false negatives, and 1%±3% were false positives. In absolute terms, 21 identifications by the 5 volunteers were false negatives. Of these 21, three samples, D5, E9 and G6, accounted for all of the false negatives. The PCR product for each of these samples was visible when stained and viewed on an agarose gel. It was therefore hypothesized that these viruses contained mutations that limited their ability to be captured or labeled within our assay. The expansion of capture probes for the influenza B HA gene should eliminate this problem. Only one assignment (out of 75) was false positive for influenza B.

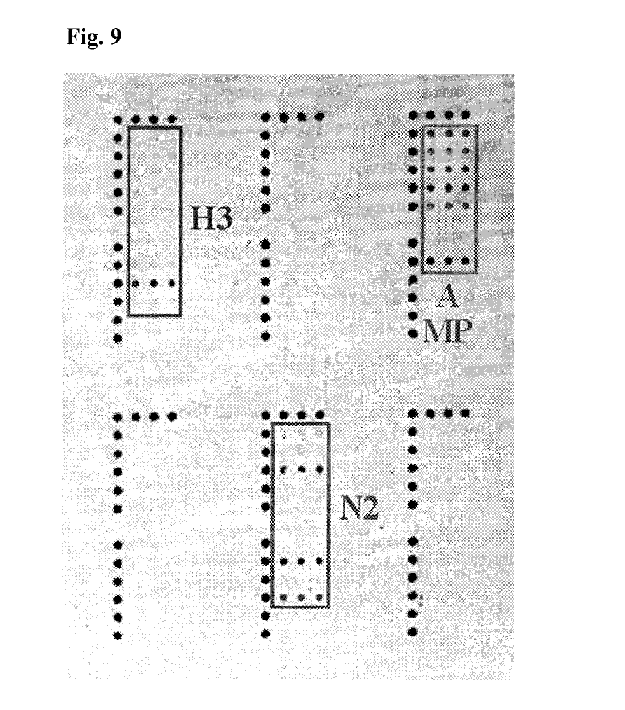

Analysis of Patient Samples. For further evaluation of FluChip-55™ microarray, patient samples were acquired. In this study, the RNA from 9 samples that had previously tested positive for influenza A and 3 unknown samples was amplified using the influenza A primers and hybridized to the array. An example image is shown in FIG. 9. The resulting microarray images were comparable in quality to those obtained from the isolate samples. Of the 12 samples, 4 were correctly and completely typed and subtyped (A/H3N2), 1 sample was correctly typed (A) and partially subtyped (N2), 4 were correctly typed (A) but with no subtype information, and the 3 unknowns were correctly identified as negative for influenza. These results were obtained within a single day rather than the typical 5-10 day time scale.

Additional Embodiments. Using the methods disclosed herein, the FluChip™ apparatus may be expanded to cover a larger number of important influenza strains, such as the avian H7N3, H7N7 and H9N2. Novel species-to-species transmissible viruses such as the equine influenza, H3N8, which was recently found in canines will also be addressed. Specifically, the next version of the FluChip™ apparatus will include capture/label sequences for H1, H2, H3, H5, H7, H9, N1, N2, N3, N4, N7, and N8 in addition to broader MP, and potentially NP, coverage. Other plans include simplification or elimination of the RNA amplification step, improved hybridization kinetics, and development of pattern recognition software for rapid image interpretation.

Using FluChip-55™ microarray, in conjunction with a well-established RNA amplification method, RNA from viruses of interest including influenza A/H1N1, A/H3N2 and A/H5N1 and influenza B was typed and subtyped in ˜11 hours. In this study, 72 samples including isolates of current influenza viruses from a number of species were fully or partially identified with greater than 95% accuracy on average. Successful identification of a wide range of viruses further validates the method for microarray sequence selection and establishes the capability of low-density (i.e., low-cost) microarrays to provide accurate identification of viruses.

Although the pattern in which the capture sequences were spotted was designed to allow easy identification of influenza subtypes, the skilled artisan is aware that any pattern of capture probe spotting may be used. The binding of target sequences to the capture and label probes may be read manually or determined by software. Analysis of target binding patterns to identify influenza type, subtype or strain may similarly be performed manually or automatically by software.

### Single Target Gene Strategies

### Methods

Sequence Selection. Capture and label probe selection is adapted from the method of Mehlmann et al (Mehlmann, M. et al. FluChip™: robust sequence selection method for a diagnostic microarray. J. Clin. Microbiol. submitted (2006) incorporated herein by reference in its entirety). In this example: M gene sequences for a variety of subtypes of influenza A were compiled using the publicly available online sequences from LANL (www.flu.lanl.gov) and other information. Subtype-specific databases were created for H1N1, H1N2, H3N2, H5N1, H3N8, and H9N2. These subdatabases were further divided by host species and mined for conserved regions using the ConFind algorithm. The conserved regions identified were then used to design appropriate “capture” and “label” sequence pairs of between 16-25 nt each in length. Approx. 60 possible sequence pairs were identified. The number of mismatches between designed sequences and the sequences in the original databases was determined, and sequences were chosen that were anticipated to be broadly reactive with all influenza subtypes or with viruses of a specific host species or subtype (e.g. all avian viruses, only H3N2 viruses). In addition, 18 capture and label pairs chosen for previous experiments were also included in initial studies to determine their suitability for use on the microarray.

### Cross-Reactivity Experiments

All capture and label pairs were checked for cross-reactivity by conducting six replicate hybridizations of only fluorophore-conjugated label sequences (in the absence of target influenza). Experiments were conducted under otherwise identical conditions. Where signals on the microarray occurred (signal is defined here as a mean S/N>3 on a majority of hybridised slides), the capture probe and corresponding label probe were removed and not used further. This sequence selection process resulted in 15 useful capture and label pairs.

Samples. Extracted RNA from 58 influenza A viral isolates representing human, avian, equine, canine, and swine hosts were provided. Additionally, 9 blind patient samples positive for influenza A (throat swabs and nasopharyngeal swabs) were provided. Virus was extracted from patient samples as previously described.

RNA Amplification: see above.

Microarray slide preparation: see above.

RNA Fragmentation and Hybridization. Transcribed RNA was fragmented prior to hybridization on the microarray as described (Mehlmann et al. Optimization of fragmentation conditions for microarray analysis of viral RNA. Anal. Biochem. 347, 316-323 (2005) incorporated herein by reference in its entirety). Hybridizations were carried out for 2 h at room temperature as described (Townsend et al. submitted (2006)).

Microarray Imaging and Analysis. Hybridized slides were scanned using a VersArray ChipReader scanner (Bio-Rad Laboratories, Hercules, Calif.) with 532 nm detection, laser power of 60%, PMT sensitivity of 700 V, and 5 μm resolution. Fluorescence images were analyzed using VersArray Analyzer software, version 4.5 (Bio-Rad Laboratories, Hercules, Calif.). Mean raw intensity values were calculated for each capture probein a single image, the highest intensity capture probe was then normalized to 100, and this was repeated for each microarray image acquired. The normalized intensity data for each image was then subjected to a hierarchical clustering analysis (Number Cruncher Statistical Systems (NCSS) 2004, Kaysville, Utah) using a Euclidean distance function and the unweighted pair-group average method.

Although the pattern in which the capture sequences were spotted was designed to allow easy identification of influenza subtypes, the skilled artisan is aware that any pattern of capture probe spotting may be used. The binding of target sequences to the capture and label probes may be read manually or determined by software. Analysis of target binding patterns to identify influenza type, subtype or strain may similarly be performed manually or automatically by software.

### Single Target Gene Strategies

### Example 3

Selection of Influenza Virus Target Sequences of the M segment for Detection and Identification of Types, Subtypes and/or Strains

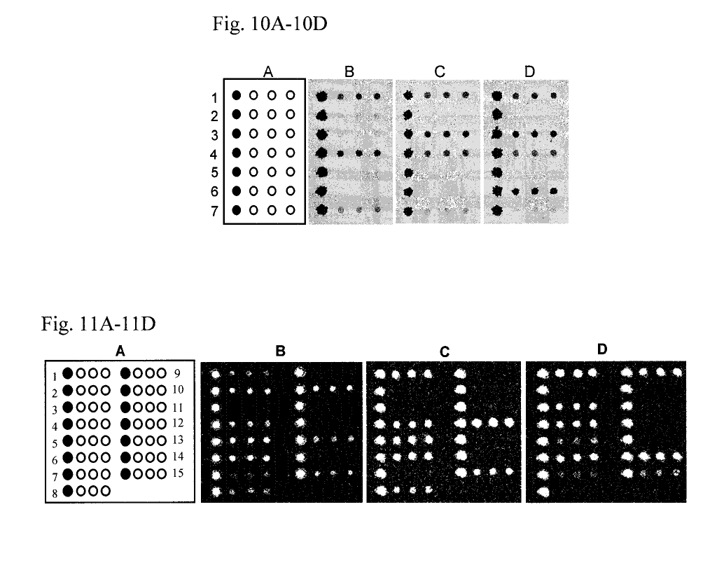

In one exemplary experiment, a distinct pattern of signals from the capture sequences designed to target the M segment was observed for different influenza viral subtypes. FIG. 10 represents these patterns in the M gene sequences for H3N2 (A), H1N1 (B), and H5N1 (C) influenza A subtypes. Of the 58 samples that tested positive for influenza A (all from 2003 forward), 18 viruses were of the H1N1 subtype, 26 were of the H3N2 subtype, and 8 were H5N1 viruses. All viruses of the same subtype (with few exceptions) revealed the same visual pattern in these seven sequences. It can be seen that sequences 1 and 4 produce signals of high relative intensity for all three subtypes. Sequences 3 and 7 also show broad reactivity, but with much lower relative intensities. Also noted, sequence 6 was selective for the H5N1 viruses (as well as other avian subtypes, data not shown), producing no signal for the human H1N1 and H3N2 viruses.

In another example, simple visual inspection of the images during a blind study revealed that a few of the viral isolates produced M-segment microarray signatures that deviated significantly from the typical patterns shown in FIG. 10. It was revealed that one of the “odd” signatures originated from a swine H3N2 virus that had infected a human. Another atypical signature was observed for a laboratory reassortant virus. The microarray signature of the 7 M segment sequences indicated an H1N1 virus while the HA and NA sequences indicated an H3N2 virus. It was revealed that the virus contained HA and NA genes from a H3N2 virus and the internal genes from A/Puerto Rico/8/1934 (H1N1). In these examples, subtyping was unexpectedly performed using only seven sequences designed to target a highly conserved gene segment. These results prompted a more thorough examination of the M segment identification and subtyping of influenza. A number of additional M segment probe sequences were selected to expand the pattern recognition power. (Mehlmann, M. et al. FluChip™: robust sequence selection method for a diagnostic microarray. J. Clin. Microbiol. (2006) incorporated by reference in its entirety for all purposes). In another exemplary method, the sequence selection method used was unique because it identifies regions of conservation among large families of similar influenza viruses. Appropriate probe sequences (capture and label) were then designed from the conserved regions (see Methods). Probe sequences were selected to yield either broad reactivity with all viral subtypes or highly specific reactivity for a given viral subtype or host species. Anticipated reactivity was determined computationally by evaluating the number of mismatches between possible probe sequences and all sequences in the databases used to design them.

In one example, 15 oligonucleotide probe sequences were selected from the M segment of influenza A and were used as the basis of the MChip™ (see Table 4 for a list of sequences). The 58 influenza A viral isolates obtained from the CDC were used to test microarray performance since the isolates represented a wide variety of subtypes including: H1N1 (18), H3N2 (26), and H5N1 (8) where the number in parentheses is the number of isolates tested for a given subtype. The M gene segment was successfully amplified for all 58 samples tested, and all of these samples resulted in positive fluorescent signals on the microarray (images given in FIG. 10, relative intensity values tabulated in Table 6). Previous studies using multiplex PCR showed that failed amplification of one or more genes produced a false negative on the array, reflecting a failure of the amplification process and not of the microarray performance (Townsend, M. B. et al. FluChip™: experimental evaluation of a diagnostic influenza microarray. J. Clin. Microbiol. submitted (2006) incorporated herein by reference in its entirety for all purposes). The use of a single gene amplification appears to eliminate all of these false negative results.

### Example 4

In one example, microarray patterns were examined for common sequences between some influenza A subtypes. FIG. 11 represents a typical microarray patterns observed for H1N1, H3N2, and H5N1 viruses. In addition FIG. 11, represents probe sequences 1, 4, 5, 6, and 15 that appear to be broadly reactive for all three subtypes, although they exhibited different patterns of relative intensity. Sequences 9 and 14 were specific for H5N1 viruses (see FIG. 11C), and non-reactive for H1N1 and H3N2 viruses. Experimentally observed reactivity of the probe generally correlated with predicted results (see Table 5). The relative intensities in the pattern were also generally preserved within a viral subtype.

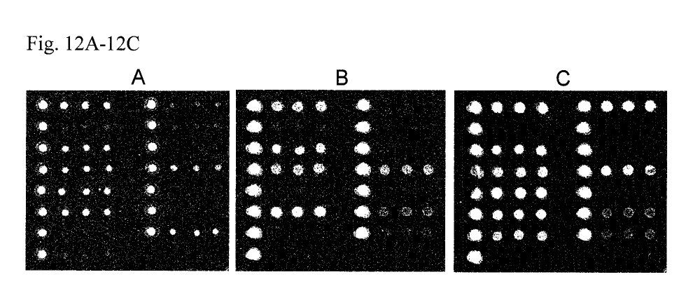

In another example, FIG. 12 discloses examples of M segment patterns for viruses other than the H1N1, H3N2, and H5N1 subtypes shown in FIG. 11. First, comparing the panels in FIG. 12, it can be seen that all 3 patterns are different. In addition, comparing FIG. 12 to the patterns in FIG. 11 illustrates they are distinct from the typical H1N1, H3N2, and H5N1 patterns. FIG. 12A shows the pattern for the laboratory reassortant virus discussed previously that contains HA and NA genes from an H3N2 virus, but the internal genes from an H1N1 virus. Previous studies using fewer sequences yielded an M pattern indicative of an H1N1 virus. Interestingly, with a larger number of probe sequences the pattern is unique and not a definite match for either H3N2 virus FIG. 11B or an H1N1 virus (FIG. 11C). Likewise, the pattern for the swine H3N2 virus that infected a human, shown in FIG. 12B, does not match the human H3N2 pattern in FIG. 11. A final example is seen in the pattern observed for an avian H9N2 virus, shown in FIG. 12C. Although it is an avian virus like the H5N1 example shown in FIG. 11D, it does not exhibit the same pattern. In most cases differences in pattern arise from not only the absence or presence of signal for certain probes, but also often from the differences in relative intensities of the signals.

In another exemplary method, a simple hierarchical clustering analysis was employed to highlight the similarities and differences between the microarray signal patterns. Hierarchical clustering is widely used for the analysis of gene expression data (Blalock, E. M. & Editor. A Beginner's Guide to Microarrays (2003) incorporated herein by reference). Here, a dendrogram illustrates the degree of “relatedness” for a set of independent measurements. Hierarchical clustering has recently been used to evaluate patterns on a diagnostic microarray designed to identify closely related bacteria (Francois, P. et al. Rapid bacterial identification using evanescent-waveguide oligonucleotide microarray classification. J. Microbiol. Methods In Press, Corrected Proof, available online 10 Oct. 2005 incorporated herein by reference). In this analysis, the horizontal length connecting two nodes indicates the degree of similarity. When a dataset is more similar it will have a shorter horizontal length between the nodes connecting them.

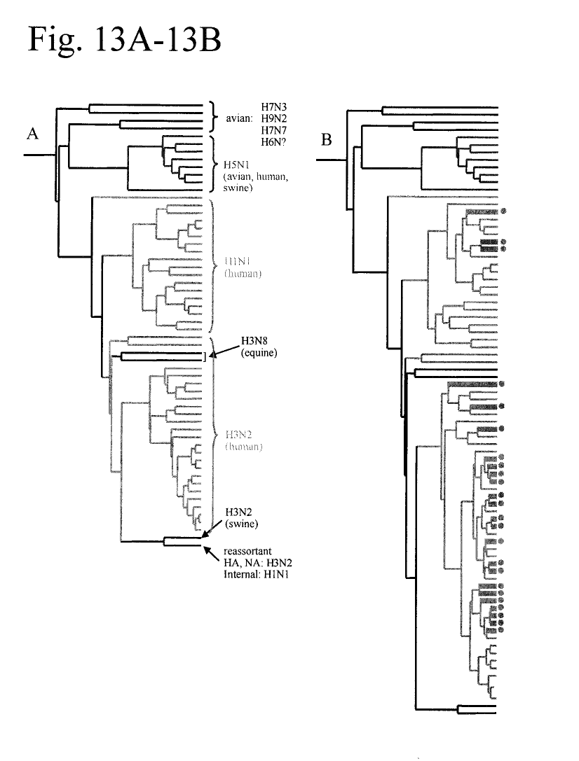

In another example, FIG. 13A represents a hierarchical clustering analysis of one microarray experiment for each of the 58 influenza A patient isolates tested (see Table 6 for relative intensities used in clustering analysis). The clustering dendrogram in FIG. 4A has been outlined to highlight the different viral subtypes. Shown in dark grey lines, the H5N1 viruses of all host species tested belong to the same cluster. The other 4 avian subtypes tested also group together and are generally dissimilar from the human H1N1 and H3N2 viruses. Referring to FIG. 12C the avian H9N2 virus (black lines) displayed a visual pattern different from that of the avian H5N1 viruses. This distinction was confirmed by the clustering analysis in FIG. 13A. Interestingly, the H9N2 virus appears in a cluster solely of other avian viruses, and this cluster is distinct from that containing the 8H5N1 viruses tested.

In one example, FIG. 13 illustrates that all but one of the human H1N1 viruses (light grey) occur in the same cluster, these are also similar to the H1N1 vaccine strain. In addition, the human H3N2 (light grey lines) viruses appear closely related in the dendrogram. The two equine H3N8 (black line) viruses tested appear among the human H3N2 viruses as a pair. Their similarity to the H3N2 viruses may represent a similar viral origin, but it is difficult to fully assess this with the limited number of H3N8 viruses tested. The H3N2/H1N1 laboratory reassortant and swine H3N2 viruses discussed in FIGS. 12A and 12B also cluster loosely with the other H3N2 viruses, but appear out-grouped as a pair and rather distinct from the main human H3N2 branch. As represented by FIG. 12, the original analysis using only 7 probe sequences indicates the signal pattern of the reassortant virus falls into the cluster containing H1N1 viruses. Here, the use of additional probe sequences provided additional pattern distinction, and that the reassortant virus containing an H1N1 M segment from a 1934 virus was significantly out-grouped.

### Neural Network

In certain embodiments, artificial neural networks (ANN) were used in order to select target gene sequences of use in arrays contemplated herein. ANNs are a common pattern recognition vehicle used in microarray data analysis, and have been used previously to diagnose and predict cancer types. In one exemplary method, an MChip ANN was trained to recognize array patterns associated with each subtype using influenza A virus samples of known subtype. As previously described, normalized input data were provided for a set of known samples called a “training set”. By providing the known outputs for the training set (e.g. viral subtypes), ANN software learned to associate an array pattern of relative fluorescence intensities with a specific output (e.g. viral subtype). Once the patterns for the training set were established, data for unknown samples was supplied as input. The ANN then provided an assignment score (scaled from 0 to 1) that the unknown sample belonged to each of the output categories.

In accordance with this example, the ANN utilized 16 inputs, 4 outputs (H3N2, H1N1, H5N1, and negative), and was trained using a feed-forward weighted back-propagation method. The method was then validated using leave-one-out cross-validation. Microarray results from 58 viral isolates (all H3N2, H1N1, and H5N1 samples) and 10 samples known to be negative for influenza A were selected as the “training set.” The trained neural network was used to determine the subtypes for 53 unknown samples in a blind study. All of the H3N2 and H1N1 unknowns were patient samples acquired by either nasal swabs or washes. Table 7 shows the ANN output assignments for the 53 unknown samples, with assignment scores greater than 0.75 highlighted. After the ANN analysis was completed the samples were unblinded. Using an assignment score of >0.75 as the minimum for correct identification, 50 of 53 samples were correctly identified and subtyped (for influenza A). There was a single false positive result and two false negative results. The resulting sensitivity was 95% and specificity 92%.

As observed herein, the M segment shows high conservation at the nucleotide level, with evolutionary rates of 0.83×10⁻³ and 1.36×10⁻³ nucleotide substitutions per year for M1 and M2, respectively. At the amino acid level, M1 has exhibited relatively little evolution since the 1930's (0.08×10⁻³ amino acid changes per residue per year). As M1 is a crucial component of many aspects of the virus life cycle, it is not surprising that this protein has a high degree of conservation. In one aspect of the study, it was observed that 4 of the 5 probe sequences found to be broadly reactive for all viral subtypes tested on the microarray were sequences targeting portions of RNA within the M1 coding region.

It is contemplated herein that the location of the M1 gene in the viral envelope implies that it interacts with the other viral envelope proteins (HA, NA, and M2), and this may be a key factor when selecting a gene for subtyping a virus such as influenza. Recent phylogenetic analysis by proteotyping distinguished subtle but important differences between related sequences. By identifying unique amino acid signatures within a single clade, specific instances of pairing of HA and M gene proteotypes were found. This result suggests that a change in one gene requires selection of compensatory mutations in the other. Proteotype assignments for several genes that always occur together suggest functionally important co-segregation during a reassortment. In addition, other studies have noted a correlated mutation between HA and M1 in their large-scale sequencing effort of human influenza. This evidence for co-evolution of HA and the M gene segment is a likely explanation for the subtype-specific binding patterns observed in this study. Thus, other genes that co-evolve similar to HA and M1 may also be important for analyzing subtype-specific microarray patterns in a virus.

MChip Validation with A/H5N1 Viruses. In order to further explore the potential of the MChip to correctly identify a rapidly emerging subtype, additional studies were conducted with RNA extracted from a wide range of A/H5N1 viruses. Thirty-four different A/H5N1 samples representing human, feline, and a variety of avian infections spanning 2003-2006 and diverse geographic locations including Vietnam, Indonesia, Nigeria, and Kazakhstan were examined. The results from 87 independent microarray tests representing influenza, 4 influenza-like illnesses (ILI's), and several negative controls are summarized in Table 8. The microarray and assay yielded a sensitivity of 95% and a specificity of 100%.

TABLE 3
Capture, label and target sequences for influenza virus identification

| | | | | | | | |
|---|---|---|---|---|---|---|---|
| | Oligo | Oligo | | | Region | Region | |
| Name | Start | End | Capture | Label | Start | End | Conserved Region |

| | | | | | | | |
|---|---|---|---|---|---|---|---|
| PosCtrl | | | CGTATATAAAACGGAACGT | CCTTCGACGTTCCGTTTTAT | | | |
| | | | CGAAGG (SEQ ID NO:1) | ATACG (SEQ ID NO:2) | | | |
| A-H1-96 | 96 | 130 | TGTTGACACAGTACTTG | GAAGAATGTGACAGTGA | 94 | 143 | ACTGTTGACACAGTACTTGAGAAG |
| | | | (SEQ ID NO:3) | (SEQ ID NO:4) | | | AAYGTGACAGTGACACACTCTGTC |
| | | | | | | | AA (SEQ ID NO:5) |
| A-H1-131 | 131 | 167 | CACACTCTGTCAACCTAC | TGAGGACAGTCACAATGG | 121 | 167 | GTGACAGTGACACACTCTGTCAAY |
| | | | (SEQ ID NO:6) | (SEQ ID NO:7) | | | CTACTTGAGGACAGTCACAATGG |
| | | | | | | | (SEQ ID NO:8) |
| A-H1-656 | 656 | 693 | TGTCTTCACATTATAGCAG | AGATTCACCCCAGAAATA | 656 | 701 | TGTCTTCACATTATAGCAGAAGAT |
| | | | (SEQ ID NO:9) | (SEQ ID NO:10) | | | TCACCCCAGAAATARCMAAAAG |
| | | | | | | | (SEQ ID NO:11) |
| A-H1-925 | 925 | 956 | TTCCAGAATGTACACC | AGTCACAATAGGAGAGT | 925 | 978 | TTCCAGAAYGTACACCCAGTYACA |
| | | | (SEQ ID NO:12) | (SEQ ID NO:13) | | | ATAGGAGAGTGTCCAAAGTATGTC |
| | | | | | | | AGGAGT (SEQ ID NO:14) |
| A-H1-964 | 964 | 1004 | AAGTATGTCAGGAGTG | AAAATTAAGGATGGTTACAG | 946 | 1011 | ACAATAGGAGAGTGTCCAAAGTAT |
| | | | (SEQ ID NO:15) | GAC (SEQ ID NO:16) | | | GTCAGGAGTRCAAAATTAAGGATG |
| | | | | | | | GTTACAGGACTAAGGAAC |
| | | | | | | | (SEQ ID NO:17) |
| A-H3-62 | 62 | 95 | CTCAAAAACTTCCCGT | AATGACAACAGCACGGC | 61 | 110 | GCTCAAAAACTTCCCGKAAATGAC |
| | | | (SEQ ID NO:18) | (SEQ ID NO:19) | | | AACAGCACGGCAACGCTGTGCCTG |
| | | | | | | | GG (SEQ ID NO:20) |
| A-H3-156 | 156 | 186 | TGACCAAATTGAAGT | ACTAATGCTACTGAG | 136 | 196 | CTAGTGAAAACAATCACGAATGAC |
| | | | (SEQ ID NO:21) | (SEQ ID NO:22) | | | CAAATTGAAGTRACTAATGCTACT |
| | | | | | | | GAGCTGGTTCAGA |
| | | | | | | | (SEQ ID NO:23) |
| A-H3-238 | 238 | 272 | CTTGATGGAGAAAACTG | ACACTAATAGATGCTCT | 235 | 284 | ATCCTTGATGGAGAAAACTGCACA |
| | | | (SEQ ID NO:24) | (SEQ ID NO:25) | | | CTAATAGATGCTCTATTGGGAGAC |
| | | | | | | | CC (SEQ ID NO:26) |
| A-H3-301 | 301 | 336 | CAAAATAAGGAATGGGA | CTTTTTGTTGAACGCAGC | 275 | 347 | TGGGAGACCCTCATTGTGATGGCT |
| | | | (SEQ ID NO:27) | (SEQ ID NO:28) | | | TCCAAAATAAGGAATGGGACCTTT |
| | | | | | | | TTGTTGAACGCAGCAAAGCCTACA |
| | | | | | | | G (SEQ ID NO:29) |
| A-H3-355 | 355 | 389 | TACCCTTATGATGTGCC | GATTATGCCTCCCTTAG | 352 | 428 | TGTTACCCTTATGATGTGCCGGAT |
| | | | (SEQ ID NO:30) | (SEQ ID NO:31) | | | TATGTCTCCCTTAGGTCACTAGTT |
| | | | | | | | GCCTCATCAGGCACRCTGGAGTTT |
| | | | | | | | AACA (SEQ ID NO:32) |
| A-H3-681 | 681 | 714 | CAAAAGAAGCCAACAA | CTGTAATCCCGAATATC | 669 | 739 | TCACAGTCTCTACCAAAAGAAGCC |
| | | | (SEQ ID NO:33) | (SEQ ID NO:34) | | | AACAAACTGTAATCCCGAATATCG |
| | | | | | | | GATCTAGACCCAGGGTAAGGGAT |
| | | | | | | | (SEQ ID NO:35) |
| A-H3-736 | 736 | 770 | AAGCATCTACTGGACAAT | GGTCTGTCTAGTAGAA | 736 | 791 | GGTCTKTCTAGTAGAATAAGCATC |
| | | | (SEQ ID NO:36) | (SEQ ID NO:37) | | | TACTGGACMATAGTTAAACCAGGG |
| | | | | | | | GACATCCT (SEQ ID NO:38) |
| A-H3-888 | 888 | 920 | CAAATGCAATTCTGAA | GCATCACTCCAAATGG | 875 | 935 | GATGCACCCATTGGCAAATGCAAT |
| | | | (SEQ ID NO:39) | (SEQ ID NO:40) | | | TCTGAATGCATCACTCCAAATGGA |
| | | | | | | | AGCATTCCYAATG |
| | | | | | | | (SEQ ID NO:41) |
| A-H3-1241 | 1241 | 1278 | CCATCAGATTGAAAAAGA | TTCTCAGAAGTAGAAGGGA | 1234 | 1320 | GAGAAATTCCATCARATTGAAAAA |
| | | | (SEQ ID NO:42) | (SEQ ID NO:43) | | | GAATTCTCAGAAGTAGARGGGAGA |
| | | | | | | | ATTCAGGACCTCGAGAAATATGTT |
| | | | | | | | GAGGACACTAAAATA |
| | | | | | | | (SEQ ID N0:44) |
| A-H5-52 | 52 | 92 | CAAATCTGCATTGGTTATCA | GCAAACAATTCAACAAAACA | 49 | 165 | GACCAAATCTGCATTGGTTATCAT |
| | | | (SEQ ID NO:45) | (SEQ ID NO:46) | | | GCAAACAATTCAACAAAACAAGTT |
| | | | | | | | GACACAATCATGGAAAAGAATGTG |
| | | | | | | | ACGGTCACACATGCTCAGGACATA |
| | | | | | | | CTAGAAAAAGAACACAATGGA |
| | | | | | | | (SEQ ID NO:47) |
| A-H5-91 | 91 | 125 | CAGGTTGACACAATAAT | GAAAAGAACGTTACTGT | 85 | 138 | ACAGAGCAGGTTGACACAATAATG |
| | | | (SEQ ID NO:48) | (SEQ ID NO:49) | | | GAAAAGAACGTTACTGTTACACAT |
| | | | | | | | GCCCAA (SEQ ID NO:50) |
| A-HS-205 | 205 | 241 | AGAGATTGTAGTGTAGCT | GATGGCTCCTCGGAAACC | 205 | 278 | AGAGATTGTAGTGTAGCTGGATGG |
| | | | (SEQ ID NO:51) | (SEQ ID NO:52) | | | CTCCTCGGRAACCCAATGTGTGAC |
| | | | | | | | GAATTCATCAATGTRCCGGAATGG |
| | | | | | | | TC (SEQ ID NO:53) |
| A-HS-384 | 384 | 417 | GAAAATTCAGATCATCC | CAAAAGTTCTTGGTCC | 350 | 417 | TGAAACACCTATTGAGCAGAATAA |
| | | | (SEQ ID NO:54) | (SEQ ID NO:55) | | | ACCATTTTGAGAAAATTCAGATCA |
| | | | | | | | TCCCCAAAARTTCTTGGTCC |
| | | | | | | | (SEQ ID NO:55) |
| A-HS-540 | 540 | 573 | CTACAATAATACCAACC | AGAAGATCTTTTGGTA | 538 | 593 | AGCTACAATAATACCAACCAAGAA |
| | | | (SEQ ID NO:57) | (SEQ ID NO:58) | | | GATCTTTTGGTAMTGTGGGGGATT |
| | | | | | | | CAYCATCC (SEQ ID NO:59) |
| A-HS-850 | 850 | 883 | AGTGAATTGGAATATGG | AACTGCAACACCAAGT | 839 | 929 | CAATTATGAAAAGTGAATTGGAAT |
| | | | (SEQ ID NO:60) | (SEQ ID NO:61) | | | ATGGTAACTGCAACACCAAGTGTC |
| | | | | | | | AAACTCCAATGGGGGCGATAAACT |
| | | | | | | | CTAGTATGCCATTCCACAA |
| | | | | | | | (SEQ ID NO:62) |
| A-N1-281 | 281 | 320 | GCAATTCATCTCTTTGTTCT | TCAGTGGATGGGCTATATA | 268 | 320 | GTGACATTGGCCGGCAATTCATCT |
| | | | (SEQ ID NO:63) | (SEQ ID NO:64) | | | CTTTGTTCTATCAGTGGATGGGCT |
| | | | | | | | ATATA (SEQ ID NO:65) |
| A-N1-363a | 363 | 402 | TTTTGTCATAAGAGAACCT | TCATATCATGTTCTCACTTG | 349 | 419 | TCCAAAGGAGATGTTTTTGTCATA |
| | | | (SEQ ID NO:66) | (SEQ ID NO:67) | | | AGAGARCCTTTCATATCATGTTCT |
| | | | | | | | CACTTGGAATGCAGAACCTTTTT |
| | | | | | | | (SEQ ID NO:68) |
| A-N1-363b | 363 | 404 | TTTTGTCATAAGAGAG | CTTTTATTTCATGTTCTCACT | 361 | 409 | GTTTTTGTCATAAGAGARCCYTTT |
| | | | (SEQ ID NO:69) | TG (SEQ ID NO:70) | | | ATTTCATGTTCTCACTTGGAATGC |
| | | | | | | | A (SEQ ID NO:71) |
| A-N1-451 | 451 | 499 | CATTCTAATGGGACCGTCA | GGAGCCCCTATAGAACTTT | 446 | 499 | ACAAGCATTCTAATGGGACCGTCA |
| | | | AAGAC (SEQ ID NO:72) | AATGA (SEQ ID NO:73) | | | AAGACAGGAGCCCCTATAGAACTT |
| | | | | | | | TAATGA (SEQ ID NO:74) |
| A-N1-526 | 526 | 562 | CCATACAATTCAAGGTTT | AGTCAGTTGCTTGGTCAG | 526 | 572 | CCATACAATTCAAGGTTTGAGTCD |
| | | | (SEQ ID NO:75) | (SEQ ID NO:76) | | | GTTGCTTGGTCAGCRAGTGCTTG |
| | | | | | | | (SEQ ID NO:77) |
| A-N1-596 | 596 | 629 | CAATTGGAATTTCTGGC | CAGACAATGGGGCTGT | 593 | 647 | TGACAATTGGAATTTCTGGCCCAG |
| | | | (SEQ ID NO:78) | (SEQ ID NO:79) | | | ACARTGGGGCTGTGGCTGTATTGA |
| | | | | | | | AATACAA (SEQ ID NO:80) |
| A-N1-829 | 829 | 860 | GATGCACCTAATTCTC | CTACGAGGAATGTTC | 826 | 876 | TTGRATGCACCTAATTCTCACTAY |
| | | | (SEQ ID NO:81) | (SEQ ID NO:82) | | | GAGGAATGTTCCTGTTACCCTGAT |
| | | | | | | | ACC (SEQ ID NO:83) |
| A-N1-952 | 952 | 991 | GAGTATCAAATAGGAT | TATATGCAGTGGAGTTTTCG | 928 | 1001 | TGGGTATCTTTCAATCAAAATTTG |
| | | | (SEQ ID NO:84) | GAG (SEQ ID NO:85) | | | GAGTATCAAATASGATATATATGC |
| | | | | | | | AGTGGAGTTTTCGGAGACAATCCA |
| | | | | | | | CG (SEQ ID NO:86) |
| A-N1-966 | 966 | 998 | ATACATCTGCAGTGGA | TGTTCGGTGACAATCC | 950 | 1014 | TGGATTATCAAATAGGATACATCT |
| | | | (SEQ ID NO:87) | (SEQ ID NO:88) | | | GCAGTGGRGTGTTCGGTGACAATC |
| | | | | | | | CGCGTCCCAAAGATGGA |
| | | | | | | | (SEQ ID NO:89) |
| A-N1-1107 | 1107 | 1146 | CAAAAGCACTAGTTCC | GGAGCGGTTTTGAAATGAT | 1099 | 1148 | GGGAGAACCAAAAGCACTAGTTCY |
| | | | (SEQ ID NO:90) | TTGG(SEQ ID NO:91) | | | AGGAGCGGTTTTGAAATGATTTGG |
| | | | | | | | GA(SEQ ID NO:92) |
| A-N2-41 | 41 | 74 | GATAATAACAATTGGC | CCGTCTCTCTAACCATT | 30 | 106 | CCAAATCAGAAGATAATAACAATT |
| | | | (SEQ ID NO:93) | (SEQ ID NO:94) | | | GGYTCHRTCTCTCTAACCATTGCA |
| | | | | | | | ACAGTATGTTCCTYATGCAGATTG |
| | | | | | | | CCAT (SEQ ID NO:95) |
| A-N2-249 | 249 | 283 | GAAATATGCCCCAAAC | AGCAGAATACAGAAATTG | 240 | 299 | ATAGAGAAGGAAATATGCCCCAAA |
| | | | (SEQ ID NO:96) | (SEQ ID NO:97) | | | CTAGCAGAATACAGAAATTGGTCA |
| | | | | | | | AAGCCGCAATGT |
| | | | | | | | (SEQ ID NO:98) |
| A-N2-536 | 536 | 568 | CAAACAAGTGTGCATA | CATGGTCCAGCTCAAG | 534 | 580 | ACCAAACAAGTGTGCATRGCATGG |
| | | | (SEQ ID NO:99) | (SEQ ID NO:100) | | | TCCAGCTCAAGCTGCCATGATGG |
| | | | | | | | (SEQ ID NO:101) |
| A-N2-879 | 679 | 712 | CTCAAAATATCCTCAGA | CTCAGGAGTCAGAATG | 675 | 722 | TGGTCYCAAAATATCCTCAGAACT |
| | | | (SEQ ID NO:102) | (SEQ ID NO:103) | | | CAGGAGTCAGAATGYGTTTGCATC |
| | | | | | | | (SEQ ID NO:104) |
| A-N2-868 | 868 | 901 | CTCGATATCCTGGTGTC | GATGTGTCTGCAGAGA | 864 | 928 | TATCCTCGATATCCTGGTGTCAGA |
| | | | (SEQ ID NO:105) | (SEQ ID NO:106) | | | TGTGTCTGCAGAGACAACTGGAAA |
| | | | | | | | GGCTCCAATAGGCCCAT |
| | | | | | | | (SEQ ID NO:107) |
| A-N2-953 | 953 | 996 | TAGCATTGTTTCCAGTTATG | TCAGGACTTGTTGGAGAC | 943 | 1008 | TAAAGGATTATAGCATTGTTTCCA |
| | | | TGTG (SEQ ID NO:108) | (SEQ ID NO:109) | | | GTTATGTGTGCTCAGGACTTGTTG |
| | | | | | | | GAGACACACCCAGAAAAA |
| | | | | | | | (SEQ ID NO:110) |
| A-N2-1138 | 1138 | 1172 | CAGGTTATGAGACTTTC | GAGTCATTGGTGGTTGG | 1122 | 1174 | AGCAAGGATTCACGCTCAGGTTAT |
| | | | (SEQ ID NO:111) | (SEQ ID NO:112) | | | GARACTTTCAGRGTCATTGGTGGT |
| | | | | | | | TGGAC (SEQ ID NO:113) |
| A-N2-1178 | 1178 | 1218 | ACCTAACTCCAAATTGCAG | TAAATAGGCAAGTCATAGTT | 1178 | 1222 | ACCTAAYTCCAAATTGCAGAYAAA |
| | | | (SEQ ID NO:114) | G(SEQ ID NO:115) | | | TAGGCAAGTCATAGTTGACAG |
| | | | | | | | (SEQ ID NO:116) |
| A-N2-1240 | 1240 | 1272 | ATTCTGGTATTTTCTC | GTTGAAGGCAAAAGCT | 1232 | 1280 | GTCCGGTTATTCTGGTATTTTCTC |
| | | | (SEQ ID NO:117) | (SEQ ID NO:118) | | | YGTTGAAGGCAAAAGCTGCATCAA |
| | | | | | | | T (SEQ ID NO:119) |
| A-MP-24 | 24 | 57 | AGATGAGTCTTCTAACC | AGGTCGAAACGTACGT | 22 | 72 | AAAGATGAGTCTTCTAACCGAGGT |
| | | | (SEQ ID NO:120) | (SEQ ID NO:121) | | | CGAAACGTACGTTCTCTCTATCRT |
| | | | | | | | CCC (SEQ ID NO:122) |
| A-MP-158 | 158 | 192 | TGGCTAAAGACAAGACC | ATCCTGTCACCTCTGA | 152 | 207 | ATGGAATGGCTAAAGACAAGACCA |
| | | | (SEQ ID NO:123) | (SEQ ID NO:124) | | | ATCCTGTCACCTCTGACTAAGGGG |
| | | | | | | | ATTTTRGG (SEQ ID NO:125) |
| A-MP-209 | 209 | 241 | TTTGTGTTCACGCTCA | CGTGCCCAGTGAGCGA | 197 | 270 | GGGATTTTAGGKTTTGTGTTCACG |
| | | | (SEQ ID NO:126) | (SEQ ID NO:127) | | | CTCACCGTGCCCAGTGAGCGAGGA |
| | | | | | | | CTGCAGCGTAGACGCTTTGTCCAR |
| | | | | | | | AA (SEQ ID NO:128) |
| A-MP-329 | 329 | 369 | AAACTAAGAGGGAGATAA | TTCCATGGGGCCAAAGAAA | 323 | 372 | TATAGAAAACTTAAGAGGGAGATA |
| | | | C (SEQ ID NO:129) | T (SEQ ID NO:130) | | | ACRTTCCATGGGGCCAAAGAAATA |
| | | | | | | | GC (SEQ ID NO:131) |
| A-MP-547 | 547 | 579 | ACATGAGAACAGAATG | TTTTGGCCAGCACTAC | 536 | 585 | CCATTAATAARACATGAGAACAGR |
| | | | (SEQ ID NO:132) | (SEQ ID NO:133) | | | ATGGTTTTGGCCAGCACTACAGCT |
| | | | | | | | AA (SEQ ID NO:134) |
| A-MP-865 | 865 | 903 | ATTTATCGTCGCCTTAAAT | CGGTTTGAAAAGAGGGCCT | 850 | 938 | CTTTTCTTCAAATGYATTTATCGT |
| | | | (SEQ ID NO:135) | (SEQ ID NO:136) | | | CGCCTTAAATACGGTTTGAAAAGA |
| | | | | | | | GGGCCTTCTACGGAAGGRRTGCCT |
| | | | | | | | GAGTCTATGAGGGAAGA |
| | | | | | | | (SEQ ID N0:137) |
| A-MP-919 | 919 | 961 | CCTGAGTCTATGAGGGAAG | ATCGAAAGGAACAGCAGAA | 898 | 999 | GGGCCTTCTACGGAAGGAGTACCT |
| | | | AA (SEQ ID NO:138) | G (SEQ ID NO:139) | | | GAGTCTATGAGGGAAGAATATCGA |
| | | | | | | | AAGGAACAGCAGAATGCTGTGGAT |
| | | | | | | | GCTGACGACAGTCATTTTGTCAGC |
| | | | | | | | ATAGAG (SEQ ID NO:140) |
| B-HA-106 | 106 | 138 | CCAACAAAATCTCATT | TGCAAATCTCAAAGGA | 97 | 164 | ACAACAACACCAACAAAATCTCAT |
| | | | (SEQ ID NO:141) | (SEQ ID NO:142) | | | TTTGCAAATCTCAAAGGAACAAAG |
| | | | | | | | ACCAGAGGGAAACTATGCCC |
| | | | | | | | (SEQ ID NO:143) |
| B-HA-503 | 503 | 535 | CAGCAACAAATTCATT | ACAATAGAAGTACCAT | 478 | 567 | GTCCCAAAAAACGAMAACAACAAA |
| | | | (SEQ ID NO:144) | (SEQ ID NO:145) | | | ACAGCAACAAATTCATTAACAATA |
| | | | | | | | GAAGTACCATACATTTGTACAGAA |
| | | | | | | | GGAGAAGACCAAATTACC |
| | | | | | | | (SEQ ID NO:146) |
| B-HA-613 | 613 | 645 | TATGGAGACTCAAATC | TCAAAAGTTCACCTCA | 597 | 647 | CCAAATGAAAAACCTCTATGGAGA |
| | | | (SEQ ID NO:147) | (SEQ ID NO:148) | | | CTCAAATCCYCAAAAGTTCACCTC |
| | | | | | | | RTC (SEQ ID NO:149) |
| B-MP-352 | 352 | 389 | CATGAAGCATTTGAAATAG | AGAAGGCCATGAAAGCTC | 346 | 393 | AGCTTYCATGAAGCATTTGAAATA |
| | | | (SEQ ID NO:150) | (SEQ ID NO:151) | | | GCAGAAGGCCATGAAAGCTCAGCG |
| | | | | | | | (SEQ ID NO:152) |
| B-MP-450 | 450 | 485 | AAAACTAGGAACGCTCTG | GCTTTGTGCGAGAAACA | 444 | 509 | GCAAGTAAAACTAGGAACGCTCTG |
| | | | (SEQ ID NO:153) | (SEQ ID NO:154) | | | TGCTTTGTGCGARAAACAAGCATC |
| | | | | | | | ACATTCACACAGGGCTCA |
| | | | | | | | (SEQ ID NO:155) |
| B-NP-646 | 646 | 682 | CACATAATGATTGGGCAT | CACAGATGAATGATGTCT | 646 | 698 | CACATAATGATTGGGCATTCACAG |
| | | | (SEQ ID NO:156) | (SEQ ID NO:157) | | | ATGAATGATGTCTGTTTCCAAAGA |
| | | | | | | | TCAAA (SEQ ID NO:158) |
| B-NP-1144 | 1144 | 1178 | CTTTACAATATGGCAAC | CCTGTTTCCATATTAAG | 1132 | 1179 | GAAGCCATGGCKCTTTACAATATG |
| | | | (SEQ ID NO:159) | (SEQ ID NO:160) | | | GCAACACCTGTTTCCATATTAAGA |
| | | | | | | | (SEQ ID NO:161) |
| B-NP-1211 | 1211 | 1250 | TATTCTTCATGTCTTGCTTC | GAGCTGCCTATGAAGACCT | 1207 | 1283 | CAATTATTCTTCATGTCTTGCTTC |
| | | | (SEQ ID NO:162) | (SEQ ID NO:163) | | | GGAGCTGCCTATGAAGACCTRAGA |
| | | | | | | | GTTTTGTCTGCATTAACAGGCACA |
| | | | | | | | GAATT (SEQ ID NO:164) |
| B-NP-1298 | 1298 | 1333 | CATTAAAATGCAAGGGTT | CCATGTTCCAGCAAAGG | 1265 | 1352 | AAGCCTAGATCAGCATTAAAATGC |
| | | | (SEQ ID NO:165) | (SEQ ID NO:166) | | | AAGGGTTTCCATGTTCCAGCAAAG |
| | | | | | | | GAACAGGTRGAAGGAATGGG |
| | | | | | | | (SEQ ID NO:167) |

TABLE 4
M gene segment probe sequences used in the present study

| | | | | | | |
|---|---|---|---|---|---|---|
| # | 5′ capture sequence 3′ | start | end | 5′ label sequence 3′0 | start | end |

| | | | | | | |
|---|---|---|---|---|---|---|
| 1 | AGATGAGTCTTCTAACC (SEQ ID NO:168) | 24 | 40 | AGGTCGAAACGTACGT (SEQ ID NO:169) | 42 | 57 |
| 2 | GAGGTCGAAACGTATGT (SEQ ID NO:170) | 41 | 57 | CTCTCTATCGTTCCATC (SEQ ID NO:171) | 59 | 75 |
| 3 | GATGTCTTTGCAGGGA (SEQ ID NO:172) | 113 | 128 | GAACACCGATCTTGAG (SEQ ID NO:173) | 130 | 145 |
| 4 | TGGCTAAAGACAAGACC (SEQ ID NO:174) | 158 | 174 | ATCCTGTCACCTCTGA (SEQ ID NO:175) | 176 | 192 |
| 5 | TTTGTGTTCACGCTCA (SEQ ID NO:176) | 209 | 224 | CGTGCCCAGTGAGCGA (SEQ ID NO:177) | 226 | 241 |
| 6 | CGAGGACTGCAGCGTAG (SEQ ID NO:178) | 239 | 255 | CGCTTTGTCCAAAATGC (SEQ ID NO:179) | 257 | 273 |
| 7 | CCTAAATGGGAATGGAGACC (SEQ ID NO:180) | 274 | 293 | AAACAACATGGACAGGGCAG (SEQ ID NO:181) | 295 | 314 |
| 8 | AAACTTAAGAGGGAGATAAC (SEQ ID NO:182) | 329 | 348 | TTCCATGGGGCCAAAGAAAT (SEQ ID NO:183) | 350 | 369 |
| 9 | TGGGTCTCATATACAAC (SEQ ID NO:184) | 408 | 424 | GGATGGGAACGGTGAC (SEQ ID NO:185) | 426 | 441 |
| 10 | CAACATGTGAACAGATTG (SEQ ID NO:186) | 471 | 488 | TGACTCCCAGCACAGGTC (SEQ ID NO:187) | 490 | 507 |
| 11 | ACATGAGAACAGAATG (SEQ ID NO:188) | 547 | 562 | TTTTGGCCAGCACTAC (SEQ ID NO:189) | 564 | 579 |
| 12 | ATGGAGGTTGCTAGTAG (SEQ ID NO:190) | 632 | 648 | GCTAGGCAGATGGTAC (SEQ ID NO:191) | 650 | 665 |
| 13 | CTGGTCTAAGAGATGATC (SEQ ID NO:192) | 705 | 722 | TCTTGAAAATTTGCAGAC (SEQ ID NO:193) | 724 | 741 |
| 14 | ATTTATCGTCGCCTTAAAT (SEQ ID NO:194) | 665 | 883 | CGGTTTGAAAAGAGGGCCT (SEQ ID NO:195) | 885 | 903 |
| 15 | CCTGAGTCTATGAGGGAAGAA (SEQ ID NO:196) | 919 | 939 | ATCGAAAGGAACAGCAGAATG (SEQ ID NO:197) | 941 | 961 |

TABLE 5
Reactivity of 15 MChip capture and label probepairs with M gene sequence
databases used for sequence selection
(sw = swine, eq = equine, h = human, av = avian)

| Data- | microarray sequences | | | | | | | | | | | | | | |
|---|---|---|---|---|---|---|---|---|---|---|---|---|---|---|---|
| base | 1 | 2 | 3 | 4 | 5 | 6 | 7 | 8 | 9 | 10 | 11 | 12 | 13 | 14 | 15 |
| H1N1 | 0.0 | 3.0 | 0.0 | 0.0 | 1.3 | 0.5 | 6.3 | 3.5 | 3.8 | 4.5 | 3.5 | 6.3 | 3.5 | 0.8 | 1.7 |
| (sw)* | | | | | | | | | | | | | | | |
| H1N1 | 0.0 | 3.6 | 3.3 | 0.0 | 0.0 | 0.1 | 6.0 | 1.0 | 4.1 | 4.0 | 1.0 | 4.0 | 5.0 | 5.0 | 2.1 |
| (h) | | | | | | | | | | | | | | | |
| H1N2 | 1.1 | 1.4 | 2.9 | 0.1 | 0.0 | 1.3 | 6.0 | 3.5 | 5.0 | 5.7 | 5.8 | 6.2 | 3.5 | 4.3 | 5.0 |
| (sw) | | | | | | | | | | | | | | | |
| H1N2 | 2.0 | 0.1 | 3.1 | 1.0 | 0.0 | 0.3 | 6.0 | 0.0 | 6.0 | 0.0 | 0.1 | 6.0 | 0.0 | 8.1 | 0.1 |
| (h) | | | | | | | | | | | | | | | |
| H3N2 | 0.0 | 3.8 | 2.4 | 0.1 | 0.7 | 0.5 | 4.4 | 7.9 | 2.4 | 6.1 | 5.4 | 5.6 | 3.7 | 1.3 | 3.3 |
| (av,sw) | | | | | | | | | | | | | | | |
| H3N2 | 2.5 | 0.0 | 3.0 | 0.3 | 0.6 | 0.6 | 5.7 | 0.1 | 6.3 | 0.1 | 0.1 | 6.4 | 0.0 | 9.2 | 0.1 |
| (h) | | | | | | | | | | | | | | | |
| H3N8 | 0.3 | 2.0 | 0.3 | 0.2 | 1.0 | 0.0 | 6.0 | 7.0 | 3.8 | 5.2 | 5.0 | 0.2 | 7.0 | 1.0 | 2.0 |
| (eq, | | | | | | | | | | | | | | | |
| can) | | | | | | | | | | | | | | | |
| H3N8 | 0.0 | 2.0 | 0.0 | 0.0 | 0.5 | 0.5 | 2.0 | 6.5 | 2.5 | 5.0 | 6.0 | 3.5 | 3.0 | 0.0 | 5.0 |
| (av) | | | | | | | | | | | | | | | |
| H5N1 | 0.0 | 3.8 | 2.1 | 0.0 | 0.8 | 1.1 | 5.1 | 8.9 | 0.3 | 8.0 | 2.8 | 5.1 | 3.4 | 0.1 | 4.5 |
| H9N2 | 0.7 | 3.8 | 1.5 | 0.2 | 0.4 | 1.0 | 1.3 | 7.9 | 2.4 | 7.1 | 4.1 | 4.5 | 4.8 | 1.0 | 4.7 |
| antic- | fairly | all | sw | broadly | broadly | broadly | av | h | H5N1 | h | h | eq/can | h | sw, | h |
| ipated | broadly | H1N2, | H1N1, | reactive | reactive | reactive | H9N2 | H1N1, | | H1N2, | H1N1, | H3N8 | H1N2, | av, | H1N2, |
| reac- | reactive | H1N2, | H3N8, | | | | | h | | h H3N2 | h | | h H3N2 | eq, | h H3N2 |
| tivity | | | H9N2 | | | | | H1N2, | | | h H3N2 | | | /can) | |
| | | | | | | | | h H3N2 | | | h H3N2 | | | | |

*host species are denoted by the following abbreviations: h = human, av = avian, sw = swine, eq = equine, and can = canine

TABLE 6
Relative intensities of microarray signals for 58 patient isolates and 9 unknown samples

| | | microarray sequences | | | | | | | | | | | | | | |
|---|---|---|---|---|---|---|---|---|---|---|---|---|---|---|---|---|
| sample ID | subtype | 1 | 2 | 3 | 4 | 5 | 6 | 7 | 8 | 9 | 10 | 11 | 12 | 13 | 14 | 15 |
| A1 | | 10.4 | 48.3 | 1.6 | 13.3 | 2.9 | 25.5 | 3.1 | 1.6 | 3.1 | 2.6 | 3.1 | 65.8 | 1.2 | 3.1 | 3.4 |
| A2 | H5N1 | 46.5 | 2.9 | 8.3 | 6.4 | 1.8 | 63.6 | 0.1 | −0.4 | 100.0 | 0.8 | 0.5 | 0.5 | 0.4 | 42.1 | 3.7 |
| A3 | H6N? | 30.7 | 8.1 | 2.3 | 1.0 | 1.6 | −1.3 | −0.6 | −1.9 | 0.8 | 1.8 | 0.0 | 2.2 | 1.4 | 1.1 | 100.0 |
| A4 | H3N2 | 5.4 | 9.6 | 0.2 | 4.9 | 34.1 | 100.0 | 3.6 | 2.9 | 0.3 | 18.0 | 0.4 | 0.2 | 4.4 | 0.1 | 6.2 |
| A5 | H1N1 | 32.4 | 0.6 | 0.1 | 4.1 | 48.2 | 100.0 | 0.0 | 0.1 | 0.2 | 0.2 | 0.1 | 49.8 | 0.2 | −0.1 | 2.5 |
| A6 | H3N2 | 4.5 | 6.2 | 0.1 | 6.8 | 29.1 | 100.0 | 0.0 | 1.3 | 0.1 | 18.0 | 0.5 | 0.0 | 7.4 | 0.0 | 9.9 |
| A7 | H1N1 | 42.4 | 0.7 | 0.4 | 5.2 | 39.0 | 77.9 | −0.1 | 0.4 | 0.6 | 0.4 | 0.5 | 100.0 | 0.1 | 0.1 | 4.3 |
| B2 | H3N2 | 4.3 | 9.0 | 0.1 | 3.1 | 31.6 | 100.0 | 2.1 | 2.5 | 0.4 | 13.3 | 0.3 | 0.3 | 2.9 | 0.0 | 8.0 |
| B3 | H3N2 | 5.7 | 11.2 | 0.2 | 4.2 | 34.1 | 100.0 | 3.1 | 4.2 | 0.3 | 36.6 | 0.3 | 0.2 | 3.3 | 0.0 | 11.0 |
| B4 | H3N2 | 4.3 | 8.0 | 0.2 | 3.1 | 30.4 | 100.0 | 2.6 | 2.6 | 0.3 | 14.7 | 0.4 | 0.2 | 3.1 | 0.3 | 7.7 |
| B5 | H5N1 | 54.7 | 0.2 | 7.0 | 8.8 | 1.7 | 43.8 | 2.4 | 0.0 | 100.0 | 0.1 | 0.0 | 0.1 | 0.0 | 63.1 | 9.6 |
| B6 | H3N2 | 1.2 | 24.1 | 0.3 | 13.2 | 47.7 | 100.0 | 0.6 | 10.3 | 1.6 | 69.6 | 0.2 | 0.5 | 31.0 | 0.3 | 42.8 |
| B7 | H3N2 | 1.2 | 26.8 | 0.3 | 13.8 | 37.0 | 100.0 | 0.1 | 6.1 | 1.2 | 55.1 | 0.1 | 0.2 | 33.2 | 0.0 | 29.0 |
| B8 | H3N2 | 7.2 | 20.6 | 0.3 | 7.4 | 38.2 | 100.0 | 6.3 | 8.6 | 1.0 | 45.6 | 0.2 | 0.1 | 24.5 | 0.0 | 26.0 |
| B9 | H5N1 | 39.2 | 0.2 | 7.9 | 5.1 | 0.9 | 39.3 | 1.8 | 0.0 | 100.0 | 0.1 | 0.1 | 0.1 | 0.0 | 46.0 | 7.4 |
| C1 | H1N1 | 57.9 | 0.4 | 0.1 | 5.1 | 22.0 | 100.0 | 0.2 | 2.1 | 0.1 | 0.1 | 0.1 | 79.3 | 0.1 | 0.0 | 10.5 |
| C3 | H3N2 | 4.9 | 26.7 | 0.2 | 9.7 | 15.9 | 100.0 | 0.1 | 8.0 | 0.5 | 29.8 | 0.1 | 0.2 | 9.3 | 0.1 | 15.3 |
| C4 | H5N1 | 50.9 | 0.2 | 18.6 | 12.0 | 2.9 | 61.0 | 5.1 | 0.0 | 100.0 | 0.0 | 0.1 | 0.2 | 0.0 | 97.5 | 13.4 |
| C6 | reassortant | 36.9 | 0.3 | 56.8 | 9.1 | 21.1 | 100.0 | 0.2 | 0.4 | 0.8 | 0.4 | 0.1 | 3.4 | 0.1 | 0.0 | 7.8 |
| C7 | H1N1 | 66.0 | 0.1 | 0.0 | 6.5 | 59.2 | 100.0 | 0.0 | 0.8 | 0.1 | 0.1 | 0.0 | 65.4 | 0.1 | 0.0 | 6.4 |
| C8 | H1N1 | 90.2 | 0.1 | 0.1 | 12.3 | 54.1 | 100.0 | 0.1 | 2.5 | 0.0 | 0.1 | 0.2 | 83.8 | 0.0 | 0.0 | 8.5 |
| C9 | H3N8 | 16.3 | 67.2 | 0.3 | 12.4 | 95.8 | 100.0 | 15.3 | 0.2 | 0.2 | 0.4 | 0.2 | 0.2 | 0.5 | 0.2 | 0.5 |
| D1 | H3N2 | 14.4 | 35.7 | 0.1 | 11.9 | 72.9 | 100.0 | 3.8 | 13.4 | 1.0 | 0.1 | 0.1 | 0.3 | 32.8 | 0.0 | 23.6 |
| D2 | H3N2 | 11.7 | 33.0 | 0.1 | 12.7 | 73.0 | 100.0 | 3.7 | 15.4 | 0.4 | 48.3 | 0.1 | 0.0 | 29.1 | 0.0 | 39.2 |
| D3 | H3N2 | 11.7 | 25.1 | 0.2 | 11.8 | 49.9 | 100.0 | 2.5 | 12.7 | 0.5 | 40.1 | 0.2 | 0.0 | 10.4 | 1.4 | 11.3 |
| D4 | H3N2 | 6.2 | 13.9 | 0.1 | 8.9 | 52.6 | 100.0 | 1.9 | 6.7 | 0.2 | 0.1 | 0.1 | 2.7 | 10.8 | 0.0 | 14.8 |
| D6 | H1N1 | 58.8 | 0.3 | 0.0 | 8.7 | 61.3 | 100.0 | 0.1 | 0.4 | 0.0 | 0.1 | 0.0 | 53.2 | 0.1 | 0.0 | 9.0 |
| D7 | H3N2 (swine) | 33.9 | 2.0 | 56.4 | 32.8 | 1.6 | 100.0 | 0.3 | 0.0 | 0.9 | 0.4 | 0.5 | 28.4 | 0.1 | 6.5 | 2.0 |
| D8 | H3N2 | 5.5 | 17.6 | 0.1 | 8.4 | 41.6 | 100.0 | 1.9 | 5.6 | 0.2 | 25.8 | 0.5 | 0.0 | 7.4 | 0.1 | 10.6 |
| E1 | H3N2 | 3.2 | 17.1 | 0.0 | 5.1 | 35.6 | 100.0 | 2.3 | 4.6 | 0.1 | 31.4 | 0.4 | 0.0 | 12.7 | −0.1 | 11.6 |
| E2 | H3N2 | 3.0 | 12.1 | 0.0 | 5.2 | 26.4 | 100.0 | 2.8 | 7.2 | 0.1 | 25.5 | 0.1 | 0.0 | 10.8 | 0.1 | 10.8 |
| E3 | H1N1 | 28.9 | 0.3 | 0.1 | 0.7 | 17.6 | 100.0 | −0.1 | 0.2 | 0.2 | 0.1 | 0.2 | 43.0 | 0.0 | 0.2 | 3.9 |
| E4 | H3N2 | 0.2 | 7.4 | 0.1 | 0.7 | 33.2 | 100.0 | 0.4 | 1.3 | 0.0 | 3.8 | 0.2 | 0.0 | 0.2 | 0.1 | 13.6 |
| E5 | H1N1 | 23.0 | 0.2 | 0.0 | 1.4 | 27.9 | 100.0 | 0.0 | 0.5 | 0.0 | 0.1 | 0.1 | 55.0 | 0.1 | 0.0 | 6.6 |
| E6 | H9N2 | 79.4 | 0.4 | 94.9 | 44.6 | 100.0 | 51.8 | 28.8 | 0.1 | 77.3 | 0.4 | 0.2 | 43.1 | 0.3 | 6.0 | 4.9 |
| E7 | H1N1 | 18.7 | 0.1 | 0.1 | 0.9 | 23.1 | 100.0 | 0.0 | 0.1 | 0.1 | 0.1 | 0.1 | 51.0 | 0.2 | 0.1 | 4.8 |
| F1 | H5N1 | 62.8 | 0.4 | 35.6 | 26.8 | 15.1 | 27.4 | 2.6 | 0.0 | 100.0 | 0.4 | 0.3 | 0.5 | 0.1 | 3.4 | 6.9 |
| F2 | H3N2 | 14.6 | 33.5 | 0.6 | 26.6 | 84.1 | 100.0 | 4.2 | 19.3 | 1.3 | 78.5 | 1.2 | 0.1 | 48.3 | 0.1 | 57.8 |
| F3 | H3N2 | 14.1 | 27.8 | 0.7 | 24.7 | 93.3 | 100.0 | 5.1 | 23.1 | 1.6 | 1.2 | 1.9 | 17.6 | 52.7 | 0.1 | 62.3 |
| F4 | H3N2 | 0.1 | 8.7 | −0.1 | 0.4 | 26.6 | 100.0 | 0.5 | 2.1 | 0.1 | 0.6 | 0.1 | 0.1 | 0.1 | 0.0 | 11.8 |
| F5 | H5N1 | 47.0 | 0.2 | 11.6 | 16.7 | 4.3 | 30.2 | 1.7 | 0.0 | 100.0 | 0.1 | 0.2 | 0.1 | 0.1 | 67.2 | 4.6 |
| F6 | H3N2 | 0.1 | 6.4 | −0.1 | 0.2 | 23.6 | 100.0 | 0.3 | 0.5 | 0.2 | 0.1 | 0.2 | 0.1 | 0.4 | 0.0 | 17.1 |
| F7 | H3N2 | 0.1 | 10.1 | 0.1 | 1.0 | 36.6 | 100.0 | 0.0 | 2.3 | 0.1 | 0.4 | 0.1 | 0.2 | 0.4 | 0.1 | 16.8 |
| F8 | H5N1 | 13.5 | 0.4 | 1.6 | 1.6 | 0.2 | 39.7 | 0.5 | 0.0 | 100.0 | 0.0 | 0.0 | 0.1 | 0.0 | 70.5 | 5.1 |
| F9 | H3N8 | 13.5 | 20.9 | 0.4 | 10.1 | 100.0 | 32.6 | 7.8 | 0.1 | 0.6 | 0.6 | 0.5 | 0.4 | 0.2 | 0.2 | 30.6 |
| G1 | H1N1 | 37.5 | 1.3 | 0.1 | 2.7 | 36.6 | 100.0 | 0.2 | 0.9 | 0.1 | 0.0 | 0.0 | 63.1 | 0.1 | 0.0 | 4.7 |
| G2 | H5N1 | 46.6 | 0.4 | 2.2 | 2.9 | 0.2 | 50.1 | 0.2 | 0.0 | 100.0 | 0.4 | 0.0 | 0.0 | 0.1 | 81.3 | 3.8 |
| G3 | H1N1 | 53.8 | 0.3 | 0.1 | 21.9 | 86.5 | 100.0 | 0.4 | 7.3 | 0.2 | 0.4 | 0.7 | 84.4 | 0.1 | 0.1 | 22.8 |
| G4 | H1N1 | 74.5 | 0.5 | 0.2 | 24.5 | 91.8 | 91.9 | 0.4 | 11.1 | 0.2 | 0.4 | 0.8 | 100.0 | 0.3 | 0.1 | 22.6 |
| G5 | H3N2 | 23.3 | 23.7 | 3.0 | 14.3 | 42.5 | 100.0 | 5.8 | 9.3 | 0.8 | 0.6 | 1.4 | 0.6 | 30.6 | 0.0 | 16.1 |
| G7 | H3N2 | 31.1 | 34.3 | 4.5 | 25.3 | 42.7 | 100.0 | 5.3 | 15.3 | 2.0 | 15.9 | 0.7 | 0.1 | 36.8 | 0.0 | 31.4 |
| G9 | H7N3 | 63.7 | 0.2 | 73.3 | 6.9 | 34.9 | 41.5 | 30.5 | 0.0 | 17.5 | 0.0 | 0.0 | 100.0 | 0.1 | 49.3 | 9.4 |
| H2 | H1N1 | 100.0 | 0.3 | 0.2 | 23.0 | 55.3 | 91.0 | 0.7 | 4.3 | 0.4 | 0.1 | 0.9 | 61.7 | 0.0 | 0.0 | 20.0 |
| H5 | H1N1 | 100.0 | 0.1 | 0.1 | 16.3 | 90.5 | 69.9 | 0.6 | 5.7 | 0.7 | 0.2 | 0.7 | 66.4 | 0.0 | 0.0 | 33.4 |
| H6 | H1N1 | 100.0 | 0.3 | 0.0 | 15.9 | 95.1 | 58.0 | 0.3 | 4.6 | 0.1 | 0.0 | 0.4 | 41.0 | 0.0 | 0.0 | 11.9 |
| H7 | H1N1 | 65.0 | 0.1 | 0.1 | 11.7 | 66.9 | 100.0 | 0.3 | 2.5 | 0.1 | 0.0 | 0.3 | 72.7 | 0.1 | 0.0 | 16.4 |
| H8 | H1N1 | 100.0 | 0.2 | 0.3 | 11.5 | 39.0 | 57.6 | 0.3 | 3.9 | 0.7 | 0.0 | 0.5 | 46.6 | 0.1 | 0.0 | 16.6 |
| H9 | H7N7 | 100.0 | 27.3 | 12.4 | 0.3 | 14.7 | 16.6 | 0.3 | 0.3 | 40.8 | 0.6 | 0.3 | 6.7 | 9.2 | 19.3 | 82.9 |
| CDPHE 200 | | 10.2 | 11.8 | 0.6 | 8.8 | 42.5 | 100.0 | 5.5 | 4.4 | 0.3 | 0.7 | 0.4 | 6.5 | 15.0 | 0.0 | 14.9 |
| CDPHE 002 | | 13.7 | 13.3 | 0.8 | 8.7 | 49.2 | 100.0 | 5.0 | 2.9 | 0.6 | 0.3 | 0.5 | 6.2 | 13.8 | 0.0 | 15.2 |
| CDPHE 196 | | 15.4 | 17.9 | 0.2 | −0.6 | 18.2 | 100.0 | 5.3 | 2.9 | 1.2 | 0.6 | 1.1 | 10.4 | 13.4 | 0.0 | 13.6 |
| CDPHE 197 | | 17.0 | 20.4 | 0.8 | 11.9 | 50.1 | 100.0 | 6.2 | 5.2 | 1.0 | 1.2 | 0.7 | 10.9 | 18.6 | 0.0 | 18.1 |
| CDPHE 198 | | 29.2 | 33.6 | 3.4 | 0.1 | 48.5 | 100.0 | 10.7 | 16.0 | 2.4 | 3.0 | 2.1 | 39.8 | 49.9 | 0.2 | 33.7 |
| CDPHE 201 | | 8.8 | 11.4 | 0.3 | 8.1 | 37.6 | 100.0 | 5.9 | 6.6 | 0.3 | 0.8 | 0.6 | 7.8 | 11.2 | −0.1 | 14.7 |
| CDPHE 203 | | 7.4 | 11.3 | 0.2 | 7.2 | 41.3 | 100.0 | 4.3 | 3.6 | 0.3 | 0.3 | 0.3 | 7.6 | 9.2 | −0.2 | 12.9 |
| CDPHE 226 | | 20.5 | 26.7 | 1.2 | 19.5 | 73.3 | 100.0 | 7.9 | 7.5 | 0.0 | 1.2 | 0.5 | 21.3 | 20.9 | 0.0 | 21.1 |
| CDPHE 227 | | 15.1 | 23.3 | 0.9 | 10.9 | 30.8 | 100.0 | 5.1 | 5.3 | 1.0 | 2.0 | 1.9 | 13.0 | 12.1 | 0.6 | 13.9 |

TABLE 7
Influenza A subtype determination for 53 samples
using an artificial neural network (ANN). The value for each
ANN output assignment score ranges from 0-1. Samples are
labeled in order numerically, and any
assignment score greater than 0.75 is highlighted.
Checkmarks indicate correct of the virus type,
subtype or negative and X represents an incorrect assignment.

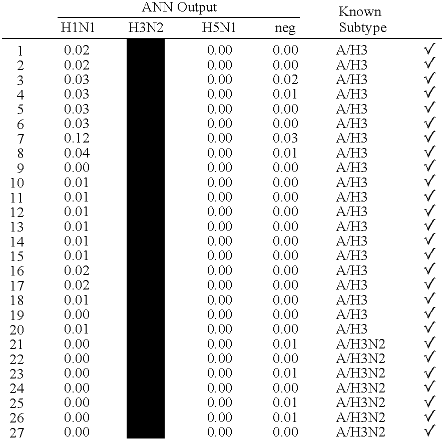

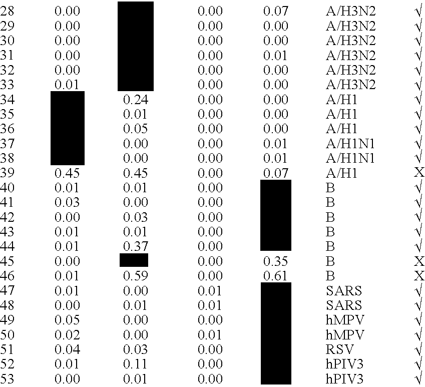

HA partial subtype identified by immunofluorescence assay by the Colorado Department of Public Health and Environment (CDPHE); Full antigenic characterization provided by Centers for Disease Control (CDC); Samples 47-53 are influenza-like illnesses included as negative controls: SARS (severe acute respiratory syndrome), hMPV (human metapneumovirus), RSV (respiratory syncytial virus), hPIV3 (human parainfluenza virus type 3)

TABLE 8
Influenza A subtype determination for 87 microarrays tests (34 distinct
A/H5N1 viruses) using an artificial neural network (ANN). The value for each ANN
output assignment score ranges from 0-1. Samples are labelled in order numerically,
and any assignment score greater than 0.93 is highlighted. Checkmarks indicate
correct identification of virus subtype and X represents an incorrect assignment.
Viral RNA was provided by the CDC.

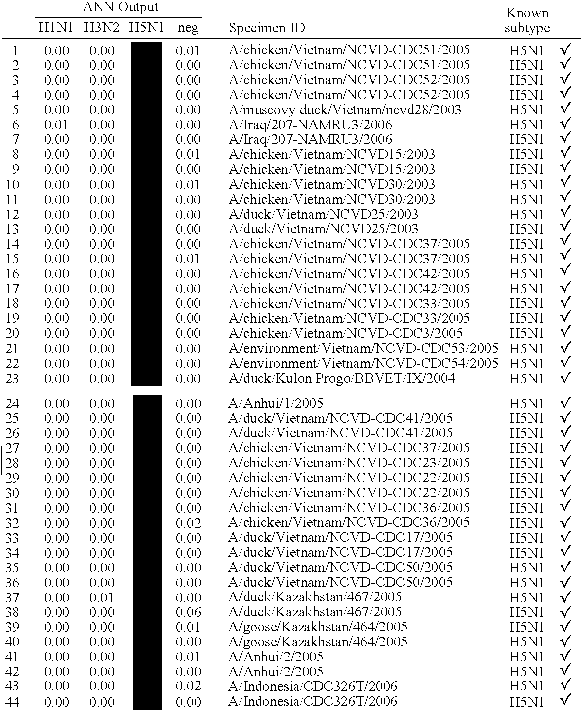

Samples 47-53 are influenza-like illnesses included as negative controls: SARS (severe acute respiratory syndrome), hMPV (human metapneumovirus), RSV (respiratory syncytial virus), hPIV3 (human parainfluenza virus type 3)

All of the COMPOSITIONS, METHODS and APPARATUS disclosed and claimed herein can be made and executed without undue experimentation in light of the present disclosure. While the compositions, methods and apparatus have been described in terms of preferred embodiments, it will be apparent to those of skill in the art that variations may be applied to the COMPOSITIONS, METHODS and APPARATUS and in the steps or in the sequence of 59eps of the methods described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. An array comprising:
a plurality of capture probes comprising oligonucleotides, wherein the capture probes are capable of binding to oligonucleotides comprising at least a portion of a nucleic acid sequence or complimentary nucleic acid sequence of a target gene of one or more influenza virus.

2. The array of claim 1, wherein the capture probes are capable of binding to one or more influenza type.

3. The array of claim 1, wherein the capture probes are capable of binding to one or more influenza A subtype or strain.

4. The array of claim 1, wherein the plurality of capture probes are bound to the surface of a solid substrate.

5. The array of claim 4, wherein the array contains 100 or less capture probes bound to the surface of the solid substrate.

6. The array of claim 4, wherein the solid substrate is selected from the group consisting of glass, plastic, silicon-coated substrate, macromolecule-coated substrate, particles, beads, microparticles, microbeads, dipstick, magnetic beads, paramagnetic beads and a combination thereof.

7. The array of claim 4, further comprising a positive control probe bound to the surface of the solid substrate, wherein the positive control probe is capable of indicating conditions sufficient to form a complex of a capture probe binding to an oligonucleotide comprising at least a portion of a nucleic acid sequence or complimentary nucleic acid sequence of a target gene.

8. The array of claim 1, wherein the array is a microarray.

9. The array of claim 8, wherein the microarray is a multiplex characteristic array derived from more than one target gene.

10. The array of claim 1, wherein the capture probes are capable of binding to an influenza strain selected from the group consisting of influenza A H3N2, influenza A H1N1, influenza A H5N1, influenza A H7N7, influenza A H9N2, influenza A H3N8, influenza A H1N2, influenza A H3N3, influenza A H3 and a combination thereof.

11. The array of claim 1, wherein the oligonucleotides comprising at least a portion of a nucleic acid sequence or complimentary nucleic acid sequence are derived from a single target gene segment.

12. The array of claim 1, wherein the capture probes are selected from sequences listed in Table 3, Table 4, or a combination thereof.

13. The array of claim 1, wherein each of the capture probes are independently about 10 to about 100 nucleotides (nt) in length.

14. A method for producing an array for detecting the presence of influenza virus comprising:
attaching a plurality of capture probes to a solid substrate surface to form an array, wherein the capture probes are capable of binding to oligonucleotides comprising at least a portion of a nucleic acid sequence or complimentary nucleic acid sequence of a target gene of one or more influenza virus.

15. The method of claim 14, wherein the capture probes are capable of binding to one or more influenza type.

16. The method of claim 14, wherein the capture probes are capable of binding to one or more influenza A subtype or strain.

17. The method of claim 14, further comprising binding a positive control probe to the surface of the solid substrate, wherein the positive control probe is capable of indicating conditions sufficient to form a complex of a capture probe binding to an oligonucleotide comprising at least a portion of a nucleic acid sequence or complimentary nucleic acid sequence of a target gene.

18. The method of claim 14, wherein the capture probes are capable of binding to oligonucleotides comprising at least a portion of a nucleic acid sequence or complimentary nucleic acid sequence of a target gene selected from the group consisting of hemagglutinin (HA gene segment), neuraminidase (NA gene segment), matrix protein (M gene segment) and a combination thereof.

19. The method of claim 14, wherein the capture probes are capable of binding to oligonucleotides comprising at least a portion of a nucleic acid sequence or complimentary nucleic acid sequence of the M gene segment.

20. A method for detecting influenza in a sample, the method comprising:
a) contacting the sample with an array of a plurality of capture probes to produce a test array, wherein the test array comprises a capture probe-sample complex when the sample contains an oligonucleotide comprising at least a portion of a nucleic acid sequence or complimentary nucleic acid sequence of a target gene of one or more influenza virus; and
b) contacting the test array with one or more detection probes to produce a labeled array, wherein the labeled array comprises a target-probe complex when the test array comprises the a capture probe-sample complex, and wherein the presence of the target-probe complex is indicative of the presence of influenza virus in the sample.

21. The method of claim 20, wherein the array comprises a plurality of capture probes comprising at least a portion of a nucleic acid sequence or complimentary nucleic acid sequence of one or more target genes of at least one influenza virus type, subtype or strain.

22. The method of claim 20, wherein the presence of influenza virus in the sample is determined by detecting a signal generated by the probe of a target-probe complex.

23. The method of claim 22, wherein the signal generated by the target-probe complex produces different patterns depending on the influenza type, subtype or strain present in the sample.

24. The method of claim 20, wherein the capture probes are capable of binding to one or more influenza type.

25. The method of claim 20, wherein the capture probes are capable of binding to one or more influenza A subtype or strain.

26. The method of claim 20, further comprising a positive control probe bound to the surface of the solid substrate, wherein the positive control probe is capable of indicating conditions sufficient to form a complex of a capture probe binding to an oligonucleotide comprising at least a portion of a nucleic acid sequence or complimentary nucleic acid sequence of a target gene.

27. The method of claim 20, further comprising a negative control probe bound to the surface of the solid substrate, wherein the negative control probe is capable of indicating conditions sufficient to indicate specificity of the capture label probes to bind to influenza virus and not to the negative control probe.

28. The method of claim 20, wherein the target gene is selected from the group consisting of hemagglutinin (HA gene segment), neuraminidase (NA gene segment), matrix protein (M gene segment) and a combination thereof.

29. The method of claim 20, wherein the sample is selected from the group consisting of nasopharangeal washes, expectorate, optical swab, respiratory tract swabs, throat swabs, nasal swabs, nasal mucus, tracheal aspirates, bronchoalveolar lavage, mucus, blood, urine, tissue, saliva, air samples, air-filter samples, surface-associated samples and a combination thereof.

30. The method of claim 20, further comprising identifying the presence of influenza in a sample in 12 hours or less.

31. An array comprising:
a plurality of capture probes comprising oligonucleotides, wherein the capture probes are capable of binding to oligonucleotides comprising at least a portion of a nucleic acid sequence or complimentary nucleic acid sequence of a single target gene segment of one or more influenza virus.

32. The array of claim 31, wherein the capture probes are capable of binding to one or more influenza type.

33. The array of claim 31, wherein the capture probes are capable of binding to one or more influenza A subtype or strain.

34. The method of claim 31, wherein the capture probes are capable of binding to oligonucleotides comprising at least a portion of a nucleic acid sequence or complimentary nucleic acid sequence of the M gene.

35. The method of claim 31, wherein the portion of a nucleic acid sequence or complimentary nucleic acid sequence of a single target gene segment comprise conserved sequence regions for a type, subtype or strain of influenza.

36. A kit comprising:
(a) an array of a plurality of capture probes bound to the surface of a solid substrate, wherein the capture probes are capable of binding to oligonucleotides comprising at least a portion of a nucleic acid sequence or complimentary nucleic acid sequence of a target gene of one or more influenza virus; and
(b) one or more tagged label probes wherein the tagged label probes are capable of producing a signal and wherein the label probes are capable of binding to the oligonucleotides comprising at least a portion of a nucleic acid sequence or complimentary nucleic acid sequence of a target gene of one or more influenza virus.

37. The kit of claim 36, further comprising a positive control probe bound to the surface of the solid substrate, wherein the positive control probe is capable of indicating conditions sufficient to form a complex of a capture probe binding to an oligonucleotide comprising at least a portion of a nucleic acid sequence or complimentary nucleic acid sequence of a target gene.


SEQUENCE LISTING (197 sequences)

SEQ ID NO: 1 - DNA, 25 bp, Influenza A virus
cgtatataaaacggaacgtcgaagg

SEQ ID NO: 2 - DNA, 25 bp, Influenza A virus
ccttcgacgttccgttttatatacg

SEQ ID NO: 3 - DNA, 17 bp, Influenza A virus
tgttgacacagtacttg

SEQ ID NO: 4 - DNA, 17 bp, Influenza A virus
gaagaatgtgacagtga

SEQ ID NO: 5 - DNA, 50 bp, Influenza A virus
actgttgacacagtacttgagaagaaygtgacagtgacacactctgtcaa

SEQ ID NO: 6 - DNA, 18 bp, Influenza A virus
cacactctgtcaacctac

SEQ ID NO: 7 - DNA, 18 bp, Influenza A virus
tgaggacagtcacaatgg

SEQ ID NO: 8 - DNA, 47 bp, Influenza A virus
gtgacagtgacacactctgtcaayctacttgaggacagtcacaatgg

SEQ ID NO: 9 - DNA, 19 bp, Influenza A virus
tgtcttcacattatagcag

SEQ ID NO: 10 - DNA, 18 bp, Influenza A virus
agattcaccccagaaata

SEQ ID NO: 11 - DNA, 46 bp, Influenza A virus
tgtcttcacattatagcagaagattcaccccagaaatarcmaaaag

SEQ ID NO: 12 - DNA, 16 bp, Influenza A virus
ttccagaatgtacacc

SEQ ID NO: 13 - DNA, 17 bp, Influenza A virus
agtcacaataggagagt

SEQ ID NO: 14 - DNA, 54 bp, Influenza A virus
ttccagaaygtacacccagtyacaataggagagtgtccaaagtatgtcaggagt

SEQ ID NO: 15 - DNA, 16 bp, Influenza A virus
aagtatgtcaggagtg

SEQ ID NO: 16 - DNA, 23 bp, Influenza A virus
aaaattaaggatggttacaggac

SEQ ID NO: 17 - DNA, 66 bp, Influenza A virus
acaataggagagtgtccaaagtatgtcaggagtrcaaaattaaggatggttacaggactaaggaac

SEQ ID NO: 18 - DNA, 16 bp, Influenza A virus
ctcaaaaacttcccgt

SEQ ID NO: 19 - DNA, 17 bp, Influenza A virus
aatgacaacagcacggc

SEQ ID NO: 20 - DNA, 50 bp, Influenza A virus
gctcaaaaacttcccgkaaatgacaacagcacggcaacgctgtgcctggg

SEQ ID NO: 21 - DNA, 15 bp, Influenza A virus
tgaccaaattgaagt

SEQ ID NO: 22 - DNA, 15 bp, Influenza A virus
actaatgctactgag

SEQ ID NO: 23 - DNA, 61 bp, Influenza A virus
ctagtgaaaacaatcacgaatgaccaaattgaagtractaatgctactgagctggttcaga

SEQ ID NO: 24 - DNA, 17 bp, Influenza A virus
cttgatggagaaaactg

SEQ ID NO: 25 - DNA, 17 bp, Influenza A virus
acactaatagatgctct

SEQ ID NO: 26 - DNA, 50 bp, Influenza A virus
atccttgatggagaaaactgcacactaatagatgctctattgggagaccc

SEQ ID NO: 27 - DNA, 17 bp, Influenza A virus
caaaataaggaatggga

SEQ ID NO: 28 - DNA, 18 bp, Influenza A virus
ctttttgttgaacgcagc

SEQ ID NO: 29 - DNA, 73 bp, Influenza A virus
tgggagaccctcattgtgatggcttccaaaataaggaatgggacctttttgttgaacgcagcaaagcctacag

SEQ ID NO: 30 - DNA, 17 bp, Influenza A virus
tacccttatgatgtgcc

SEQ ID NO: 31 - DNA, 17 bp, Influenza A virus
gattatgcctcccttag

SEQ ID NO: 32 - DNA, 76 bp, Influenza A virus
tgttacccttatgatgtgccggattatgtctcccttaggtcactagttgcctcatcaggcacrctggagtttaaca

SEQ ID NO: 33 - DNA, 16 bp, Influenza A virus
caaaagaagccaacaa

SEQ ID NO: 34 - DNA, 17 bp, Influenza A virus
ctgtaatcccgaatatc

SEQ ID NO: 35 - DNA, 71 bp, Influenza A virus
tcacagtctctaccaaaagaagccaacaaactgtaatcccgaatatcggatctagacccagggtaagggat

SEQ ID NO: 36 - DNA, 18 bp, Influenza A virus
aagcatctactggacaat

SEQ ID NO: 37 - DNA, 16 bp, Influenza A virus
ggtctgtctagtagaa

SEQ ID NO: 38 - DNA, 56 bp, Influenza A virus
ggtctktctagtagaataagcatctactggacmatagttaaaccaggggacatcct

SEQ ID NO: 39 - DNA, 16 bp, Influenza A virus
caaatgcaattctgaa

SEQ ID NO: 40 - DNA, 16 bp, Influenza A virus
gcatcactccaaatgg

SEQ ID NO: 41 - DNA, 61 bp, Influenza A virus
gatgcacccattggcaaatgcaattctgaatgcatcactccaaatggaagcattccyaatg

SEQ ID NO: 42 - DNA, 18 bp, Influenza A virus
ccatcagattgaaaaaga

SEQ ID NO: 43 - DNA, 19 bp, Influenza A virus
ttctcagaagtagaaggga

SEQ ID NO: 44 - DNA, 87 bp, Influenza A virus
gagaaattccatcarattgaaaaagaattctcagaagtagargggagaattcaggacctcgagaaatatgttgaggacactaaaata

SEQ ID NO: 45 - DNA, 20 bp, Influenza A virus
caaatctgcattggttatca

SEQ ID NO: 46 - DNA, 20 bp, Influenza A virus
gcaaacaattcaacaaaaca

SEQ ID NO: 47 - DNA, 117 bp, Influenza A virus
gaccaaatctgcattggttatcatgcaaacaattcaacaaaacaagttgacacaatcatggaaaagaatgtgacggtcacacatgctcaggacatactagaaaaagaacacaatgga

SEQ ID NO: 48 - DNA, 17 bp, Influenza A virus
caggttgacacaataat

SEQ ID NO: 49 - DNA, 17 bp, Influenza A virus
gaaaagaacgttactgt

SEQ ID NO: 50 - DNA, 54 bp, Influenza A virus
acagagcaggttgacacaataatggaaaagaacgttactgttacacatgcccaa

SEQ ID NO: 51 - DNA, 18 bp, Influenza A virus
agagattgtagtgtagct

SEQ ID NO: 52 - DNA, 18 bp, Influenza A virus
gatggctcctcggaaacc

SEQ ID NO: 53 - DNA, 74 bp, Influenza A virus
agagattgtagtgtagctggatggctcctcggraacccaatgtgtgacgaattcatcaatgtrccggaatggtc

SEQ ID NO: 54 - DNA, 17 bp, Influenza A virus
gaaaattcagatcatcc

SEQ ID NO: 55 - DNA, 16 bp, Influenza A virus
caaaagttcttggtcc

SEQ ID NO: 56 - DNA, 68 bp, Influenza A virus
tgaaacacctattgagcagaataaaccattttgagaaaattcagatcatccccaaaarttcttggtcc

SEQ ID NO: 57 - DNA, 17 bp, Influenza A virus
ctacaataataccaacc

SEQ ID NO: 58 - DNA, 16 bp, Influenza A virus
agaagatcttttggta

SEQ ID NO: 59 - DNA, 56 bp, Influenza A virus
agctacaataataccaaccaagaagatcttttggtamtgtgggggattcaycatcc

SEQ ID NO: 60 - DNA, 17 bp, Influenza A virus
agtgaattggaatatgg

SEQ ID NO: 61 - DNA, 16 bp, Influenza A virus
aactgcaacaccaagt

SEQ ID NO: 62 - DNA, 91 bp, Influenza A virus
caattatgaaaagtgaattggaatatggtaactgcaacaccaagtgtcaaactccaatgggggcgataaactctagtatgccattccacaa

SEQ ID NO: 63 - DNA, 20 bp, Influenza A virus
gcaattcatctctttgttct

SEQ ID NO: 64 - DNA, 19 bp, Influenza A virus
tcagtggatgggctatata

SEQ ID NO: 65 - DNA, 53 bp, Influenza A virus
gtgacattggccggcaattcatctctttgttctatcagtggatgggctatata

SEQ ID NO: 66 - DNA, 19 bp, Influenza A virus
ttttgtcataagagaacct

SEQ ID NO: 67 - DNA, 20 bp, Influenza A virus
tcatatcatgttctcacttg

SEQ ID NO: 68 - DNA, 71 bp, Influenza A virus
tccaaaggagatgtttttgtcataagagarcctttcatatcatgttctcacttggaatgcagaaccttttt

SEQ ID NO: 69 - DNA, 16 bp, Influenza A virus
ttttgtcataagagag

SEQ ID NO: 70 - DNA, 23 bp, Influenza A virus
cttttatttcatgttctcacttg

SEQ ID NO: 71 - DNA, 49 bp, Influenza A virus
gtttttgtcataagagarccytttatttcatgttctcacttggaatgca

SEQ ID NO: 72 - DNA, 24 bp, Influenza A virus
cattctaatgggaccgtcaaagac

SEQ ID NO: 73 - DNA, 24 bp, Influenza A virus
ggagcccctatagaactttaatga

SEQ ID NO: 74 - DNA, 54 bp, Influenza A virus
acaagcattctaatgggaccgtcaaagacaggagcccctatagaactttaatga

SEQ ID NO: 75 - DNA, 18 bp, Influenza A virus
ccatacaattcaaggttt

SEQ ID NO: 76 - DNA, 18 bp, Influenza A virus
agtcagttgcttggtcag

SEQ ID NO: 77 - DNA, 47 bp, Influenza A virus
ccatacaattcaaggtttgagtcdgttgcttggtcagcragtgcttg

SEQ ID NO: 78 - DNA, 17 bp, Influenza A virus
caattggaatttctggc

SEQ ID NO: 79 - DNA, 16 bp, Influenza A virus
cagacaatggggctgt

SEQ ID NO: 80 - DNA, 55 bp, Influenza A virus
tgacaattggaatttctggcccagacartggggctgtggctgtattgaaatacaa

SEQ ID NO: 81 - DNA, 16 bp, Influenza A virus
gatgcacctaattctc

SEQ ID NO: 82 - DNA, 15 bp, Influenza A virus
ctacgaggaatgttc

SEQ ID NO: 83 - DNA, 51 bp, Influenza A virus
ttgratgcacctaattctcactaygaggaatgttcctgttaccctgatacc

SEQ ID NO: 84 - DNA, 16 bp, Influenza A virus
gagtatcaaataggat

SEQ ID NO: 85 - DNA, 23 bp, Influenza A virus
tatatgcagtggagttttcggag

SEQ ID NO: 86 - DNA, 74 bp, Influenza A virus
tgggtatctttcaatcaaaatttggagtatcaaatasgatatatatgcagtggagttttcggagacaatccacg

SEQ ID NO: 87 - DNA, 16 bp, Influenza A virus
atacatctgcagtgga

SEQ ID NO: 88 - DNA, 16 bp, Influenza A virus
tgttcggtgacaatcc

SEQ ID NO: 89 - DNA, 65 bp, Influenza A virus
tggattatcaaataggatacatctgcagtggrgtgttcggtgacaatccgcgtcccaaagatgga

SEQ ID NO: 90 - DNA, 16 bp, Influenza A virus
caaaagcactagttcc

SEQ ID NO: 91 - DNA, 23 bp, Influenza A virus
ggagcggttttgaaatgatttgg

SEQ ID NO: 92 - DNA, 50 bp, Influenza A virus
gggagaaccaaaagcactagttcyaggagcggttttgaaatgatttggga

SEQ ID NO: 93 - DNA, 16 bp, Influenza A virus
gataataacaattggc

SEQ ID NO: 94 - DNA, 17 bp, Influenza A virus
ccgtctctctaaccatt

SEQ ID NO: 95 - DNA, 77 bp, Influenza A virus
ccaaatcagaagataataacaattggytchrtctctctaaccattgcaacagtatgtttcctyatgcagattgccat

SEQ ID NO: 96 - DNA, 16 bp, Influenza A virus
gaaatatgccccaaac

SEQ ID NO: 97 - DNA, 18 bp, Influenza A virus
agcagaatacagaaattg

SEQ ID NO: 98 - DNA, 60 bp, Influenza A virus
atagagaaggaaatatgccccaaactagcagaatacagaaattggtcaaagccgcaatgt

SEQ ID NO: 99 - DNA, 16 bp, Influenza A virus
caaacaagtgtgcata

SEQ ID NO: 100 - DNA, 16 bp, Influenza A virus
catggtccagctcaag

SEQ ID NO: 101 - DNA, 47 bp, Influenza A virus
accaaacaagtgtgcatrgcatggtccagctcaagctgccatgatgg

SEQ ID NO: 102 - DNA, 17 bp, Influenza A virus
ctcaaaatatcctcaga

SEQ ID NO: 103 - DNA, 16 bp, Influenza A virus
ctcaggagtcagaatg

SEQ ID NO: 104 - DNA, 48 bp, Influenza A virus
tggtcycaaaatatcctcagaactcaggagtcagaatgygtttgcatc

SEQ ID NO: 105 - DNA, 17 bp, Influenza A virus
ctcgatatcctggtgtc

SEQ ID NO: 106 - DNA, 16 bp, Influenza A virus
gatgtgtctgcagaga

SEQ ID NO: 107 - DNA, 65 bp, Influenza A virus
tatcctcgatatcctggtgtcagatgtgtctgcagagacaactggaaaggctccaataggcccat

SEQ ID NO: 108 - DNA, 24 bp, Influenza A virus
tagcattgtttccagttatgtgtg

SEQ ID NO: 109 - DNA, 18 bp, Influenza A virus
tcaggacttgttggagac

SEQ ID NO: 110 - DNA, 66 bp, Influenza A virus
taaaggattatagcattgtttccagttatgtgtgctcaggacttgttggagacacacccagaaaaa

SEQ ID NO: 111 - DNA, 17 bp, Influenza A virus
caggttatgagactttc

SEQ ID NO: 112 - DNA, 17 bp, Influenza A virus
gagtcattggtggttgg

SEQ ID NO: 113 - DNA, 53 bp, Influenza A virus
agcaaggattcacgctcaggttatgaractttcagrgtcattggtggttggac

SEQ ID NO: 114 - DNA, 19 bp, Influenza A virus
acctaactccaaattgcag

SEQ ID NO: 115 - DNA, 21 bp, Influenza A virus
taaataggcaagtcatagttg

SEQ ID NO: 116 - DNA, 45 bp, Influenza A virus
acctaaytccaaattgcagayaaataggcaagtcatagttgacag

SEQ ID NO: 117 - DNA, 16 bp, Influenza A virus
attctggtattttctc

SEQ ID NO: 118 - DNA, 16 bp, Influenza A virus
gttgaaggcaaaagct

SEQ ID NO: 119 - DNA, 49 bp, Influenza A virus
gtccggttattctggtattttctcygttgaaggcaaaagctgcatcaat

SEQ ID NO: 120 - DNA, 17 bp, Influenza A virus
agatgagtcttctaacc

SEQ ID NO: 121 - DNA, 16 bp, Influenza A virus
aggtcgaaacgtacgt

SEQ ID NO: 122 - DNA, 51 bp, Influenza A virus
aaagatgagtcttctaaccgaggtcgaaacgtacgttctctctatcrtccc

SEQ ID NO: 123 - DNA, 17 bp, Influenza A virus
tggctaaagacaagacc

SEQ ID NO: 124 - DNA, 16 bp, Influenza A virus
atcctgtcacctctga

SEQ ID NO: 125 - DNA, 56 bp, Influenza A virus
atggaatggctaaagacaagaccaatcctgtcacctctgactaaggggattttrgg

SEQ ID NO: 126 - DNA, 16 bp, Influenza A virus
tttgtgttcacgctca

SEQ ID NO: 127 - DNA, 16 bp, Influenza A virus
cgtgcccagtgagcga

SEQ ID NO: 128 - DNA, 74 bp, Influenza A virus
gggattttaggktttgtgttcacgctcaccgtgcccagtgagcgaggactgcagcgtagacgctttgtccaraa

SEQ ID NO: 129 - DNA, 20 bp, Influenza A virus
aaacttaagagggagataac

SEQ ID NO: 130 - DNA, 20 bp, Influenza A virus
ttccatggggccaaagaaat

SEQ ID NO: 131 - DNA, 50 bp, Influenza A virus
tatagaaaacttaagagggagataacrttccatggggccaaagaaatagc

SEQ ID NO: 132 - DNA, 16 bp, Influenza A virus
acatgagaacagaatg

SEQ ID NO: 133 - DNA, 16 bp, Influenza A virus
ttttggccagcactac

SEQ ID NO: 134 - DNA, 50 bp, Influenza A virus
ccattaataaracatgagaacagratggttttggccagcactacagctaa

SEQ ID NO: 135 - DNA, 19 bp, Influenza A virus
atttatcgtcgccttaaat

SEQ ID NO: 136 - DNA, 19 bp, Influenza A virus
cggtttgaaaagagggcct

SEQ ID NO: 137 - DNA, 89 bp, Influenza A virus
cttttcttcaaatgyatttatcgtcgccttaaatacggtttgaaaagagggccttctacggaaggrrtgcctgagtctatgagggaaga

SEQ ID NO: 138 - DNA, 21 bp, Influenza A virus
cctgagtctatgagggaagaa

SEQ ID NO: 139 - DNA, 21 bp, Influenza A virus
atcgaaaggaacagcagaatg

SEQ ID NO: 140 - DNA, 102 bp, Influenza A virus
gggccttctacggaaggagtacctgagtctatgagggaagaatatcgaaaggaacagcagaatgctgtggatgctgacgacagtcattttgtcagcatagag

SEQ ID NO: 141 - DNA, 16 bp, Influenza A virus
ccaacaaaatctcatt

SEQ ID NO: 142 - DNA, 16 bp, Influenza A virus
tgcaaatctcaaagga

SEQ ID NO: 143 - DNA, 68 bp, Influenza A virus
acaacaacaccaacaaaatctcattttgcaaatctcaaaggaacaaagaccagagggaaactatgccc

SEQ ID NO: 144 - DNA, 16 bp, Influenza A virus
cagcaacaaattcatt

SEQ ID NO: 145 - DNA, 16 bp, Influenza A virus
acaatagaagtaccat

SEQ ID NO: 146 - DNA, 90 bp, Influenza A virus
gtcccaaaaaacgamaacaacaaaacagcaacaaattcattaacaatagaagtaccatacatttgtacagaaggagaagaccaaattacc

SEQ ID NO: 147 - DNA, 16 bp, Influenza A virus
tatggagactcaaatc

SEQ ID NO: 148 - DNA, 16 bp, Influenza A virus
tcaaaagttcacctca

SEQ ID NO: 149 - DNA, 51 bp, Influenza A virus
ccaaatgaaaaacctctatggagactcaaatccycaaaagttcacctcrtc

SEQ ID NO: 150 - DNA, 19 bp, Influenza A virus
catgaagcatttgaaatag

SEQ ID NO: 151 - DNA, 18 bp, Influenza A virus
agaaggccatgaaagctc

SEQ ID NO: 152 - DNA, 48 bp, Influenza A virus
agcttycatgaagcatttgaaatagcagaaggccatgaaagctcagcg

SEQ ID NO: 153 - DNA, 18 bp, Influenza A virus
aaaactaggaacgctctg

SEQ ID NO: 154 - DNA, 17 bp, Influenza A virus
gctttgtgcgagaaaca

SEQ ID NO: 155 - DNA, 66 bp, Influenza A virus
gcaagtaaaactaggaacgctctgtgctttgtgcgaraaacaagcatcacattcacacagggctca

SEQ ID NO: 156 - DNA, 18 bp, Influenza A virus
cacataatgattgggcat

SEQ ID NO: 157 - DNA, 18 bp, Influenza A virus
cacagatgaatgatgtct

SEQ ID NO: 158 - DNA, 53 bp, Influenza A virus
cacataatgattgggcattcacagatgaatgatgtctgtttccaaagatcaaa

SEQ ID NO: 159 - DNA, 17 bp, Influenza A virus
ctttacaatatggcaac

SEQ ID NO: 160 - DNA, 17 bp, Influenza A virus
cctgtttccatattaag

SEQ ID NO: 161 - DNA, 48 bp, Influenza A virus
gaagccatggckctttacaatatggcaacacctgtttccatattaaga

SEQ ID NO: 162 - DNA, 20 bp, Influenza A virus
tattcttcatgtcttgcttc

SEQ ID NO: 163 - DNA, 19 bp, Influenza A virus
gagctgcctatgaagacct

SEQ ID NO: 164 - DNA, 77 bp, Influenza A virus
caattattcttcatgtcttgcttcggagctgcctatgaagacctragagttttgtctgcattaacaggcacagaatt

SEQ ID NO: 165 - DNA, 18 bp, Influenza A virus
cattaaaatgcaagggtt

SEQ ID NO: 166 - DNA, 17 bp, Influenza A virus
ccatgttccagcaaagg

SEQ ID NO: 167 - DNA, 68 bp, Influenza A virus
aagcctagatcagcattaaaatgcaagggtttccatgttccagcaaaggaacaggtrgaaggaatggg

SEQ ID NO: 168 - DNA, 17 bp, Influenza A virus
agatgagtcttctaacc

SEQ ID NO: 169 - DNA, 16 bp, Influenza A virus
aggtcgaaacgtacgt

SEQ ID NO: 170 - DNA, 17 bp, Influenza A virus
gaggtcgaaacgtatgt

SEQ ID NO: 171 - DNA, 17 bp, Influenza A virus
ctctctatcgttccatc

SEQ ID NO: 172 - DNA, 16 bp, Influenza A virus
gatgtctttgcaggga

SEQ ID NO: 173 - DNA, 16 bp, Influenza A virus
gaacaccgatcttgag

SEQ ID NO: 174 - DNA, 17 bp, Influenza A virus
tggctaaagacaagacc

SEQ ID NO: 175 - DNA, 16 bp, Influenza A virus
atcctgtcacctctga

SEQ ID NO: 176 - DNA, 16 bp, Influenza A virus
tttgtgttcacgctca

SEQ ID NO: 177 - DNA, 16 bp, Influenza A virus
cgtgcccagtgagcga

SEQ ID NO: 178 - DNA, 17 bp, Influenza A virus
cgaggactgcagcgtag

SEQ ID NO: 179 - DNA, 17 bp, Influenza A virus
cgctttgtccaaaatgc

SEQ ID NO: 180 - DNA, 20 bp, Influenza A virus
cctaaatgggaatggagacc

SEQ ID NO: 181 - DNA, 20 bp, Influenza A virus
aaacaacatggacagggcag

SEQ ID NO: 182 - DNA, 20 bp, Influenza A virus
aaacttaagagggagataac

SEQ ID NO: 183 - DNA, 20 bp, Influenza A virus
ttccatggggccaaagaaat

SEQ ID NO: 184 - DNA, 17 bp, Influenza A virus
tgggtctcatatacaac

SEQ ID NO: 185 - DNA, 16 bp, Influenza A virus
ggatgggaacggtgac

SEQ ID NO: 186 - DNA, 18 bp, Influenza A virus
caacatgtgaacagattg

SEQ ID NO: 187 - DNA, 16 bp, Influenza A virus
ttttggccagcactac

SEQ ID NO: 188 - DNA, 16 bp, Influenza A virus
acatgagaacagaatg

SEQ ID NO: 189 - DNA, 16 bp, Influenza A virus
ttttggccagcactac

SEQ ID NO: 190 - DNA, 17 bp, Influenza A virus
atggaggttgctagtag

SEQ ID NO: 191 - DNA, 16 bp, Influenza A virus
gctaggcagatggtac

SEQ ID NO: 192 - DNA, 18 bp, Influenza A virus
ctggtctaagagatgatc

SEQ ID NO: 193 - DNA, 18 bp, Influenza A virus
tcttgaaaatttgcagac

SEQ ID NO: 194 - DNA, 19 bp, Influenza A virus
atttatcgtcgccttaaat

SEQ ID NO: 195 - DNA, 19 bp, Influenza A virus
cggtttgaaaagagggcct

SEQ ID NO: 196 - DNA, 21 bp, Influenza A virus
cctgagtctatgagggaagaa

SEQ ID NO: 197 - DNA, 21 bp, Influenza A virus
atcgaaaggaacagcagaatg